(19) United States
(12) Patent Application Publication
(10) Pub. No.: US 2026/0320072 A1
(43) Pub. Date: Oct. 15, 2026

(54) SYSTEMS AND METHODS FOR DYNAMICALLY SYNCHRONIZING GRAPH-BASED DATA IN A COMPUTER NETWORK USING DYNAMICALLY GENERATED VISUAL REPRESENTATIONS

(71) Applicant: Altana Technologies, Inc., Brooklyn, NY (US)

(72) Inventors: Evan Smith, New York, NY (US); Peter Swartz, New York, NY (US); Ian Cadieu, Stamford, CT (US); Joshua Max Broomberg, Brooklyn, NY (US)

(73) Assignee: Altana Technologies, Inc., Brooklyn, NY (US)

(21) Appl. No.: 19/642,512

(22) Filed: Apr. 8, 2026

Related U.S. Application Data
(60) Provisional application No. 63/786,089, filed on Apr. 9, 2025.

(51) Int. Cl. G06F 16/27; G06F 16/901

(52) U.S. Cl. CPC G06F 16/27; G06F 16/9024

(57) ABSTRACT

Methods and systems for updating and synchronizing graph-based data across a computer network in a distributed computing environment are disclosed. A system can transmit a digital record comprising a visual representation of one or more sub-graph data structures to a computing device. The digital record can comprise a request for additional information for a sequence of nodes. The system can receive an augmented digital record updated with the additional information from the computing device of the first node. The system can update, based at least on the additional information, at least one node of the sequence of nodes and regenerate the visual representation. The system can identify one or more other nodes of the sequence of nodes to propagate the update to the digital record. The system can propagate the augmented digital record to a computing system of each of the identified one or more other nodes.

### CROSS-REFERENCE TO APPLICATIONS

This application claims the benefit of priority to U.S. Provisional Application No. 63/786,089, filed Apr. 9, 2025, the entirety of which is incorporated by reference herein.

### BACKGROUND

Network graph data structures can store complex relationships between entities and networked items as interconnected nodes and edges. Computing devices can process and analyze network graph data structures to extract insights about the represented relationships. However, efficiently managing and updating large-scale network graph data structures is difficult given the large amount of computational resources (e.g., memory and processing power) that is used as the data scales.

### SUMMARY

In distributed computing environments, computing systems frequently maintain graph-based data structures that represent networked items and their relationships across multiple interconnected systems of record. For example, computing systems corresponding to a plurality of entities (e.g., value chain platforms, operational task orchestration systems, or enterprise service meshes, etc.) may each maintain a system of record including data of the graph-based data structure. The entities may interact with the graph-based data structure by submitting tasks and requesting data that can be provided by other entities associated with the graph-based data structure. The entities may also upload information to the graph-based data structure, including information uploaded in response to requests from other entities. However, conventional distributed systems lack a reliable mechanism for incrementally updating and propagating changes to such graph-based representations while preserving path-specific context and consistency across nodes. Updates received at one system are often applied locally without coordinated propagation along relevant graph paths, causing downstream systems to operate on stale or incomplete representations of the network state. As a result, actions triggered based on these representations may diverge from the authoritative system-of-record state, reducing accuracy and reliability in distributed operations. Furthermore, the system may incur significant computational overhead when rolling back operations executed based on stale representations of the network state.

The embodiments described herein address these shortcomings by providing a computing system that generates, incrementally augments, and propagates a digital record that remains logically bound to an underlying graph data structure. The computing system receives node-specific information from one or more networked entities, resolves the information to corresponding nodes within the stored graph, and incrementally updates the affected nodes while preserving the contextual paths in which the nodes participate. Based on identified graph paths, the computing system can selectively propagates the updated sub-graph record to other distributed nodes, thereby triggering coordinated actions across multiple systems of record in a manner that maintains graph consistency and path-aware context. By selectively propagating the updated record along identified graph paths, the system can coordinate propagation of modifications to the graph-based data structure, thereby reducing inaccuracies caused by inconsistent application of graph updates across multiple interconnected systems of record.

Existing computer-networked systems also lack a structured mechanism for accurately capturing, updating, and visually regenerating network graph data that reflects evolving task-related operations across multiple interconnected entities. Conventional visualization techniques typically rely on static snapshots or manually refreshed views that fail to reflect incremental changes received from distributed sources. The static snapshots can prevent users and systems from observing modifications to the graph-based data structure as they occur across the network, thereby limiting situational awareness and operational coordination.

To address this technical problem, the computing system regenerates visual representations of any records associated with a modification to the graph-based data structure. As updates are applied to the underlying graph, the computing system regenerates synchronized visual representations that reflect the updated network state without reconstruction of the entire graph. For example, in response to receiving an update to a node of a first digital record reflecting part of the graph-based data structure, the system can query the graph-based data structure to identify a second digital record associated with the update and regenerate a visual representation of the second digital record to reflect the update. As a result, the computing system can efficiently maintain an accurate, continuously updated visual depiction of task-related operations across interconnected entities, enabling a consistent and up-to-date representation of the distributed network.

At least one aspect relates to a method for updating and synchronizing graph-based data across a computer network in a distributed computing environment. The method can be performed, for example, by one or more processors coupled to non-transitory memory. The method can include transmitting a digital record comprising a visual representation of one or more sub-graph data structures of a network graph data structure comprising a network of nodes to a computing device of a first node of the network of nodes of the network graph data structure, the digital record comprising a request for additional information for a sequence of nodes of a sub-graph data structure of the one or more sub-graph data structures, sequence of nodes forming a path of one or more instances of a networked item from a source node to a destination node. The path represents network operations of the one or more instances of the networked item through the sequence of nodes. Each node of the sequence of nodes represents an entity performing a network operation on the one or more instances of the networked item. Each edge between one or more pairs of the sequence of nodes represents a network operation involving the one or more instances of the networked item from one node of the pair of nodes to the other node of the pair of nodes. The method can include receiving an augmented digital record updated with the additional information from the computing device of the first node of the network of nodes of the network graph data structure. The method can include updating, based at least on the additional information, at least one node of the sequence of nodes of the sub-graph data structure and regenerating the visual representation based at least on the updated at least one node of the network graph data structure. The method can include identifying one or more other nodes of the sequence of nodes to propagate the update to the digital record. The method can include propagating, across a communications network, the augmented digital record to a computing system of each of the identified one or more other nodes of the sequence of nodes for taking an action regarding a system of record maintained by the computing system and comprising a set of nodes of the computing system represented in the network graph data structure.

In some implementations, propagating the augmented digital record to the computing system of each of the identified one or more other nodes of the sequence of nodes comprises, for each computing system, identifying an address of a second computing device of the computing system from the first node of the one or more other nodes of the sequence of nodes. In some implementations, propagating the augmented digital record to the computing system of each of the identified one or more other nodes of the sequence of nodes comprises, for each computing system, including the address in a header of each of a set of data packets including the augmented digital record transmitted to the second computing device across the communications network.

In some implementations, the method can include receiving, from a second computing device, a request to complete a task corresponding to the networked item. In some implementations, the method can include creating the digital record in response to the request and based on the task by identifying the one or more sub-graph data structures of the network graph data structure based on a link between the one or more sub-graph data structures linked and a node of a profile for the networked item within the network of nodes.

In some implementations, creating the digital record comprises creating a visual representation of the sub-graph data structure that corresponds to completing the task identified in the request. In some implementations, transmitting the digital record comprising the first visual representation of the one or more sub-graph data structures comprises rendering the visual representation on a user interface for presentation on the computing device.

In some implementations, receipt of the augmented digital record triggers at least one computing system of the one or more other nodes to locally add an edge between a pair of nodes of the set of nodes within the digital record.

In some implementations, the method can include transmitting the set of nodes to the computing system including attributes corresponding to entities represented by the set of nodes. In some implementations, the method can include receiving, from the computing system, the set of nodes updated with added edge between the pair of nodes of the set of nodes.

In some implementations, the method can include receiving a message from the at least one computing system identifying the added edge between the pair nodes. In some implementations, the method can include identifying the pair of nodes within the network graph data structure stored by the one or more processors. In some implementations, the method can include adding the edge between the pair of nodes within the network graph data structure stored by the one or more processors.

In some implementations, identifying the one or more other nodes of the sequence of nodes to propagate the update to the digital record comprises identifying each node of the sub-graph data structure containing the sequence of nodes through edges connecting the respective nodes.

In some implementations, the method can include identifying security permissions of each node of the sequence of nodes. In some implementations, the method can include determining to propagate the augmented digital record to the computing system of each of the identified one or more other nodes of the sequence of nodes responsive to determining security permissions of the one or more nodes satisfy a threshold.

In some implementations, selectively propagating the augmented digital record only to computing systems of nodes with security permissions satisfying the threshold improves data integrity of the network graph data structure by preventing unauthorized updates to nodes outside the updated sequence of nodes.

At least one aspect relates to a system for updating and synchronizing graph-based data across a computer network in a distributed computing environment. The system can include one or more processors and one or more non-transitory computer-readable media storing instructions that, when executed by the one or more processors, cause the system to transmit a digital record comprising a visual representation of one or more sub-graph data structures of a network graph data structure comprising a network of nodes to a computing device of a first node of the network of nodes of the network graph data structure, the digital record comprising a request for additional information for a sequence of nodes of a sub-graph data structure of the one or more sub-graph data structures, sequence of nodes forming a path of one or more instances of a networked item from a source node to a destination node. The path represents network operations of the one or more instances of the networked item through the sequence of nodes. Each node of the sequence of nodes represents an entity performing a network operation on the one or more instances of the networked item. Each edge between one or more pairs of the sequence of nodes represents a network operation involving the one or more instances of the networked item from one node of the pair of nodes to the other node of the pair of nodes. The system can receive an augmented digital record updated with the additional information from the computing device of the first node of the network of nodes of the network graph data structure. The system can update, based at least on the additional information, at least one node of the sequence of nodes of the sub-graph data structure and regenerating the visual representation based at least on the updated at least one node of the network graph data structure. The system can identify one or more other nodes of the sequence of nodes to propagate the update to the digital record. The system can propagate across a communications network, the augmented digital record to a computing system of each of the identified one or more other nodes of the sequence of nodes for taking an action regarding a system of record maintained by the computing system and comprising a set of nodes of the computing system represented in the network graph data structure.

In some implementations, the instructions for propagating the augmented digital record to the computing system of each of the identified one or more other nodes of the sequence of nodes causes the system to, for each computing system, identify an address of a second computing device of the computing system from the first node of the one or more other nodes of the sequence of nodes. In some implementations, the instructions for propagating the augmented digital record to the computing system of each of the identified one or more other nodes of the sequence of nodes causes the system to, for each computing system, include the address in a header of each of a set of data packets including the augmented digital record transmitted to the second computing device across the communications network.

In some implementations, the instructions further cause the system to receive, from a second computing device, a request to complete a task corresponding to the networked item. In some implementations, the instructions further cause the system to create the digital record in response to the request and based on the task by identifying the one or more sub-graph data structures of the network graph data structure based on a link between the one or more sub-graph data structures linked and a node of a profile for the networked item within the network of nodes.

In some implementations, the instructions for creating the digital record cause the system to create a visual representation of the sub-graph data structure that corresponds to completing the task identified in the request. In some implementations, the instructions for transmitting the digital record comprising the first visual representation of the one or more sub-graph data structures cause the system to render the visual representation on a user interface for presentation on the computing device.

In some implementations, receipt of the augmented digital record triggers at least one computing system of the one or more other nodes to locally add an edge between a pair of nodes of the set of nodes within the digital record.

In some implementations, the instructions further cause the system to transmit the set of nodes to the computing system including attributes corresponding to entities represented by the set of nodes. In some implementations, the instructions further cause the system to receive, from the computing system, the set of nodes updated with added edge between the pair of nodes of the set of nodes.

In some implementations, the instructions further cause the system to receive a message from the at least one computing system identifying the added edge between the pair nodes. In some implementations, the instructions further cause the system to identify the pair of nodes within the network graph data structure stored by the one or more processors. In some implementations, the instructions further cause the system to add the edge between the pair of nodes within the network graph data structure stored by the one or more processors.

In some implementations, identifying the one or more other nodes of the sequence of nodes to propagate the update to the digital record comprises identifying each node of the sub-graph data structure containing the sequence of nodes through edges connecting the respective nodes.

In some implementations, the instructions further cause the system to identify security permissions of each node of the sequence of nodes. In some implementations, the instructions further cause the system to determine to propagate the augmented digital record to the computing system of each of the identified one or more other nodes of the sequence of nodes responsive to determining security permissions of the one or more nodes satisfy a threshold.

At least one aspect relates to a non-transitory computer-readable storage medium storing instructions that, when executed by one or more processors, cause the one or more processors to perform operations. The operations can include transmitting a digital record comprising a visual representation of one or more sub-graph data structures of a network graph data structure comprising a network of nodes to a computing device of a first node of the network of nodes of the network graph data structure, the digital record comprising a request for additional information for a sequence of nodes of a sub-graph data structure of the one or more sub-graph data structures, sequence of nodes forming a path of one or more instances of a networked item from a source node to a destination node. The path represents network operations of the one or more instances of the networked item through the sequence of nodes. Each node of the sequence of nodes represents an entity performing a network operation on the one or more instances of the networked item. Each edge between one or more pairs of the sequence of nodes represents a network operation involving the one or more instances of the networked item from one node of the pair of nodes to the other node of the pair of nodes. The operations can include receiving an augmented digital record updated with the additional information from the computing device of the first node of the network of nodes of the network graph data structure. The operations can include updating, based at least on the additional information, at least one node of the sequence of nodes of the sub-graph data structure and regenerating the visual representation based at least on the updated at least one node of the network graph data structure. The operations can include identifying one or more other nodes of the sequence of nodes to propagate the update to the digital record. The operations can include propagating, across a communications network, the augmented digital record to a computing system of each of the identified one or more other nodes of the sequence of nodes for taking an action regarding a system of record maintained by the computing system and comprising a set of nodes of the computing system represented in the network graph data structure.

In some cases, the operations further include identifying security permissions of each node of the sequence of nodes; and determining to propagate the augmented digital record to the computing system of each of the identified one or more other nodes of the sequence of nodes responsive to determining security permissions of the one or more nodes satisfy a threshold.

At least one aspect relates to a method for synchronizing a network graph data structure in a computer-networked environment using a visual representation of the network graph data structure. The method can be performed, for example, by one or more processors coupled to non-transitory memory. The method can include receiving, from a first computing device, a request to complete a task corresponding to a networked item. The method can include creating a digital record that corresponds to the task, the digital record comprising a first visual representation of one or more sub-graph data structures of a network graph data structure comprising a network of nodes, each sub-graph data structure linked to a node of a profile for the networked item and comprising a chain of nodes, the chain of nodes comprising a sequence of connected nodes forming a path of one or more instances of the networked item from a source node to a destination node. The path represents network operations of the one or more instances of the networked item through the sequence of connected nodes. Each node of the sequence of connected nodes represents an entity performing a network operation on the one or more instances of the networked item. Each edge between one or more pairs of the sequence of connected nodes represents a network operation involving the one or more instances of the networked item from a first node of the pair of nodes to a second node of the pair of nodes. The method can include transmitting the digital record to a second computing device of at least one entity of a node of the network of nodes with a request for additional information for the sequence of nodes. The method can include receiving an augmented digital record updated with the additional information from the second computing device associated with a node of the network graph data structure. The method can include updating, based at least on the additional information, a node of the network graph data structure associated with the augmented digital record and regenerating the first visual representation based at least on the updated node of the network graph data structure. The method can include generating a second digital record comprising a second visual representation generated responsive to the update to the node of the network graph data structure.

In some implementations, creating the digital record that corresponds to the task comprises generating the digital record to include the first visual representation of the one or more sub-graph data structures of the network graph data structure as a graphical depiction including icons representing one or more nodes of each of the one or more sub-graph data structures. In some implementations, receiving the augmented digital record comprises receiving the augmented digital record responsive to a selection of an icon corresponding to the node of the network graph data structure into the graphical depiction and an input of a file identifying an entity represented by the node. In some implementations, updating the node of the network graph data structure comprises linking the file to the node of the network graph data structure. In some implementations, transmitting the digital record to the second computing device comprises identifying an address of the second computing device from the node included in the sequence of nodes. In some implementations, transmitting the digital record to the second computing device comprises including the address in a header of each of a set of data packets including the digital record transmitted to the second computing device across a communications network.

In some implementations, generating the second digital record comprises querying a database comprising identifications of a plurality of digital records each corresponding to a portion of the network graph data structure. In some implementations, generating the second digital record comprises determining that a third digital record corresponds to the updated node based on the query. In some implementations, generating the second digital record comprises revising the third digital record into the second digital record based on the update to the node of the network graph data structure. In some implementations, revising the third digital record comprises appending a file identifying an entity represented by the node to the third digital record to generate the second digital record. In some implementations, creating the first visual representation and generating the second visual representation comprises creating the first visual representation and generating the second visual representation as a dynamic, computer-generated two-dimensional rendering of at least one of the one or more sub-graph data structures including node icons and edge lines, and are configured for display within a viewport of a graphical user interface. In some implementations, updating the node of the network graph data structure associated with the augmented digital record comprises inserting a value into a field-value pair of the node.

In some implementations, creating the digital record comprises responsive to receiving the request, querying the sub-graph data structure for any nodes that correspond to profiles and contain a matching identifier to the networked item. In some implementations, creating the digital record comprises identifying the node of the profile for the networked item based on the query. In some implementations, creating the digital record comprises identifying the one or more sub-graph data structure based on the links of each sub-graph data structure with the node of the profile for the networked item. In some implementations, creating the digital record comprises dynamically creating the digital record based on the identified one or more sub-graph data structures. In some implementations, receiving the request to complete the task comprises receiving, from the first computing device, the request to provide additional node attributes corresponding to the networked item.

At least one aspect relates to a system for synchronizing a network graph data structure in a computer-networked environment using a visual representation of the network graph data structure. The system can include one or more processors. The system can include one or more non-transitory computer-readable media storing instructions that, when executed by the one or more processors, cause the system to receive, from a first computing device, a request to complete a task corresponding to a networked item. The system can create a digital record that corresponds to the task, the digital record comprising a first visual representation of one or more sub-graph data structures of a network graph data structure comprising a network of nodes, each sub-graph data structure linked to a node of a profile for the networked item and comprising a chain of nodes, the chain of nodes comprising a sequence of connected nodes forming a path of one or more instances of the networked item from a source node to a destination node. The path represents network operations of the one or more instances of the networked item through the sequence of connected nodes. Each node of the sequence of connected nodes represents an entity performing a network operation on the one or more instances of the networked item. Each edge between one or more pairs of the sequence of connected nodes represents a network operation involving the one or more instances of the networked item from a first node of the pair of nodes to a second node of the pair of nodes. The system can transmit the digital record to a second computing device of at least one entity of a node of the network of nodes with a request for additional information for the sequence of nodes. The system can receive an augmented digital record updated with the additional information from the second computing device associated with a node of the network graph data structure. The system can update, based at least on the additional information, a node of the network graph data structure associated with the augmented digital record and regenerating the first visual representation based at least on the updated node of the network graph data structure. The system can generate a second digital record comprising a second visual representation generated responsive to the update to the node of the network graph data structure.

In some implementations, the instructions for creating the digital record that corresponds to the task cause the system to generate the digital record to include the first visual representation of the one or more sub-graph data structures of the network graph data structure as a graphical depiction including icons representing one or more nodes of each of the one or more sub-graph data structures. In some implementations, the instructions for receiving the augmented digital record cause the system to receive the augmented digital record responsive to a selection of an icon corresponding to the node of the network graph data structure into the graphical depiction and an input of a file identifying an entity represented by the node. In some implementations, the instructions for updating the node of the network graph data structure cause the system to link the file to the node of the network graph data structure. In some implementations, the instructions for transmitting the digital record to the second computing device cause the system to identify an address of the second computing device from the node included in the sequence of nodes. In some implementations, the instructions for transmitting the digital record to the second computing device cause the system to include the address in a header of each of a set of data packets including the digital record transmitted to the second computing device across a communications network.

In some implementations, the instructions for generating the second digital record cause the system to query a database comprising identifications of a plurality of digital records each corresponding to a portion of the network graph data structure. In some implementations, the instructions for generating the second digital record cause the system to determine that a third digital record corresponds to the updated node based on the query. In some implementations, the instructions for generating the second digital record cause the system to revise the third digital record into the second digital record based on the update to the node of the network graph data structure. In some implementations, the instructions for revising the third digital record cause the system to append a file identifying an entity represented by the node to the third digital record to generate the second digital record. In some implementations, the instructions for creating the first visual representation and generating the second visual representation cause the system to create the first visual representation and generate the second visual representation as a dynamic, computer-generated two-dimensional rendering of at least one of the one or more sub-graph data structures including node icons and edge lines, and are configured for display within a viewport of a graphical user interface. In some implementations, updating the node of the network graph data structure associated with the augmented digital record comprises inserting a value into a field-value pair of the node.

In some implementations, the instructions for creating the digital record cause the system to responsive to receiving the request, query the sub-graph data structure for any nodes that correspond to profiles and contain a matching identifier to the networked item. In some implementations, the instructions for creating the digital record cause the system to identify the node of the profile for the networked item based on the query. In some implementations, the instructions for creating the digital record cause the system to identify the one or more sub-graph data structure based on the links of each sub-graph data structure with the node of the profile for the networked item. In some implementations, the instructions for creating the digital record cause the system to dynamically create the digital record based on the identified one or more sub-graph data structures.

At least one aspect relates to a non-transitory computer-readable storage medium storing instructions that, when executed by one or more processors, cause the one or more processors to perform operations. The operations can include receiving, from a first computing device, a request to complete a task corresponding to a networked item. The operations can include creating a digital record that corresponds to the task, the digital record comprising a first visual representation of one or more sub-graph data structures of a network graph data structure comprising a network of nodes, each sub-graph data structure linked to a node of a profile for the networked item and comprising a chain of nodes, the chain of nodes comprising a sequence of connected nodes forming a path of one or more instances of the networked item from a source node to a destination node. The path represents network operations of the one or more instances of the networked item through the sequence of connected nodes. Each node of the sequence of connected nodes represents an entity performing a network operation on the one or more instances of the networked item. Each edge between one or more pairs of the sequence of connected nodes represents a network operation involving the one or more instances of the networked item from a first node of the pair of nodes to a second node of the pair of nodes. The operations can include transmitting the digital record to a second computing device of at least one entity of a node of the network of nodes with a request for additional information for the sequence of nodes. The operations can include receiving an augmented digital record updated with the additional information from the second computing device associated with a node of the network graph data structure. The operations can include updating, based at least on the additional information, a node of the network graph data structure associated with the augmented digital record and regenerating the first visual representation based at least on the updated node of the network graph data structure. The operations can include generating a second digital record comprising a second visual representation generated responsive to the update to the node of the network graph data structure.

In some cases, creating the digital record that corresponds to the task includes generating the digital record to include the first visual representation of the one or more sub-graph data structures of the network graph data structure as a graphical depiction including icons representing one or more nodes of each of the one or more sub-graph data structures; and receiving the augmented digital record comprises receiving, by the one or more processors, the augmented digital record responsive to a selection of an icon corresponding to the node of the network graph data structure into the graphical depiction and an input of a file identifying an entity represented by the node.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles, and concepts. The drawings are not intended to limit the scope of the claims included herewith.

FIG. 1A illustrates an example block diagram depicting a computing device, in accordance with one or more embodiments.

FIG. 1B illustrates an example block diagram depicting a computing environment comprising a client device in communication with cloud service providers, in accordance with one or more embodiments.

FIG. 2A illustrates an example block diagram depicting a system using supervised learning, in accordance with one or more embodiments.

FIG. 2B illustrates an example block diagram depicting a simplified neural network model, in accordance with one or more embodiments.

FIG. 3A is an illustration of an example system for network graph data structure-based transportation networking, in accordance with an implementation.

FIG. 3B illustrates an example network graph data structure, in accordance with an implementation.

FIG. 3C illustrates example sub-graph data structures of the example network graph data structure of FIG. 3B, in accordance with an implementation.

FIG. 3D illustrates an example sub-graph data structure of the example network graph data structure of FIG. 3B, in accordance with one or more embodiments.

FIG. 3E illustrates a hub and spoke infrastructure for managing a network graph data structure that allows sharing of insights without transmission of sensitive data, in accordance with one or more embodiments.

FIG. 3F illustrates an example flowchart of a process for network graph data structure-based transportation networking, in accordance with an implementation.

FIG. 4A illustrates a sequence diagram of a system for updating and propagating graph-based data across a computer network in a distributed computing environment, in accordance with one or more embodiments.

FIG. 4B illustrates a digital record for a networked item profile, in accordance with one or more embodiments.

FIG. 4C illustrates a flowchart of a method for updating and propagating graph-based data across a computer network in a distributed computing environment, in accordance with one or more embodiments.

FIG. 4D illustrates a sequence diagram of a system for updating a network graph data structure in a computer-networked environment using a visual representation of the network graph data structure, in accordance with one or more embodiments.

FIG. 4E illustrates a flowchart of a method for updating a network graph data structure in a computer-networked environment using a visual representation of the network graph data structure, in accordance with one or more embodiments.

FIGS. 5A-5S illustrate a sequence of example user interfaces for updating a system of record using a network graph data structure, in accordance with one or more embodiments.

### DETAILED DESCRIPTION

For purposes of reading the description of the various embodiments below, the following descriptions of the sections of the specification and their respective contents can be helpful:
Section A describes a computing environment and network environment that can be useful for practicing embodiments described herein.
Section B describes an artificial intelligence environment that can be useful for practicing embodiments described herein.
Section C describes a computing device for network graph data structure-based networking in accordance with embodiments described herein.
Section D describes systems and methods for updating and synchronizing graph-based data in accordance with embodiments described herein.

### A. Computing and Network Environment

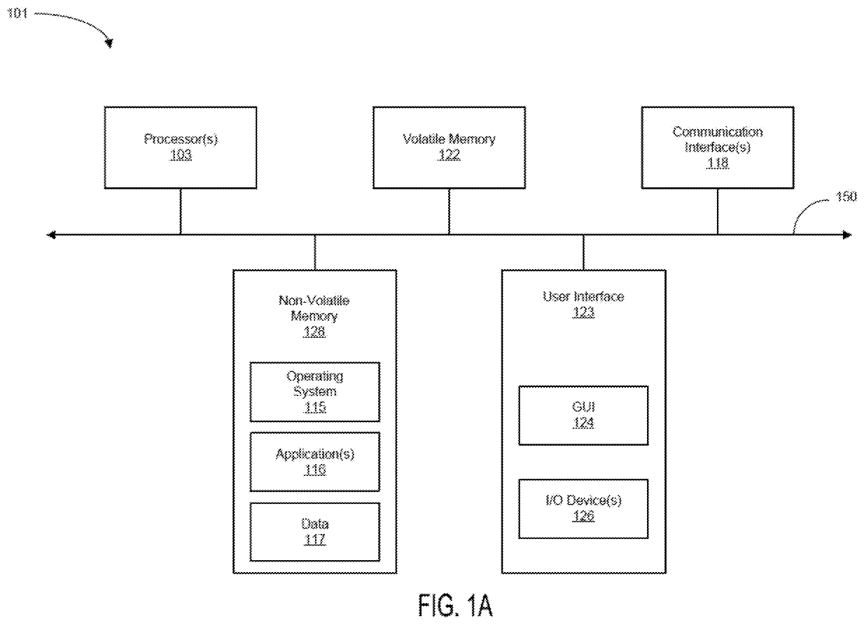

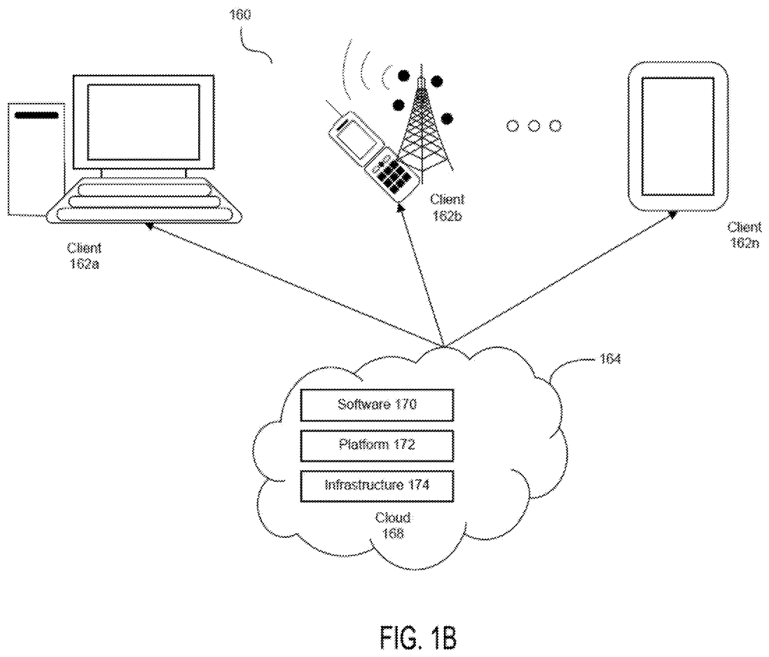

As shown in FIG. 1A, computer 101 may include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computer 101 may communicate via one or more communication buses, shown as communication bus 150.

Computer 101 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described embodiments, the computing device 101 may execute an application on behalf of a user of a client computing device. For example, the computing device 101 may execute a virtual machine, which provides an execution session within which applications execute on behalf of a user or a client computing device, such as a hosted desktop session. The computing device 101 may also execute a terminal services session to provide a hosted desktop environment. The computing device 101 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 may provide client 162 with one or more resources provided by a network environment. The computing environment 160 may include one or more clients 162a-162n, in communication with a cloud 168 over one or more networks 164. Clients 162 may include, e.g., thick clients, thin clients, and zero clients. The cloud 168 may include back end platforms, e.g., servers, storage, server farms or data centers. The clients 162 can be the same as or substantially similar to computer 101 of FIG. 1A.

The users or clients 162 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 168 may be public, private, or hybrid. Public clouds 168 may include public servers that are maintained by third parties to the clients 162 or the owners of the clients 162. The servers may be located off-site in remote geographical locations as disclosed above or otherwise. Public clouds 168 may be connected to the servers over a public network 164. Private clouds 168 may include private servers that are physically maintained by clients 162 or owners of clients 162. Private clouds 168 may be connected to the servers over a private network 164. Hybrid clouds 168 may include both the private and public networks 164 and servers.

The cloud 168 may include back end platforms, e.g., servers, storage, server farms or data centers. For example, the cloud 168 can include or correspond to a server or system remote from one or more clients 162 to provide third party control over a pool of shared services and resources. The computing environment 160 can provide resource pooling to serve multiple users via clients 162 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 162. The computing environment 160 can provide an elasticity to dynamically scale out or scale in responsive to different demands from one or more clients 162. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include serverless computing. The computing environment 160 can include Software as a service (SaaS). For example, the cloud 168 may also include a cloud based delivery, e.g., Software as a Service (SaaS) 170, Platform as a Service (PaaS) 172, and Infrastructure as a Service (IaaS) 174. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g., DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 162 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 162 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 162 may access SaaS resources through the use of web-based user interfaces, provided by a web browser (e.g., GOOGLE CHROME, Microsoft INTERNET EXPLORER, or Mozilla Firefox provided by Mozilla Foundation of Mountain View, California). Clients 162 may also access SaaS resources through smartphone or tablet applications, including, e.g., Salesforce Sales Cloud, or Google Drive app. Clients 162 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Artificial Intelligence Environment

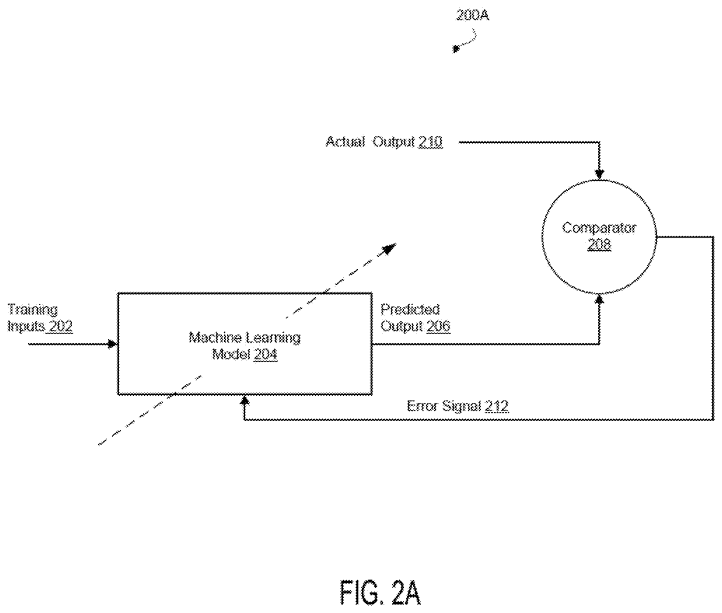

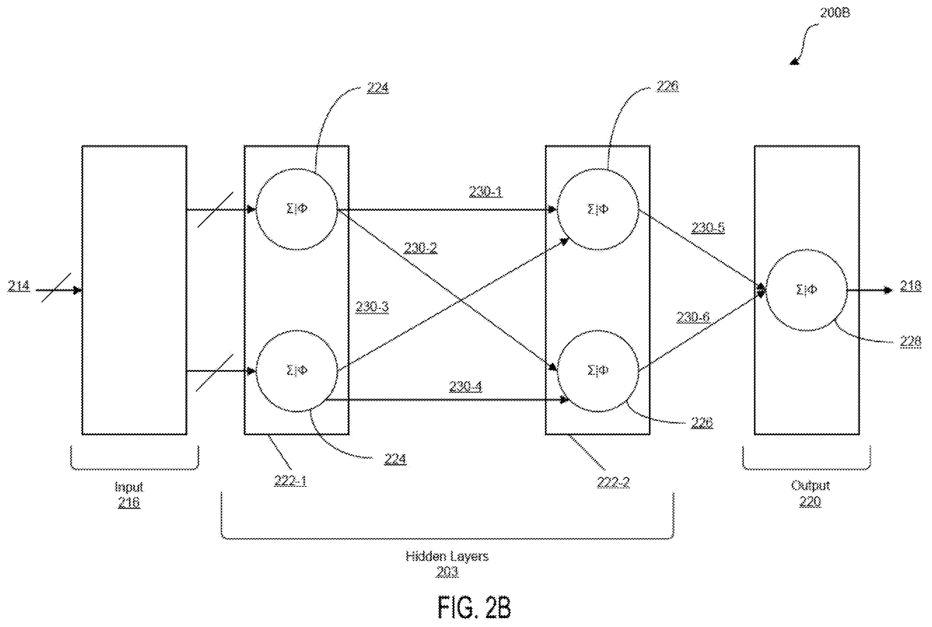

Referring to FIG. 2A, an embodiment of an artificial intelligence environment 200A is depicted. The artificial intelligence environment 200A may incorporate various machine learning models to process data, identify patterns, and generate predictions or decisions. By way of example, machine learning models can comprise supervised learning models, clustering models, neural network models, deep learning models, reinforcement learning models, unsupervised models, decision trees, support-vector machines, Bayesian networks, Gaussian processes, genetic algorithms models, generative models, image and text processing models, video processing models, any other models that can be used by one or more machine learning algorithms, any other models that can learn from data (e.g., training data) to perform tasks without explicit instructions, or various combinations thereof. They can also involve combinations of the above and agentic systems that leverage models and underlying data. The neural network models can comprise, for example and without limitation, artificial neural networks (ANNs), deep neural networks (DNNs), deep belief networks (DBNs), one or more language models, large language models (LLMs), attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), any other models that can learn patterns and make predictions or decisions, or various combinations thereof.

The machine learning models can be configured, learned, or trained using various learning or training operations, such as unsupervised learning, weakly supervised learning, semi-supervised learning, supervised learning, or any other learning or training operations that can learn from data (e.g., training data) and generalize to unseen data, or various combinations thereof. For example, parameters of nodes of a neural network model, such as weights, biases, and/or thresholds, can be configured, learned, or trained using various learning or training operations, such as unsupervised learning, weakly supervised learning, semi-supervised learning, or supervised learning. A machine learning model can be configured using training data from various domain-agnostic and/or domain-specific data sources. The training data can include a plurality of training data elements (e.g., training data instances). Each training data element can be arranged in structured or unstructured formats; for example, the training data element can include an example output mapped to an example input. The training data can include data that is not separated into input and output subsets (e.g., for configuring the machine learning model to perform clustering, classification, or other unsupervised machine learning operations). The training data can include data describing network structure, such as a supply chain network, and the greater network situation of a given observation. The training data can include human-labeled information, including but not limited to feedback regarding outputs of the machine learning model, which can allow the machine learning model to generate more human-like outputs.

Referring back to FIG. 2A, a block diagram of an example system using supervised learning is shown. Supervised learning is a method of training a machine learning model given input-output pairs. An input-output pair is an input with an associated known output (e.g., an expected output).

Machine learning model 204 may be trained on known input-output pairs such that the machine learning model 204 can learn how to predict known outputs given known inputs. Once the machine learning model 204 has learned how to predict known input-output pairs, the machine learning model 204 can operate on unknown inputs to predict an output.

The machine learning model 204 may be trained based on general data and/or granular data (e.g., data based on a specific user) such that the machine learning model 204 may be trained specific to a particular user.

Training inputs 202 and actual outputs 210 may be provided to the machine learning model 204. Training inputs 202 may include features such as numerical data, categorical variables, text, images, audio signals, and the like.

The inputs 202 and actual outputs 210 may be received from various data repositories. For example, a data repository may contain labeled datasets with example data points and their corresponding correct outputs. The data repository may also contain data associated with specific users or general populations. Thus, the machine learning model 204 may be trained to predict outcomes based on the training inputs 202 and actual outputs 210 used to train the machine learning model 204.

The example system may include one or more machine learning models 204. In an embodiment, a first machine learning model 204 may be trained to predict data using a classification or regression technique. For example, the first machine learning model 204 may use the training inputs 202 to predict outputs 206 by applying the current state of the first machine learning model 204 to the training inputs 202. The comparator 208 may compare the predicted outputs 206 to actual outputs 210 to determine an amount of error or differences. For example, the predicted output 206 may be compared to the actual output 210 to calculate a loss function or error metric.

In other embodiments, a second machine learning model 204 may be trained to make one or more recommendations to the user based on the predicted output from the first machine learning model 204. For example, the second machine learning model 204 may use the training inputs 202 and the predicted outputs from the first machine learning model 204 as its own input to predict outputs 206 in the form of personalized recommendations by applying the current state of the second machine learning model 204 to the training inputs 202. The comparator 208 may compare the predicted outputs 206 (e.g., the recommended actions or networked items) to actual outputs 210 (e.g., user choices or feedback on previous recommendations to determine an amount of error or differences.

The actual outputs 210 may be determined based on historic data of recommendations made to the user and the resulting outcomes in the supply chain. In an illustrative non-limiting example, the machine learning model 204 may be continuously trained to improve its quality and accuracy in predicting and improving supply chain operations. The machine learning model 204 can take into account various inputs such as forecasted demand, inventory data, customer preferences, and distributor preferences to model, recommend, and execute operations. The actual outputs 210 may then be determined by measuring the real-world outcomes after implementing these recommendations, such as the resulting stockout rate, inventory carrying costs, and overall supply chain efficiency.

In some embodiments, a single machine learning model 204 may be trained to make one or more recommendations to the user based on current user data received from enterprise resources. That is, a single machine learning model may be trained using the training inputs 202, which include historical data and current user data, to predict outputs 206 in the form of personalized recommendations by applying the current state of the machine learning model 204 to the training inputs 202. The comparator 208 may compare the predicted outputs 206 to actual outputs 210 to determine an amount of error or differences. The actual outputs 210 may be determined based on historic data associated with the recommendation to the user and their subsequent actions or outcomes. The machine learning model 204 may use the data to learn patterns and make increasingly accurate recommendations over time. For instance, if the machine learning model 204 recommends ordering 1000 units of a product and a user follows the recommendation, the actual output 210 may include data on whether the quantity was sufficient, excessive, or inadequate based on subsequent demand and inventory levels. This feedback loop can allow the machine learning model 204 to continuously refine its predictions and adapt to changing conditions and user preferences in the supply chain ecosystem.

During training, the error (represented by error signal 212) determined by the comparator 208 may be used to adjust the weights in the machine learning model 204 such that the machine learning model 204 changes (or learns) over time. The machine learning model 204 may be trained using a backpropagation algorithm, for instance. The backpropagation algorithm operates by propagating the error signal 212. The error signal 212 may be calculated each iteration (e.g., each pair of training inputs 202 and associated actual outputs 210), batch and/or epoch, and propagated through the algorithmic weights in the machine learning model 204 such that the algorithmic weights adapt based on the amount of error. The error is minimized using a loss function. Non-limiting examples of loss functions may include the square error function, the root mean square error function, and/or the cross entropy error function.

The weighting coefficients of the machine learning model 204 may be tuned to reduce the amount of error, thereby minimizing the differences between (or otherwise converging) the predicted output 206 and the actual output 210. The machine learning model 204 may be trained until the error determined at the comparator 208 is within a certain threshold (or a threshold number of batches, epochs, or iterations have been reached). The trained machine learning model 204 and associated weighting coefficients may subsequently be stored in memory or other data repository (e.g., a database) such that the machine learning model 204 may be employed on unknown data (e.g., not training inputs 202). Once trained and validated, the machine learning model 204 may be employed during a testing (or an inference) phase. During testing, the machine learning model 204 may ingest unknown data to predict future data (e.g., future demand, inventory levels, supplier performance, delivery times, and the like).

Referring to FIG. 2B, a block diagram of a simplified neural network model 200B is shown. The neural network model 200B is only an example architecture. The neural network 200B can be any type of neural network, such as a feedforward neural network, a recurrent neural network, a convolutional neural network, a long short-term memory neural network, etc. The neural network model 200B may include a stack of distinct layers (vertically oriented) that transform a variable number of inputs 214 being ingested by an input layer 216 into an output 218 at the output layer 220.

The neural network model 200B may include a number of hidden layers 222 between the input layer 216 and output layer 220. Each hidden layer has a respective number of nodes (224, 226, and 228). In the neural network model 200B, the first hidden layer 222-1 has nodes 224, and the second hidden layer 222-2 has nodes 226. The nodes 224 and 226 perform a particular computation and are interconnected to the nodes of adjacent layers (e.g., nodes 224 in the first hidden layer 222-1 are connected to nodes 226 in a second hidden layer 222-2, and nodes 226 in the second hidden layer 222-2 are connected to nodes 228 in the output layer 220). Each of the nodes (224, 226, and 228) sum up the values from adjacent nodes and apply an activation function, allowing the neural network model 200B to detect nonlinear patterns in the inputs 214. Each of the nodes (224, 226, and 228) are interconnected by weights 230-1, 230-2, 230-3, 230-4, 230-5, 230-6 (collectively referred to as weights 230). Weights 230 are tuned during training to adjust the strength of the node. The adjustment of the strength of the node facilitates the neural network's ability to predict an accurate output 218.

In some embodiments, the output 218 may be one or more numbers. For example, output 218 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As such, the softmax classifier may be employed because of the classifier's ability to classify various classes. Other classifiers may be used to make other classifications. For example, the sigmoid function makes binary determinations about the classification of one class (i.e., the output may be classified using label A or the output may not be classified using label A).

### C. Computing Device for Node Transportation Networking

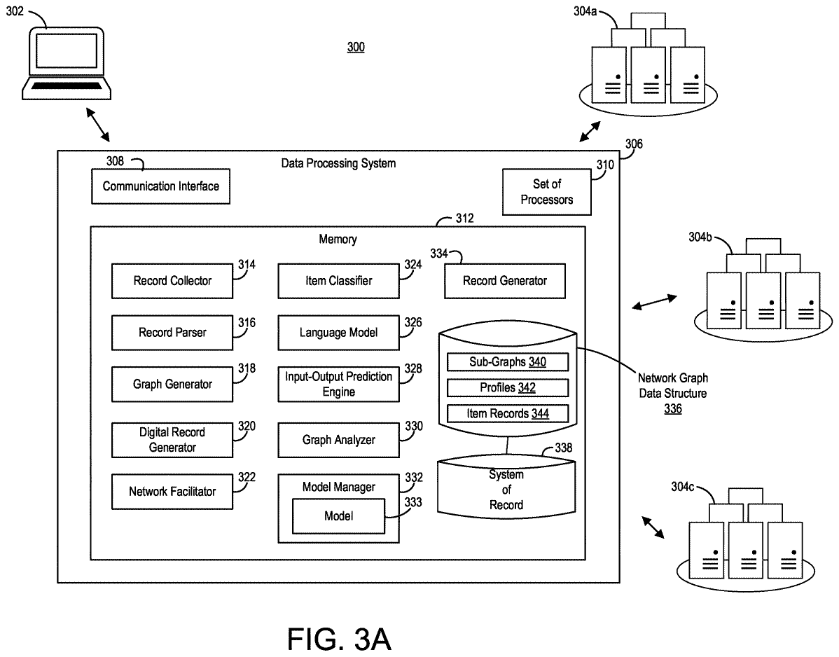

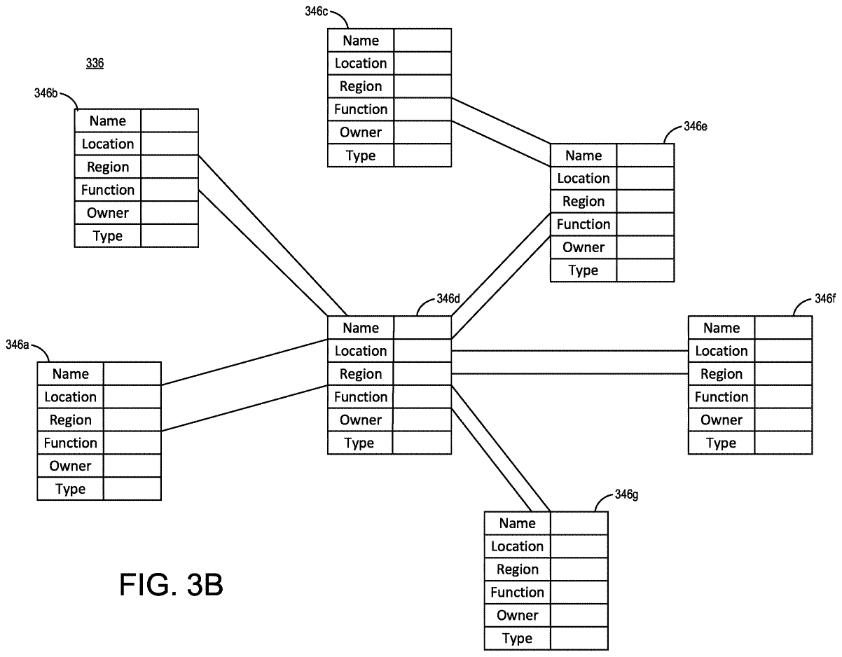

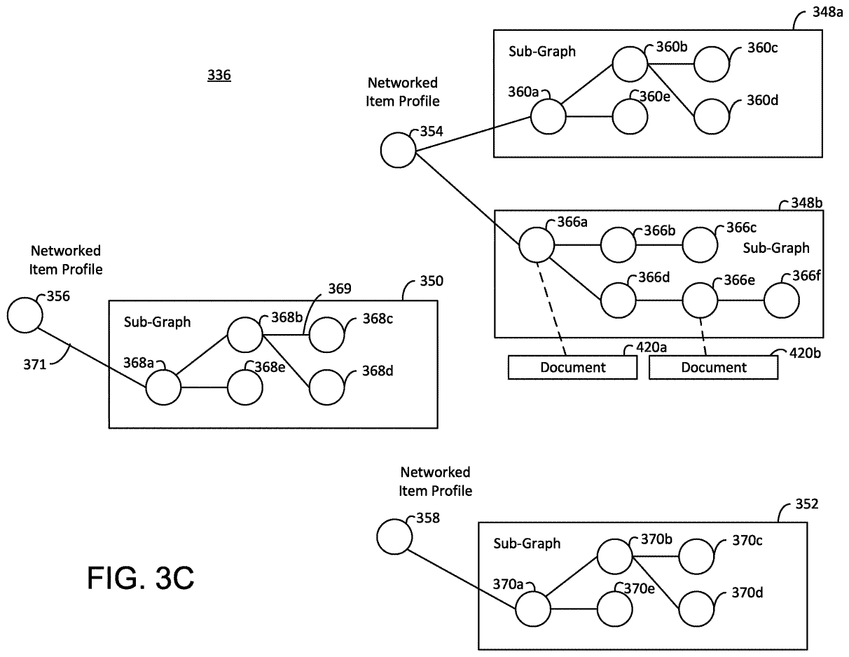

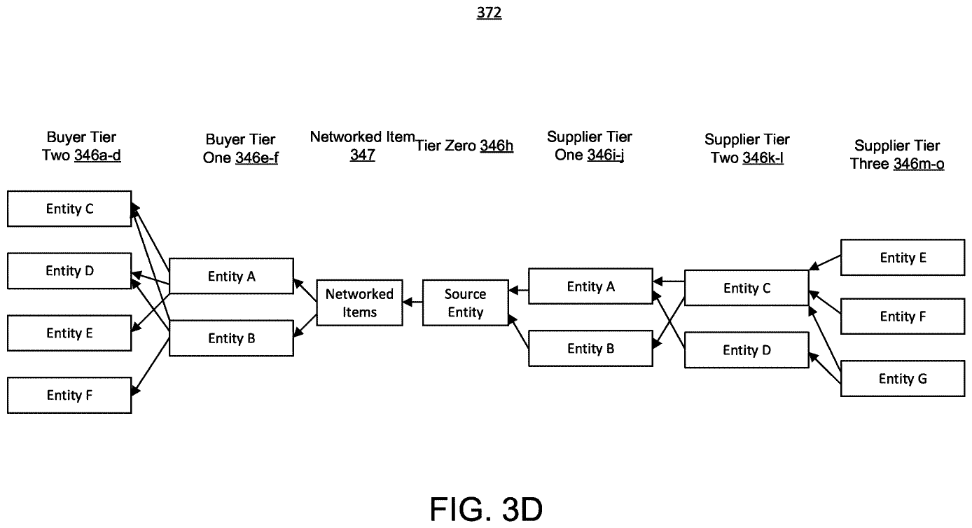

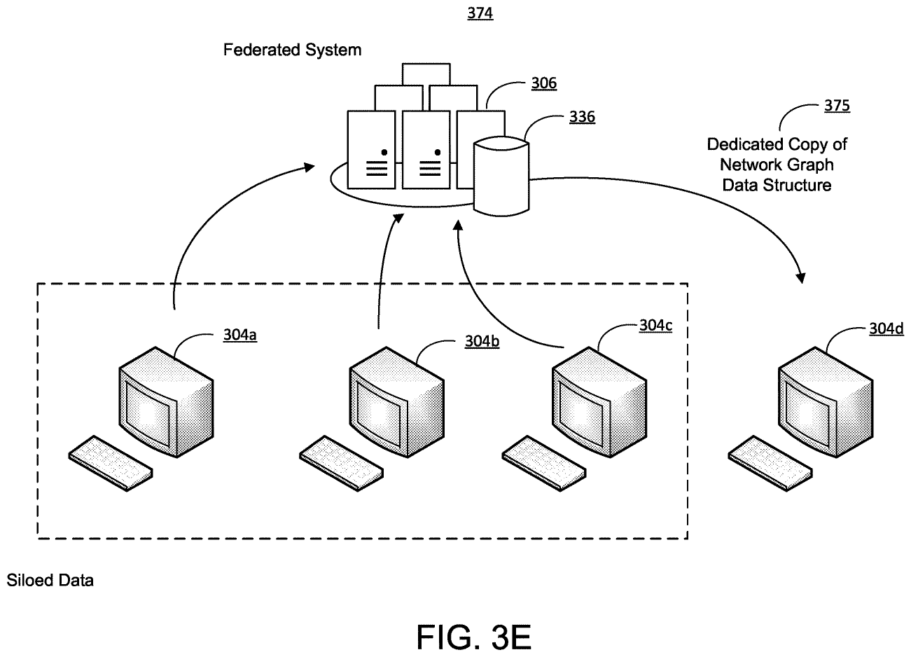

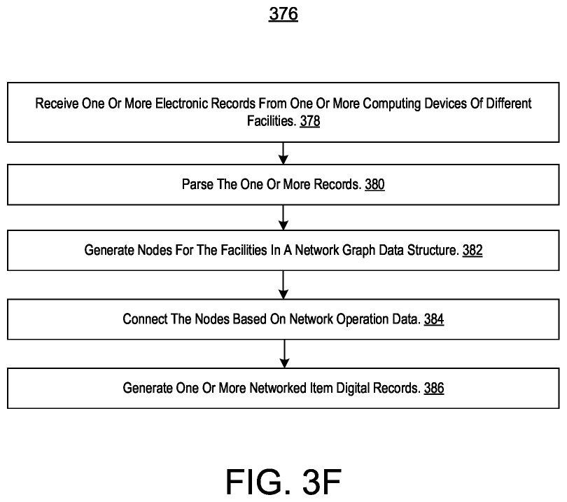

FIG. 3A is an illustration of an example system 300 for network graph data structure-based transportation networking, in accordance with an implementation. In brief overview, the example system 300 can include a client device 302, computing devices 304a-304c (individually, computing device 304, and together, computing devices 304), and a data processing system 306. The system 300 can include more or fewer components than illustrated in FIG. 3A, depending on the implementation. Each of the computing devices 304 can be configured to store various types of data and perform various types of operations discussed in this disclosure. The data processing system 306 can execute a language processing model (e.g., a large language model) to receive and/or process contextual information regarding database transactions or other communications from a user (e.g., a user accessing the client device 302) of the data processing system 306 and/or data received from the computing devices 304. The data processing system 306 can transmit the contextual information to the computing devices 304 for storage.

The client device 302 can be an electronic computing device (e.g., a cellular phone, a laptop, a tablet, a personal computer, or any other type of computing device). The client device 302 can include a display with a microphone, a speaker, a keyboard, a touchscreen, or any other type of input/output device. A user can access a platform provided by the data processing system 306 through the client device 302 to view outputs of machine learning models and/or otherwise access a portions of a network graph data structure (e.g., a knowledge graph or a graph data structure storing nodes and edges) provided generated and/or provided by the data processing system 306. In one example, the user can transmit a request including an identification of a networked item to the data processing system 306. The data processing system 306 can receive the request and retrieve data from a network graph data structure hosted or maintained by the data processing system to generate context or other requested information regarding the identified networked item. The data processing system 306 can transmit the generated context or requested information back to the client device 302. The data processing system 306 can receive and/or transmit such data over a network (e.g., a synchronous or asynchronous network).

The computing devices 304 can each be or correspond to facilities or locations in a transportation network. The facilities can be or include physical locations or sites within a value chain in which operations or processes take place to generate, modify, assemble, store, distribute, or otherwise deliver products or services. Facilities may include manufacturing plants, warehouses, distribution centers, transportation hubs, retail outlets, data centers, or other relevant infrastructure locations. Collectively, these facilities can facilitate the efficient movement and transformation of goods and services across various stages of the value chain, from initial sourcing and supply, through intermediate processing or logistics, and ultimately to the end user or consumer. The transformation and movement can each be a network operation indicating an operation performed on networked items as they move or are transformed across a network of facilities.

For example, a value chain for a consumer electronics product such as a smartphone may include the transportation and transformation of the smartphone across different facilities of the value chain. In the value chain, a first facility in the value chain can be a manufacturing plant, where components are initially assembled into finished products, such as the smartphone. The components of the smartphone can each originate at other facilities of the value chain, such that each facilitate may include multiple inputs to generate one or more outputs for the value chain for a single product. The smartphone can be transported to another facility in the value chain, such as a warehouse facility, which can store completed products awaiting orders from distributors or retailers. From the warehouse facility, the smartphone may be transported to another facility, such as a distribution center or transportation hub, where products are sorted, packaged, and dispatched to retail outlets or directly to end users.

A second example can be a value chain for food products. In this example, facilities may include food processing plants, which can transform raw agricultural produce into packaged and marketable food networked items. From these processing plants, the products may be transported to cold storage or refrigerated warehousing facilities for product freshness and safety. subsequently, transportation hubs or logistics centers can coordinate the distribution of the food products to supermarkets, grocery stores, or directly to consumers, completing the flow from farm to table for the value chain for the food products.

Facilities within a value chain can provide electronic documentation about their roles and operations in the value chain by transmitting relevant data from their respective computing devices 304 to the data processing system 306. For example, a manufacturing plant can use its computing device 304 to transmit detailed production reports that include finished quantities, malfunction logs, quality assurance metrics, and resource consumption data to the data processing system 306. Similarly, warehouse and storage facilities can utilize their respective computing devices 304 to regularly provide inventory updates, storage conditions, inbound delivery notifications, outbound shipment records, and product-handling information to the data processing system 306. By electronically transmitting ongoing documentation regarding inventory status, product movements, batch numbers, expiration dates, and environmental conditions (for example, temperature or humidity sensor readings), these facilities allow the data processing system 306 to maintain continuous visibility into different value chains in which the facilities are a part and the network operations performed by the facilities.

Additionally, logistics hubs and distribution centers may similarly rely upon their computing devices 304 to relay shipping and transportation documentation to the data processing system 306. The computing devices 304 for the logistics hubs and distribution centers can transmit information, such as shipment tracking data, freight bills, estimated delivery timelines, route details, transport conditions, and real-time status updates on transit delays or incidents can be to the data processing system 306.

The data processing system 306 may include one or more processors that are configured to maintain and update a network graph data structure, such as for transportation network management. The data processing system 306 may include a communication interface 308, a set of processors 310, and a memory 312. The data processing system 306 may communicate with the computing devices 304 via the communication interface 308, which may be or include an antenna or other network device that enables communication across a network and/or with other devices. The memory 312 may include a record collector 314, a record parser 316, a graph generator 318, a digital record generator 320, a network facilitator 322, an item classifier 324, a language model 326, an input-output prediction engine 328, a graph analyzer 330, a model manager 332, a record generator 334, a network graph data structure 336, and/or a system of record 338.

The set of processors 310 may be or include an application-specific integrated circuit (ASIC), a set of field programmable gate arrays (FPGAs), a set of digital signal processors (DSPs), circuits containing one or more processing components, circuitry for supporting a microprocessor, a group of processing components, or other suitable electronic processing components. In some embodiments, the set of processors 310 may execute computer code or modules (e.g., executable code, object code, source code, script code, machine code, etc.) stored in the memory 312 to facilitate the operations described herein. The memory 312 may be or include any volatile or non-volatile computer-readable storage medium capable of storing data or computer code.

One or more of the computing devices 304 or the data processing system 306 can include or utilize at least one processing unit or other logic devices such as a programmable logic array engine or a module configured to communicate with one another or other resources or databases to perform one or more of the operations described in this disclosure. As described herein, computers can be described as computers, computer devices, computing devices, or client devices. One or more of the computing devices 304 may each contain their own computer resources (e.g., processor, memory, etc.), share computer resources, or be part of a distributed computer system. The components of the computing devices 304 or the data processing system 306 can be separate components or a single component. The example system 300 and its components can include hardware elements, such as one or more processors, logic devices, or circuits. The computing devices 304 or the data processing system 306 can each be a server or computer that is configured to store various types of data, such as data stream data, image data, audio data, other types of content data, etc. For example, the computing devices 304 or the data processing system 306 can each store records for different accounts in memory (e.g., in a database in memory), where such media may include non-transitory machine-readable media used to store program instructions for performing one or more operations described in this disclosure.

The record collector 314 may include instructions that, when executed by the set of processors 310, cause the set of processors 310 to aggregate and retrieve or receive data from different sources, such as the computing devices 304. The record collector 314 may perform such operations by implementing various retrieval methods such as polling, change data capture (CDC), or event-driven mechanisms to fetch real-time data updates. For handling real-time data collection, the record collector 314 may employ message queues like Apache Kafka or RabbitMQ to buffer incoming data streams and prevent data loss during high-volume periods. In some cases, the record collector 314 can receive and/or manage data reception of electronic documents or records that the computing devices 304 transmit to the data processing system 306.

The record collector 314 may store the collected electronic documents or records within the system of record 338. The collected records may be stored in a structured manner, enabling efficient indexing, querying, and retrieval of information. For example, the computing devices 304 of the different facilities involved in one or more value chains may transmit records to the data processing system 306. Examples of records that the data processing system may receive can include, in addition to any other types of records:
Manufacturing facility records, such as production run reports, quality control data, defect logs, maintenance schedules, machine downtimes, and resource utilization reports.
Warehouse and inventory management records, such as detailed inventory counts, storage condition logs (e.g., temperature and humidity readings), product expiration dates, batch numbers, incoming delivery details, and outbound shipment data.
Logistics and transportation records, including shipment tracking records, freight bills, customs declarations, delivery confirmation receipts, transportation delay reports, real-time GPS coordinates, carrier performance metrics, and incident or accident documentation.
Records relating to retail or distribution centers, such as inventory sales data, return processing documents, reorder logs, store stock levels, and customer demand forecasts.
Event-driven notifications, such as alerts of supply chain disruptions, inventory shortages, equipment failures, or transportation route changes.
Operational transaction data, including purchasing or procurement orders, invoice records, payment confirmations, and financial transaction logs.
Compliance or regulatory records documenting adherence to applicable regulations, standards, certifications, inspection reports, and audit trails from each facility.
Ownership/directorship information, including ownership and directorship by companies and individuals. Moreover, the sanctioned/denied/risk status of these related entities, their physical locations, nationalities, and similar information.
Records including sanctions lists, denied party lists, geographic information (e.g., if a network operation is a denied or sanctioned region), etc.
   The record collector 314 may receive such records as sets of data or electronic documents or files and store the records in the system of record 338.

In one example, the record collector 314 can be, include, or interface with an application programming interface (API) that facilitates communication between the data processing system 306 (e.g., via the communication interface 308 of the data processing system) and other computing devices, such as the client device 302 and/or the computing devices 304. The record collector 314 may communicate with the client device 302 and/or the computing devices 304 across a network.

For instance, the record collector 314 can establish a connection with one of the computing devices 304. The record collector 314 can establish the connection with the computing device 304 over the network. To do so, the record collector 314 can communicate with set of servers across the network. In one example, the record collector 314 can transmit a syn packet to the computing device 304 (or vice versa) and establish the connection using a TLS handshaking protocol. The record collector 314 can use any handshaking protocol to establish a connection with the computing device. The data processing system 306 can communicate with the computing device over the established connection.

Over the established connection, the computing device 304 can transmit one or more records for a facility. The records can include, for example, one or more shipment tracking records, bills of materials, freight bills, delivery confirmation receipts, transportation delay reports, real-time GPS coordinates, carrier performance metrics, or incident or accident documentation. The record collector 314 can receive the records and store the records in the system of record 338.

The record parser 316 may include instructions that, when executed by the set of processors 310, cause the set of processors 310 to parse the records received by the record collector 314 and/or retrieved from the system of record 338. In some cases, the record parser 316 can parse the records using machine learning (including techniques such as natural language processing, image processing, and usage of contextual graph information) techniques, such as by extracting relevant operational data elements and facility-specific details from the electronic records transmitted by computing devices 304 of different facilities within the value chain. For example, the record parser 316 may use natural language processing techniques such as named entity recognition to identify (e.g., automatically identify) facility names, locations, equipment identifiers, product batch numbers, or shipment tracking numbers from textual records. Relationship extraction methods may be employed to identify connections between different entities, for instance, associating product batch information with manufacturing dates, quality inspection results, or origin/destination details from logistics records. Additionally, the record parser 316 may apply text classification or rule-based parsing methods to categorize records based on facility roles (e.g., manufacturing, warehousing, transportation, etc.). In some cases, the record parser 316 can normalize extracted data into standardized formats to aggregate, index, analyze, and report across datasets from multiple facilities consistently and efficiently. In some embodiments, domain-adapted machine learning models trained specifically on facility-generated documentation and supply chain terminology may further enhance the parsing accuracy and comprehensiveness of the data extraction process. The record parser 316 can identify or extract such information from the different records and store the extracted or identified data in the system of record 338.

The system of record 338 can be a relational or any other type of database that is configured to store records collected by the record collector 314 and/or data parsed or extracted from such records by the record parser 316. The system of record 338 may store structured and normalized operational data parsed from electronic records transmitted by computing devices 304 associated with facilities throughout the value chain. Examples of such operational data stored in the system of record 338 may include production run details, quality inspection results, detailed inventory levels, shipment tracking logs, logistics incidents and delays, product batch identifiers, facility locations, and transactional or compliance documentation. By maintaining this comprehensive and structured data repository, the system of record 338 can facilitate the data processing system 306 performance of efficient support queries, analytics, reporting, real-time decision-making, and/or proactive management of the overall value chain operations. The system of record 338 can also be configured to provide interfaces or data-access layers that allow other components or services within or external to the data processing system 306 to easily access and retrieve such stored information for downstream processing, visualization, or further analysis. In some cases, the system of record 338 can include the network graph data structure 336 and/or include different notes or comments about the network graph data structure 336.

The graph generator 318 may include instructions that, when executed by the set of processors 310, cause the set of processors 310 to generate the network graph data structure 336. The graph generator 318 can generate the network graph data structure 336 based on (e.g., based only on) records and/or parsed data stored in the system of record 338. For example, from the stored records and/or parsed data, the graph generator 318 can generate one or more nodes that each represent a different facility that is involved in at least one value chain. The graph generator 318 can generate edges between pairs of nodes representing pairs of facilities that represent or indicate the transportation of networked items or components used to create or transform individual the networked items. An edge between a pair of nodes representing a pair of facilities can indicate the output from one facility of the pair of nodes that is input into another facility of the pair of nodes. The graph generator 318 can additionally or instead generate nodes that represent different networked items (e.g., items that are transformed and/or transported across a value chain). The graph generator 318 can generate edges between the nodes for the networked items to the facilities that are involved in the transportation and/or creation of the respective networked items. The graph generator 318 can generate the edges by storing identifications of the nodes connected by the edges in the respective nodes. The graph generator 318 generate the nodes and/or edges between nodes in the network graph data structure 336.

The network graph data structure 336 can be or include a graph data structure configured to store different nodes of value chains for different networked items. The nodes can each be or include a separate data structure with node field-value pairs that each correspond to a different type of data regarding a facility represented by the node. For instance, the individual nodes can each include node field-value pairs for a name or identifier of the facility represented by the node, a type of node (e.g., manufacturing, warehousing, transportation, etc.), a description of the function of the node, a location (e.g., geographic location) of the node, a region of the node, an owner of the node, etc. Each node field-value pair can include an identification of the type of the node field-value pair and a value for the node field-value pair. The graph generator 318 can identify values for the node field-value pairs from the records and/or parsed data of the system of record 338 and store the values in the corresponding node field-value pairs.

The network graph data structure 336 can be or include one or more sub-graph data structures 340. Each of the sub-graph data structures can represent a value chain for generating a networked item. For instance, each sub-graph data structure 340 can be linked by an edge with a profile data structure or networked item profile 342 for a networked item that is generated by a value chain that the sub-graph data structure 340 represents. The individual sub-graph data structures 340 can each include a chain of nodes. The chain of nodes can be or include a sequence of connected nodes forming a path of one or more instances of the networked item from a source node (e.g., a source node or initial node of the chain of nodes or the sub-graph data structure 340) to a destination node (e.g., a destination node or last node of the chain of nodes or the sub-graph data structure 340). The path can represent network operations of one or more instances of the networked item through the sequence of connected nodes. In some cases, each node of the sequence of connected nodes represents an entity performing a network operation on the one or more instances of the networked item. Each edge between one or more pairs of the sequence of connected nodes can represent movement, transfer, or transport of the one or more instances of the networked item from a first node (e.g., a source node) of the pair of nodes to a second node (e.g., a destination node) of the pair of nodes.

In some cases, the graph generator 318 can perform entity resolution techniques to modify the network graph data structure 336. For example, the graph generator 318 can extract of facility-related references from electronic records parsed by the record parser 316. For instance, the record parser 316 can identify a facility's name, location, and equipment identifiers from shipment tracking logs and quality inspection reports. Once these references are extracted, the graph generator 318 can move to a resolution phase. In the resolution phase, the graph generator 318 can match each extracted reference to existing entities within the system of record 338 or, if no match is found, create a new entity to represent the facility or item. The graph generator 318 can generate nodes in the network graph data structure 336 for new entities that the graph generator 318 identifies. In doing so, the graph generator 318 can ensure that each node in the network graph data structure 336 corresponds to a unique, defined entity, minimizing duplication and enabling accurate representation of relationships within the network graph data structure 336.

The digital record generator 320 may include instructions that, when executed by the set of processors 310, cause the set of processors 310 to generate networked item profiles 342 and/or networked item digital records (e.g., passports) for different networked items for which value chains are represented in the network graph data structure 336. The networked item profiles 342 can be or include nodes or profiles that store data the networked items represented by the networked item profiles 342. For example, the networked item profiles 342 can be or include separate data structures that represent the respective networked items. The data structures can each be or include one or more attribute field-value pairs that each correspond to attributes of the respective networked items. Examples of attribute field-value pairs can include classifications, carbon footprint for manufacturing the networked items., revenue, origin, etc. The digital record generator 320 can generate networked item profiles 342 for different networked items using data stored for the networked items from the system of record 338. The graph generator 318 can store the networked item profiles 342 in the network graph data structure as profiles 342 as nodes of the network graph data structure 336. In doing so, the graph generator 318 can generate edges between the networked item profiles 342 and nodes representing facilities (e.g., the origin or initial facilities) of value chains involving the networked item or that are used to generate networked items of the respective networked item profiles 342.

The digital record generator 320 can generate networked item digital records for different networked items. The networked item digital records can be or include a view into the network graph data structure 336 that includes one or more sets of nodes or sub-graph data structures indicating one or more value chains of the networked items associated with the networked item digital records. The networked item digital records can each correspond to one or more networked items. The digital record generator 320 can generate the networked item digital records to each have a unique identifier (e.g., a passport identifier or a digital record identifier) that operates as an address for the networked item digital record. The digital record generator 320 can generate the networked item digital records to include identifications of one or more networked item profiles 342, identifications of individual nodes, and/or identifications of different sub-graph data structures or value chains for networked items. In some cases, the networked item digital records can include the profiles, nodes, and/or sub-graph data structures themselves.

The digital record generator 320 can generate the networked item digital records based on user selections that the digital record generator 320 receives, such as from the client device 302. For example, a user can provide an input to generate a networked item digital record for a networked item. The user can then provide an input selecting a networked item profile for the networked item and one or more sub-graph data structures indicating sets of nodes representing value chains in which the networked item is involved. The digital record generator 320 can receive the selections and generate a networked item digital record for the networked item by generating an identifier for the networked item digital record as well as identifying identifiers for each of the selected networked item profile and the sub-graph data structures and/or nodes of the sub-graph data structures. The digital record generator 320 can store a file including the identifiers and/or the data structures of the selected networked item digital record and the sub-graph data structures or nodes. The digital record generator 320 can store the file in the network graph data structure 336 as one of a plurality of networked item digital records 344.

The digital record generator 320 can generate the digital records to include or correspond to role-based access controls and/or permissioning. For example, in some cases, the digital records can facilitate workflows for publishing, requesting, and/or sharing data of the network graph data structure 336. The digital record generator 320 can use the digital records to do so with subscriber management by applying access control to fields, edges, and/or nodes of the network graph data structure 336. The digital records can be transmitted via HTTP-shareable links with access-controlled views. The access controls can indicate which users or accounts can view or otherwise access which data or segments of data (e.g., defined portions of the network graph data structure 336). In an example, for individual nodes or edges, different users can view the values of different subsets of fields of the nodes or edges based on the access controls of the users' accounts. The access controls can be defined in the profiles of the users and/or as attributes of the nodes, edges, and/or fields themselves. Because the different users may have access to different fields and digital records only provide views into the network graph data structure, different users or accounts viewing the same digital record may have access to different data (e.g., different fields and/or values). Such may be the case when the digital records are live views into the network graph data structure 336 and/or when digital records contain the data, such as because the access permissions may be indicated in the digital records and/or restricted locally in the accounts of the users.

Another example, in which access controls and permissioning of digital records can apply includes version history. For example, a digital record may store different versions of the corresponding portion of the network graph data structure 336 over time. Different users or accounts may have settings that indicate the accounts can only access specific versions of the portion of the network graph data structure 336. For instance, one account may be restricted to access to the current version of the portion of the network graph data structure 336 (e.g., the current edges and nodes displayed or included of the portion of the network graph data structure 336 represented by the digital record) while another account may have access to all versions that are available, which can be useful when reviewing historical data of the portion of the network graph data structure 336. In another example, individual accounts may only have access to a particular sub-graph data structure in the portion of the digital record, which may represent or include multiple sub-graph data structures for the same networked item. Such may be the case, for example, such that nodes that are a part of the sub-graph data structure may only have access to the sub-graph data structure of which they are a part for privacy purposes. The digital record can provide the capability for multiple users to view selected or defined portions of the network graph data structure 336 for updating the portions, such as in response to requests for tasks or by otherwise accessing the digital records.

The network facilitator 322 may include instructions that, when executed by the set of processors 310, cause the set of processors 310 to facilitate the transfer of networked items across a network nodes. The network facilitator 322 can do so, for example, by responding to requests from computing devices regarding whether networked items satisfy a set of rules. For instance, the network facilitator 322 can store a set of rules that indicate criteria that networked items can satisfy during the transfer or transportation of the networked items between facilities, in some cases across the border. In response to a request, the network facilitator 322 can identify a networked item digital record for the networked item from the network graph data structure 336. The network facilitator 322 can identify the networked item digital record, for example, by identifying the networked item digital record based on the networked item digital record containing an identification of the networked item or by identifying an address of the networked item digital record that was contained in the request. The network facilitator 322 can retrieve the networked item digital record and identify a networked item profile for the networked item and/or the nodes containing data regarding one or more transformations and/or transportations of the networked item. The network facilitator 322 can retrieve data from the respective profiles and/or data structures. The network facilitator 322 can apply the set of criteria to the retrieved data to determine whether the data for the networked item satisfies the set of criteria. Responsive to determining the set of criteria is satisfied, the network facilitator 322 can generate a flag indicating the transfer or transport of the networked item is allowed. Otherwise, the network facilitator 322 can restrict the transfer or transport of the networked item by generating an alert or otherwise operating a machine to restrict the movement of a vehicle from transferring or accepting the networked item.

The item classifier 324 may include instructions that, when executed by the set of processors 310, cause the set of processors 310 to generate classifications for networked items. The item classifier 324 can generate classifications for networked items in response to requests from computing devices, such as the client device 302. For example, the item classifier 324 can receive a request containing an identification of a networked item. The request can be for a classification (e.g., a harmonized system (HS) code for the time) for the networked item. The item classifier 324 can receive the request and identify one or more sub-graph data structures from the network graph data structure 336 that correspond to the networked item (e.g., correspond to facilities that facilitate the transformation and/or transport of the networked item and/or components of the networked item). The item classifier 324 can use edges between the sub-graph data structures to identify different information about the networked item, such as a source node (e.g., source facility) for the networked item and/or a destination node (e.g., a destination facility) for the networked item.

The item classifier 324 can use the retrieved data from the network graph data structure 336 to generate either a prompt or a prompt augmented for the language model. The language model 326 can be or include a large language model, a transformer, a neural network, etc., that is trained to generate responses to input containing different types of content, such as images, text, or videos. The item classifier 324 can generate a prompt containing the identification of the networked item and/or any information retrieved from the network graph data structure 336 regarding the networked item in response to the request. In some cases, the item classifier 324 can include features (e.g., textual, numeric, categorical, graph-based features, or image features) of the networked item in the prompt. This description may be augmented with graph context (buyers and suppliers of the good, their extended relationships) as well as characteristics such as the weight, value, and similar of the good. The item classifier 324 may receive the description in the request or by retrieving the text description from the networked item profile for the networked item stored in the network graph data structure 336. The item classifier 324 can generate such a prompt and input the prompt into the language model 326. The item classifier 324 can execute the language model 326 based on the input to cause the language model 326 to output a classification for the networked item and/or a confidence score for the classification for the networked item.

The item classifier 324 can compare the confidence score for the classification to a threshold. Responsive to determining the confidence score exceeds the threshold, the item classifier 324 can generate a visual representation of the classification and/or the confidence score for the classification. The item classifier 324 can transmit the visual representation of the classification to the client device that transmitted the request.

In cases in which the item classifier 324 determines the confidence score is less than the threshold, the item classifier 324 can retrieve further information regarding the networked item. The item classifier 324 can do so, for example, by querying a network (e.g., the Internet) for one or more databases that store data regarding networked items that contain matching identifiers to the identifier received in the request. The item classifier 324 can retrieve information regarding the networked item from such databases enrich the prompt with the retrieved data. The item classifier 324 can input the enriched prompt into the language model 326 and execute the language model 326 to generate a classification and/or a confidence score for the classification. The item classifier 324 can repeat this process any number of times until determining or identifying a confidence score for a classification that exceeds the threshold.

The item classifier 324 can use any type of machine learning model to generate classifications for networked items of network operations. The item classifier 324 can do so using the retrieved data from the network graph data structure 336. The item classifier 324 can use the retrieved data to generate a feature vector for input into any type of machine learning model. For example, the item classifier 324 can generate a feature vector of numeric values from the records. The item classifier 324 can do so by inserting extracted numeric values from the records and/or converting text or other attributes from the records into the numbers for inclusion in the feature vector. The item classifier 324 can insert the feature vector into a neural network configured or trained to generate classifications of network items of networked operation. The item classifier 324 can execute the neural network based on the input to cause the neural network to generate a classification for the networked item and a confidence score for the classification. Responsive to determining the confidence score does not exceed a threshold, the data processing system can retrieve further data about the networked item and execute the neural network again to determine a classification and a new confidence score. The data processing system can repeat this process until identifying a classification and a corresponding confidence score that exceeds or satisfies a threshold. The item classifier 324 can use any type of machine learning model for classification.

The input-output prediction engine 328 may include instructions that, when executed by the set of processors 310, cause the set of processors 310 to generate predictions for inputs and/or outputs of nodes of the network graph data structure 336. For instance, the input-output prediction engine 328 can be or include one or more machine learning models (e.g., neural networks, support vector machine, random forests, etc.) that are each configured to generate a prediction regarding an input to a node and/or an output of a node. Examples of inputs can be or include different types of energy (e.g., coal, electricity, gas, etc.) the facilities represented by the nodes use for operation, the amount of energy the facilities use for a defined time interval, components that the facilities receive from other facilities, types of transportation through which the facilities receive inputs, the facilities that provide the inputs, etc. The outputs can be the types of networked items or components the facilities produce, environmental emissions or outputs the facilities produce, etc. The input-output prediction engine 328 can predict such inputs and/or outputs based on any type of data or metadata regarding the facilities, such as based on identification of the technology the facilities use, identifications of the inputs and/or outputs of the facilities, the number of employees, the geography or region of the facilities, the number of network operations that the facilities are involved in, etc. The input-output prediction engine 328 can generate predictions based on such inputs or outputs. The input-output prediction engine 328 can store the predictions in the data structures or nodes of the network graph data structure 336 for which the input-output prediction engine 328 generated the predictions.

In some cases, the input-output prediction engine 328 can store and/or include an input-output matrix. The input-output matrix can map input items with classifications or directly to determine relevance for target item generation. This matrix can operate as a lookup table that facilitates fast identification of pertinent input/output relationships without requiring extensive graph traversal. The system can perform classification-based queries against this matrix, in some cases using item classifications or other types of data (e.g., textual description, numeric characteristics, categorical values, and/or graph connections) as keys to identify which inputs should be included in or discarded from the sub-graph generation process. Generating and using the input-output matrix in this way can transform the conventionally recursive and computationally expensive process of dependent graph traversal into an efficient and direct lookup operation that scales with the size of the network graph data structure.

Additionally, the input-output prediction engine 328 can implement one or more semantic models, such as generative models, foundational neural net models, transformer models, convolutional or recurrent neural networks, BERT models, SBERT models, etc., that analyze textual descriptions of items to make more nuanced determinations about input-output relationships. These semantic models can provide an additional layer of intelligence beyond classification matching using the input-output matrix, facilitating the data processing system 306's ability to understand contextual relationships between items based on their descriptive content. The semantic analysis can aid in resolving ambiguous cases where matrix-based filtering alone might be insufficient, ensuring that the generated sub-graphs capture the most accurate and relevant dependency relationships for the corresponding target items.

Moreover, the model manager 332 can continuously increase the accuracy of the models involved in evolving operational environments through continuous learning. For example, the model manager 332 can train and retrain large language models or other type of machine learning model or generative model, including those with graph based and contextual features, using records of actual network operations and item transfers. The model manager 332 can use the trained large language models or machine learning models to enable the input-output matrix to adapt to changing operational patterns. This dynamic updating capability ensures that the sub-graph generation process remains accurate as new items are introduced, relationships change, or operational procedures evolve. The continuous learning approach prevents the degradation of system accuracy.

The graph analyzer 330 may include instructions that, when executed by the set of processors 310, cause the set of processors 310 to generate metrics for the network graph data structure 336. The graph analyzer 330 can generate the metrics for individual nodes in the network graph data structure 336, individual networked item profiles of the network graph data structure 336, individual sub-graph data structures of the network graph data structure 336, etc. The graph analyzer 330 can generate the metrics based on the data stored in the network graph data structure 336 for the respective nodes, sub-graph data structures, and/or networked item profiles. The graph analyzer 330 can generate the metrics and store the metrics in network graph data structure 336 and/or the system of record 338.

The model manager 332 may include instructions that, when executed by the set of processors 310, cause the set of processors 310 to generate manage the different computer models (e.g., optimization models, machine learning models, etc.) stored by the data processing system. The model manager 332 may execute and/or train the different machine learning models and/or other types of computer models to generate outputs based on data stored in the network graph data structure 336, the system of record 338, and/or any other data sources.

The model manager 332 may be or include a task agent that is configured to execute different applications and/or models stored by the data processing system 306 to perform different tasks. For instance, the task agent can be or include one or more large language models and/or other types of machine learning models. The task agent can determine the intents of queries (e.g., natural language queries) and use the intents to determine one or more tasks to perform. The task agent can identify a relevant sets of instruction, model, and/or application of the components 314-330 and/or 334 to use to perform a task, execute the identified set of instructions, model, and/or application, determine if the task are completed based on the execution, identify another set of instructions responsive to determining the task is not completed, and repeat this process until determining the task and/or each task is completed.

The model manager 332 may include a model 333. The model 333 can include one or more of the models described herein as being processed or executed by the data processing system 306, such the language model 326 and/or the models for classification of the input-output prediction engine 328. The model manager 332 can execute and/or train the model 333 to perform different tasks, such as classifying networked items, generating risk scores for network operations, generating risk scores for entity nodes, etc. The model manager 332 can train such models using data from the network graph data structure 336 and/or ground truth information (e.g., from the network graph data structure 336 or from another source, such as the system of record 338 or an external database or data source). The model manager 332 may do so as a task agent or any type of model or application that the data processing system 306 can execute.

The record generator 334 may include instructions that, when executed by the set of processors 310, cause the set of processors 310 to generate records (e.g., user interfaces, databases, tables, files, etc.). The record generator 334 can generate records containing data that is requested by different computing devices. In some cases, the record generator 334 can generate the records to include data generated by one or more of the network facilitator 322, the item classifier 324, the language model 326, the input-output prediction engine 328, and/or the graph analyzer 330. The record generator 334 can (e.g., through the record collector 314) transmit such records to the requesting computing devices and/or store the records in the system of record 338 and/or the network graph data structure 336.

FIG. 3B illustrates an example of the network graph data structure 336 storing nodes representing the networking of the transportation and/or transformation of different networked items across a network, in accordance with an implementation. As illustrated, the network graph data structure 336 can include one or more nodes 346a-g (individually, node 346 and together, nodes 346) that represent different facilities. The nodes 346 can be connected by edges that each represent network operations (e.g., transfers, transformations, or transportation instances) between the respective nodes 346. The nodes 346 can each include one or more node field-value pairs for different types of characteristics or attributes of the facilities represented by the nodes 346. The nodes 346 can include one or more attributes such as, for example, name, location, region, function, owner, type, etc.

The edges of the network graph data structure 336 can be or include data structures (e.g., edge data structures). For example, the edge data structures can each include one or more edge field-value pairs for different types of characteristics or attributes of the network operations represented by the edges. The edges can include one or more attributes such as, for example, identifier or name of the networked item being transported or transferred, quantity (e.g., number of networked items of a shipment and/or weight of an individual network item and/or weight of the total networked items being transferred in the network operation), a time and/or date of the network operation, a classification (e.g., an HS classification) of the networked item, a description (e.g., a text string description) of the networked item, a method of transport, etc. The edge data structures can each include identifiers of the nodes that the edges are connecting, in some cases forming the edge in a structured manner.

### Master Data Objects

The network graph data structure 336 can include master data objects that store data for specific types of networked items represented in the network graph data structure 336. Non-limiting examples of networked items for which the network graph data structure 336 may store master data objects include products, organizations, locations, customers, users, suppliers, orders, directors, shareholders, shipments, and customs entries. Details regarding these data objects are below.
Product
   The “output” Product is the primary focus in the Catalog and in the overall value chain management system design
   Input Products are also linked to the output Product via a Bill of Materials
   Products can be linked across value chains networks, and specifically through the Systems of Record of “active” registered organizations, via product passports
   Attributes
      Revenue (for output Products)
      Spend (for input Products)
      Bill of Materials
      Certificate of Origin
      Free trade agreement qualification
      Product Carbon Footprint
      HS codes (by jurisdiction)
      Duty/tariff owed by jurisdiction and date
      Deforestation impact
      Forced labor risk
      Material Safety Data Sheet
      Third Party Certifications
      Images
      Reports/Attestations generated within the system
      The system ID and system-generated QR Code
      Any other attributes can be specified by users involved (e.g., the parties involved) in the need for the product passport.
Organizations
   Registered Organization
      This organization type is meant to capture the general sense of a “counterparty” entity in a global b2b or B2g interaction. I sell to Crystal and Stone Co., and not the Smith family. I import my goods with the customs agency and not the government. I buy jet engines from Acme Co. and not the parent company Globex. I fly on Jets Airways and not the regionally-licensed subsidiary.
      Registered organizations include 1) any customer-provided company counterparty node listed in their Catalog, and/or 2) system-created registered organizations generated through AI systems operating on customer and third party data, but not in reliance on, or re-constituting, any one corporate firmographic dataset.
         Registered organizations can have one or more Legal Organizations, Legal Entities, and Facilities linked to them.
      Government, non-profits, academic institutions, etc. can be registered organizations—not just corporate entities
      Attributes of registered organizations:
         Website
         Brands
         Legal Organizations linked through ownership
         Facilities
         User registries
         Sanctions/denied party status
         Revenue
      A canonical legal entity provided by a third party corporate register
Locations
   Facility
      A system-generated entity that is comprised of a 1) physical address, and 2) a business relationship edge (mostly shipments, but summary buyer-supplier edges work too)
   Area
      Polygon
      Attributes:
         Land use
         Deforestation risk
Customers
   Customers are registered organizations, and can be linked to one or more output Products in the Catalog
Suppliers
   Suppliers are registered organizations, and can be linked to one or more input Products in the Catalog
Orders
Shipments
Customs Entries

### Insight Objects

The network graph data structure 336 can include or be associated with insight objects. The insight objects can store data generated from metrics or analytics performed on the nodes or objects of the network graph data structure 336. Examples of insights for which the network graph data structure 336 may store insight data objects include exposure, event, opportunity, and change. Details regarding these data objects are below.
Exposure
   Compliance risk
   Business interruption risk
   Geopolitical risk
Event
   AI event
      Subcategories thereof
   System network event
      Placeholder for events generated based on the network graph data structure 336 and/or network
Opportunity
   Placeholder for an insight type that is an opportunity, such as a “recommended supplier” or “recommended customer”
Change
   A graph change that affects a customer's VC network

### Task Objects

The network graph data structure 336 can include or be associated with task objects. The task objects represent or include data for any type of data object of the network graph data structure 336 or associated with the network graph data structure 336. In some cases, task objects can be grouped or linked into a larger “job” data structure representing different actions to be performed to accomplish a job associated with the job data structure. Details regarding task data objects are below.
Tasks can be collaborative pages that allow for internal and external collaboration/communication and role-based abilities to:
   Edit, annotate, and append Master Data Objects
   Disposition Insight Objects
   Share or request Passports, including designating data and documents to share or request within the Passport
Examples of tasks can include
   Exposure Assessment, which may be subdivided into two tasks that include:
      Network Validation
      Exposure Validation
   Event Assessment, which may be subdivided into two tasks that include:
      Network Validation
      Event Characterization
   Duty/tariff assessment
   Free trade agreement qualification
   Proving deforestation free production
   Calculating and proving embodied carbon impact
   Classification
   Connection
      Facilitation (cross-border voluntary trade facilitation)
      Survey (upstream and downstream data gathering)
      Reporting (customer and/or regulator) as recipient
   Screening
      For screening entities not in my System of Record for exposures
   Network Update
      Network Validation action associated with a Change insight

In some cases, the data processing system may include different AI agents that facilitate users requesting an agent to establish or generate a workspace or different tasks.

FIG. 3C illustrates another view of the network graph data structure 336 storing nodes representing the networking of the transportation and/or transformation of different networked items across a network, in accordance with an implementation. As illustrated, the network graph data structure 336 can include one or more sub-graph data structures 348a-b, 350, and 352. Each sub-graph data structure can represent or otherwise correspond to a value chain including a path for generating a respective networked item.

The respective sub-graph data structures 348a-b, 350, and 352 can each include a chain of nodes that represent different locations of facilities of a path for generating a networked item. For example, the sub-graph data structure 348a can include nodes 360a-e (together, nodes 360, and, individually, node 360). One or more, or all, of the nodes 360 can be the same as or similar to the nodes 346. The nodes 360 can be linked by edges to indicate the outputs and/or inputs of the nodes 360 to other nodes of the sub-graph data structure 348a to generate a networked item. The nodes 360c, d, and e can each be a source node of the sub-graph data structure because the nodes 360c, d, and e do not receive any inputs from another node (e.g., specifically for the sub-graph data structure 348a). The node 360a can be the last facility (e.g., the destination node) of the value chain represented by the sub-graph data structure 348a because the node 360a may not provide any inputs to another node of the sub-graph data structure 348a. The destination node 360a can be linked with a node 354 associated with the networked item generated by the value chain of the sub-graph data structure 348.

The sub-graph data structure 348b can be configured in a similar manner to the sub-graph data structure 348a. For example, the sub-graph data structure 348b can include nodes 366a-f (together, nodes 366, and, individually, node 366). One or more, or all, of the nodes 366 can be the same as or similar to the nodes 346. The nodes 366 together can represent a value chain for generate the same networked item as the nodes 360 of the sub-graph data structure 348a. The nodes 366 can include one or more common nodes (e.g., the same node) to the nodes 360, such as nodes that are configured to generate the same outputs as each other. The sub-graph data structure 348b can be linked with the node 354 for the profile of the networked item that the nodes 366 are configured to generate together.

A document 420a can be linked with the node 366a of the sub-graph data structure 348b and/or a document 420b can be linked with the node 366e of the sub-graph data structure 348b. The document links are optional. More or fewer document links with nodes can be included than shown. The documents 420a and/or 420b can be records (e.g., electronic records) that were used to generate the respective nodes 366a and/or 366e. For example, the documents 420a and/or 420b can be or include attestations about the nodes 366a and/or 366e, attestations about networked items and/or outputs generated by the nodes 366a and/or 366e, bills of materials provided or associated with the respective nodes 366a and/or 366e, or any other types of documents or electronic records containing data about the respective nodes 366a and/or 366e and/or from which the data (e.g., attributes) of the nodes 366a and/or 366e was generated.

The sub-graph data structure 350 can be configured in a similar manner to the sub-graph data structure 348a. For example, the sub-graph data structure 350 can include nodes 368a-e (together, nodes 368, and, individually, node 368). One or more, or all, of the nodes 368 can be the same as or similar to the nodes 346. The nodes 368 together can represent a value chain for generating or creating the same networked item as the nodes 360 of the sub-graph data structure 348a. The nodes 368 can include one or more common nodes (e.g., the same node) to the nodes 360, such as nodes that are configured to generate the same outputs as each other. The sub-graph data structure 350 can be linked with the node 356 for the profile of the networked item that the nodes 368 are configured to generate together.

The node 368a can be connected with the node 356 for the profile of the networked item that the nodes 368 are configured to generate together. The node 368a can be connected with the node 356 by an edge 371. The edge 371 can be or include a data structure (e.g., an edge data structure) that is configured to identify the type of the connection. In this case, the edge 371 can store data indicating that the node 368 is the final node of the sub-graph data structure 350, an identifier of the sub-graph data structure 350 itself, an identifier of the networked item generated by the sub-graph data structure 350, an indication that the edge connects a node for a location or facility of the sub-graph data structure 350 with a node for a profile (e.g., a profile node) instead of representing a network operation, etc. The different sub-graph data structures 348a, 348b, and/or 352 may each be connected with a node for a profile of a networked item with a similar edge to the edge 371.

The nodes 368b and 368c may be connected by an edge 369. The edge 369 can be or include a data structure (e.g., an edge data structure) that includes data indicating a network operation between the entity represented by the node 368c (e.g., a source node) and the entity represented by the node 368b (e.g., a destination node). The network operation can be a transfer or a transportation of an instance of the network item (e.g., a portion of the networked item that will be eventually be transformed into the networked item or the networked item itself) from the entity of the node 368c to the entity of the node 368b. Together, the nodes 368b and 368c can be a pair of nodes because they are connected by an edge (e.g., the edge 369). The nodes 368b and 368c can be connected by any number of edges, as each edge may correspond to a different network operation. In some cases, the nodes 368b and 368c may be connected by different sets of edges that each correspond to a particular sub-graph data structure. Such may be the case when the nodes 368b and 368c are connected to generate different networked items as part of different value chains (e.g., in different sub-graph data structures). Thus, the edges may be specific to the sub-graph data structures in which the edges are depicted. The nodes of the different sub-graph data structures 348a, 348b, and/or 352 may respectively be connected with each other with edges similar to the edge 369.

The sub-graph data structure 352 can be configured in a similar manner to the sub-graph data structure 350. For example, the sub-graph data structure 352 can include nodes 370a-e (together, nodes 370, and, individually, node 370). One or more, or all, of the nodes 370 can be the same as or similar to the nodes 346. The nodes 370 together can represent a value chain for generate the same networked item as the nodes 368 of the sub-graph data structure 350. The nodes 368 can include one or more common nodes (e.g., the same node) to the nodes 370, such as nodes that are configured to generate the same outputs as each other. The sub-graph data structure 352 can be linked with the node 358 for the profile of the networked item that the nodes 370 are configured to generate together.

FIG. 3D is a sub-graph data structure 372 that represents an example value chain for the production of networked items (e.g., vehicle gearboxes). The sub-graph data structure 372 can represent supply and consumption tiers for generating or creating networked items and then distributing the generated networked items, in some implementations. For example, the sub-graph data structure 372 can include supplier nodes 346m-o that provide inputs to supplier nodes 346k-l as indicated by the edges and arrows between the nodes 346m-o and the nodes 346k-l. The supplier nodes 346k-l can use or transform the inputs to generate outputs that are input into the nodes 346i-j. The nodes 346i-j can use or transform the inputs to generate outputs that are input into the node 346h, as the source entity node. The source entity node 346h can generate the networked items 347 based on (e.g., by transforming) the inputs from the nodes 346i-j. The source entity node 346 can transfer the networked items 347 to nodes 346e-f. The nodes 346e-f can distribute or transfer the networked items 347 or a transformed version of the networked items 347.

The data processing system 306 can implement the systems and methods described herein to generate the network graph data structure 336 representing one or more value chains in the sub-graph data structures 340, such as sub-graph data structures 340 with the following characteristics:
Accurate: The network graph data structure 336 may accurately describe the physical production and transportation processes, even if they are described in disparate messy documents in multiple languages.
Granular down to the part-site level: the part-site level is necessary to truly manage supply chains. Previous approaches have focused on the business network level or connection level, but these approaches fail to understand the fundamental physicality (locations and products) of the underlying value chains. The network graph data structure 336 may include specific details to ascertain what was the specific flow of a given product from raw materials to production, distribution, and sale. Failure to achieve this part-site level view results in such high levels of false-positives (erroneous links) that value chain analysis is impossible-participants are stuck in a mire of analyzing irrelevant business relationships.
Dynamically updating: the supply chain is constantly changing. To provide actionable intelligence, the network graph data structure 336 may evolve as production networks, site locations, and corporate relationships evolve. Thus, the system can automatically update while not losing track of relationship histories.
Consistent: To facilitate collaboration between participants whether their role in a value chain is suppliers, buyers, transporters, regulators, banks, insurers, or more, all participants may operate on a shared source of truth. One-off customer specific representations may fail to enable value chain management-they cannot be used as a basis for collaboration. The supply chain graph has to be consistent and linkable across all parties.

To achieve these attributes the network graph data structure 336 may have the following characteristics.
1. Assembly: The intelligence on global value chains be assembled while respecting data sovereignty, security, and privacy. In other words, the system can have shared value-chain intelligence without sharing data.
2. Construction: The information can be harmonized into a network representation with the correct nodes and links.
3. Customization: Users can customize the resultant value chain maps with their organization specification information, groupings, and similar.
4. Value-chain specificity: The information can allow understanding of specific value chains at the part-site level of understanding. In other words, value chain understanding that is not at the company level, but rather facility-to-facility network operations can be understood in the context of the inputs they provide for the final product.

Nodes may include not only companies, but facilities, ports, products, individuals, vessels, countries, geographies, and more. Edges may cover movement of goods, locations of facilities, ownership of companies, directorship of companies, and more. Value chain management can include constructing a network graph data structure that covers more than just corporate relationships, but also the fundamental input-output relationships of product production. Such a part-site specific graph may allow part-site specific understanding of value chains at scale.

The network graph data structure 336 illustrated in FIGS. 3B and 3C can be constructed from both commercial and proprietary data. To do so, the system can obtain publicly and commercially available supply chain data. The system can focus upon datasets that describe physical movement of goods from facility to facility, rather than more abstract “business relationships.” In other words, documents such as bills of lading, manifests, customs declarations, and purchase orders. These documents can contain information on the sender, receiver, their addresses, the goods transported (both in free text and harmonized-system product category form), the ports, the vessels, and more. The system can augment the documents with commercially available information on corporate registries, embargoes lists, tariff incentives, free trade agreement qualification, and more. Such information can be identified with publicly/privately reported business relationships as appropriate.

However, public and commercially available data can be limited. For instance, such data may only be available for certain geographies and certain modes of transport. Operating on public data alone may not achieve the visibility necessary to solve the world's value chain problems—a disconnected, erroneous, or low-fidelity network doesn't help the participants. To understand value chains, system may need to be able to understand and connect the multiple stages of production from raw extraction through final distribution.

To do so, in some cases, the data processing system 306 can implement a federated system that permits each participant to have their own private “spoke” in which their data is secure and safe, but where derived analytics can be shared across desired participants. FIG. 3E demonstrates such a hub and spoke federated system 374, where all participants benefit from the derived analytics but sensitive information stays only with the participant that owns the information. Every participant can have a private enclave, in their jurisdiction of choice, where only they can see the entirety and fidelity of the data they put into the platform. Such participants are depicted in FIG. 3E as computing devices 304a-c, respective. Product details such as names, revenue, bills of materials, costs, supplier and customer experiences, and analytics on their supply chain are always private, never shared and only exist within each enclave. Third-party data procured by participants such as ESG scores, revenue importance, and custom calculations similarly privately enriches the individualized deployments. This functionality allows participants to wire in their own private information to the network graph data structure so they see a unified view of their world connected into the global map. Each participant benefits from seeing their data, kept for their private usage in their private enclave, bound to more visibility than any one country, let alone one company, has access to.

Participants can publish and share minimal information on linkages to allow mutual engagement and tracing of value chains. By sharing this minimal information on linkages, all participants can benefit from connectivity of the network graph data structure 336—the ability to traverse through multiple tiers. This connectivity can provide essential value to all participants, as it allows the participants to understand and manage their value chains across all stages of production. For this reason, the network graph data structure 336 can enable a collaborative supply chain graph, while preserving contributors' privacy, and competitive advantages.

The shared graph of intelligence assembled via the hub and spoke architecture can be constructed from documents with erroneous or woefully incomplete information. They frequently lack the detail necessary to go down to the part-site level. The data processing system can extract signal from the noise through the following steps: (1) recognizing and matching entities such as companies, addresses, ports, and products in many languages, robust to misspellings; identifying and correcting erroneous information, such as incorrect addresses, values, product categories (e.g., HS codes), and more; (2) imputing missing information, whether that is missing product categories, address components, values, or otherwise; and (3) solving these challenges can involve state-of-the-art machine translation, entity resolution, link resolution, deduplication, cross-linking of information, and domain specific optimizations to connect the data together in both a granular and scalable manner.

The data processing system 306 can leverage both classic machine learning and modern deep learning, including graph based approaches. Table 1 below provides an example of transformations of raw messy shipment information into canonicalized standardized representations.

| | | Canonicalized |
|---|---|---|
| Type | Original raw text | representation |
| Company | from warehaus rivilogistics by Globex | Globex |
| Company | AKME Ko B Ka3axcTaHe | Acme Co. |
| Address | 2 a calle 8 s n 53370 naulcalpan de juarez | Calle 8 No. 2 A, Industrial |
| | naucalpan de juarez | Alce Blanco, Naucalpan De |
| | | Juarez, Mexico, 53370, |
| | | Mexico |
| Product | Ladies 90% cotton 7% tencel 3% elastane | 6204.62.8011 (US |
| | woven denim pant | Harmonized Tariff System |
| | | Code) |
| | | Articles of apparel and |
| | | clothing accessories, not |
| | | knitted or crocheted— |
| | | women's or girls' suits, |
| | | ensembles, suit-type jackets, |
| | | blazers, dresses, skirts, |
| | | divided skirts, trousers, bib |
| | | and brace overalls, breeches |
| | | and shorts (other than |
| | | swimwear):—trousers, bib |
| | | and brace overalls, breeches |
| | | and shorts: of cotton:—other: |
| | | other: other: other—other: |
| | | women's trousers and |
| | | breeches: blue denim (348) |
| Product | [symbol] [symbol] [symbol] [symbol] | 3006.20.00 |
| | | (Gulf Cooperation Council |
| | | Harmonized System Code) |
| | | [symbol] [symbol] [symbol] [symbol] |
| | | [symbol] [symbol] [symbol] [symbol] |
| | | [symbol] [symbol] [symbol] [symbol] [symbol] |
| | | [symbol] [symbol] [symbol] \| Blood-grouping |
| | | reagents |

The data processing system 306 can perform the following operations to generate Table 1 and similar tables:
map the raw fields to standardized fields;
use one or more artificial intelligence (AI) systems to parse fields with multiple values (e.g., name+address) concatenated into one field;
use AI systems to structure unstructured fields (e.g., address not structured by administrative granularity) into structured representations (e.g., a structured address);
use AI driven search systems to take obscure/opaque/vague descriptions and expand them (e.g., take a goods description that is just a parts number from a company specific parts database and replace it with a detailed description of that product); and
use AI systems to match to canonical representations based on a semantic understanding of the entity (e.g., company, address, product) regardless of what language/misspellings it has.

The data processing system 306 can perform this canonicalization based on the features (textual, numeric, categorical, graph) and contextual information such as involved parties, involved products, etc., in the raw document. The end result is both a canonical description of the entity and a canonical ID by which the entity can be referenced. If no canonical entity already exists, the data processing system 306 can create one.

The data processing system 306 can identify and correct erroneous or missing information functions in a similar manner. For example, the data processing system 306 can use AI systems to predict the field's information. If it differs from the provided original information, the data processing system 306 can flag and correct the discrepant information (e.g., an erroneous product code or monetary value). If it's empty, the data processing system 306 can predict the correct value. In both cases, there is a measure of confidence in the prediction that is calibrated for at least a threshold accuracy/quality. One particularly notable correction is for supplier addresses. In some cases, customers have supplier lists that either have no address information or provide the supplier's HQ, not the true production facility address. The distinction, and the data processing system 306's systemic correction of this error can be used accurate construction of part-site specific value chains.

Users of the network graph data structure 336 may customize the network graph data structure 336 with their organization and user-specific information. Users may do so, for example, through:
1. Addition of organization-specific scores and values: For example, internal parts numbers for products, ESG scores for different facilities, previous return rates on investment in trade financement.
2. Organization/user-specific groupings of entities: the ability to group multiple entities (e.g., companies, facilities, products) represented in the network graph data structure into one grouping. For example, an organization may wish to see all the activity of a given supplier cohort grouped together, ignoring distinctions between the underlying companies.
3. Attachment of source documents and files: Backing files serving as backing information for the entities.
4. Storage of notes: Specific additional information provided by users and organizations on the entities.

The data processing system 306 can provide above capability in customer private-enclave-specific (e.g., spoke specific) instances. In doing so, the data processing system 306 can provide each customer with the capability to customize the network graph data structure 336 as necessary for their organization. The sensitive information described herein may stay in each private deployment and, in some cases may never transmitted back to the hub.

Additionally, understanding physical production and acting upon the physical production can require understanding the steps from raw material extraction through final distribution. Within their private enclave, customers may have their bill of materials for their products. However, they may not have the recursive bill of materials—the inputs for their inputs or the inputs resulting from their outputs. This information may be required to understand the original and intermediate processing that led to the product, as well as the intermediate and final consumption, as illustrated in FIG. 3D.

To construct this understanding, the data processing system 306 can integrate, in the private enclave, the customer's bill of material information. Combined with the customer's supplier list, this gives the first tier understanding of production facilities and inputs for each customer product. Then, the data processing system 306 can apply an AI-based understanding of input-output relationships to understand value chains to understand the network of production conditional on the good being produced. The data processing system 306 can use the network graph data structure 336 to filter a set of relationships to only include the value chain for a vehicle gearbox, for example, while disregarding all irrelevant links and associations related to other goods at the same facility. The data processing system 306 can do so by producing and applying a recursive map of the relationship between inputs and outputs, a function estimating the “bill of materials” for all physical goods. Using deep learning, graph information/modeling, and generative AI, the data processing system 306 can derive this input-output relationship for all goods, thus allowing the refinement of site-specific exchange of goods to be conditional on specific products. This understanding can then be refined, in some cases, by a human collaborating with internal and external parties.

The resultant graph of global value chains may be, post-harmonization, gigantic in size, in some cases including billions of transactions linking 100s of millions of entities. The data processing system 306 can identify the most relevant parts of the network graph data structure, individual entities, shipments or sub-networks (“sub-graph data structures”) involving companies, addresses, products, shipments, ports. The data processing system 306 can do so using cutting edge AI, exceptional engineering, deep product understanding, and insightful design to achieve these tasks. The underlying systems and industrial ecosystems represented by the network graph data structure are complex, and easy answers are uncommon. The data processing system 306 can implement the systems and methods described herein to generate and process the network graph data structure 336 for:
Compliance: Complying with and enforcing environmental (e.g., Scope 3, deforestation, etc.), human rights (e.g., forced labor), tax/tariff/duty, export controls, sanctions, national security, and other laws and regulation across multiple country's regulatory environments.
Sourcing and procurement: Analyzing existing and potential suppliers and buyers at scale across 10s of thousands or more relationships.
Resiliency: Proactively and reactively understanding potential disruption to value chains at the scale of multinational corporations or nations. Analyses include understanding bottlenecks, exposure to current or potential adverse events (e.g., a factory being destroyed), multi-tier exposure to geopolitically risk geographies, and more. Such resiliency is critical to continued corporate operation as well as economic and national security.
Insurance: Usage of the above resiliency information to offer and price novel forms of business-interruption coverage. Understanding resiliency at scale enables origination and pricing of insurance that could not profitably previously be offered due to lack of information on the extended value chain. Contingent business interruption insurance, insuring against extended disruptions in the value chain, was previously unavailable at desired volumes due to the difficulty of understanding extended value chain relationships. Insurers can now offer such insurance while understanding extended risk and concentrations, and insureds can benefit from the surety that such insurance brings.
Trade facilitation and prevention of illicit activity across borders: Logistics parties, multinational corporations, and governments can collaborate together to ensure facilitation of legitimate cargoes and targeting of illicit activity. Positive value chains are promoted and aided in filing of required paperwork, negative value chains (such as narcotics production) are impeded.

The data processing system 306 has several features that facilitates generation and processing of a network graph data structure that represents a real-time version of multiple value chains. For example, the data processing system 306 can use security features such that the represented data remains safe using information security programs, secure software development lifecycle, and segmenting customer accounts. The data processing system 306 may be deployed into various secure environments across the globe. These controls help service the goal of securing data.

Another advantage is that the system supports granular role-based access controls to put individual organization's administrators in control of who in the organization can see which details, as well as external collaboration with other parties.

In some cases, in the context of sensitive applications, the data processing system 306 can support selection and vetting of which specific users (e.g., government-associated users) can access private deployments. The most standard use case is for public sector deployments where all access must be done by vetted/security-cleared individuals, often from that nation.

In some cases, the data processing system 306 may never share raw data between spokes without explicit instructions for collaboration between trusted parties. The default may be that no direction is enabled. Rather, the system can facilitate sharing of network visibility, analytics, and shared AI models without moving raw data.

The data processing system 306 can provide individual customers a private enclave where they, and only they, can see the entirety of the data their organization puts into the platform. Product details such as name, revenue, bill of materials, costs, supplier and customer experiences, and analytics on the customer's supply chain are always private, never shared and only exist in the private enclave. They are processed and harmonized with the network graph data structure's broader multi-tier view while remaining within that individual enclave.

To facilitate the value chain network function, and connections between buyers and suppliers in multi-tier value chains, the data processing system 306 can facilitate minimal linkages necessary for engagement. After normalizing and canonicalizing the entities to the network graph data structure in the private-enclave, the data processing system 306 can anonymously connect the minimal details of a supply chain linkage to the central network graph data structure. These details include: the sender and receiver companies and locations; an intentionally vague description of the goods such as an HS code or summarized description; and the month of the transaction.

The source of the derived links derived via this canonicalization and anonymization may not be revealed to any other clients. This shared intelligence may allow each customer to in turn receive and connect to linkages provided by others.

The data processing system 306 can be, include, or otherwise interact with a federated learning system to generate the network graph data structure 336 and generate metrics and intelligence across users or entities. Federated learning is a field of machine learning focused on how to learn in a privacy preserving manner that does not share nor combine data. One example of use of federated learning is customization of suggestions when an individual types on a cell phone. The system learns across many devices by learning on the device and never transferring the raw data, only the trained model, back to a central hub. All users thus benefit without ever sharing any typing history such as passwords, loved ones' names, or full messages back to the cloud.

The data processing system 306 can implement federated learning across a number of features of generating and processing the network graph data structure 336. In doing so, the data processing system 306 can preserve user privacy while providing the benefits of aggregating data from a large number of data sources. Examples of how the data processing system 306 uses federated learning include the following:

Value chain construction: Many facilities receive shipments of coffee, but these are very unlikely to be relevant to a particular product's specific value chain for any product that is not in the coffee category. As such, the data processing system 306 can implement a process which smartly builds product value chains from the network graph data structure creating specific and granular understanding down to the material category, type of input (e.g., ingredients, capital goods, packaging). Customers can engage and refine these value chains which further contributes to quality of this machine learning construction. The customer provided feedback, as well as rich product descriptions, and relationships may all be private to the users that provide the data. The data processing system 306 can train across the feedback on those classifications in a privacy preserving manner and such that each user may benefit from other customers' refinements. This technique has shown significant improvement in quality of value chain construction both within and across industries when compared to expert review.

A value chain can be constructed as a network graph data structure to provide the technical foundations of value chain management. The network graph data structure can be used to identify missing information or deficiencies and identify risk probabilistically. Users can collaborate in a risk/impact-oriented manner on top of the network graph data structure For example, the network graph data structure 336 can be used to generate or support product passports and trade facilitation.

Harmonized System (HS) Classification: Assigning HS codes to products may determine tariff rates and other global trade related requirements. Determining the appropriate HS code for a product is difficult, however, and most practitioners outside of customs don't know how to classify products correctly. The data processing system 306 can include suite of tools for both assigning HS codes to products as well as explaining these according to the general rules of interpretation, and using previous CROSS/BTI rulings to support a classification. To properly do this requires detailed product descriptions that are private to individual users. As such, the data processing system 306 can use federated learning to achieve these processes, while preserving the privacy of users' information, and enabling users to benefit from other users' refinements of the classifications.

Tariff/duty calculation: assessing the correct tariff requires calculation based on the HS code, the country of origin, free trade agreement qualification, input material origin, and similar. The data processing system 306 uses federated learning to assemble all this information without compromising data privacy and security

Free trade agreement qualification: similarly, qualifying for a free trade agreement requires multi-tier understanding of the value chain of the goods, the companies, facilities, countries, and processes involved, and the production of a certified representation of the good's production and certification. The data processing system 306 uses federated learning to assemble all this information without compromising data privacy and security

Trust scores: Shipment fraud and illicit goods may affect all players in the logistics and shipping space. To facilitate cross border trade, the data processing system 306 can generate a trust score based on customers' shipment interdiction history, proximity to embargoes, shipper history, and other attributes. These details may be private to customer relationships, however, all participants in the space would benefit from being able to identify contraband and smuggling better. The data processing system 306 can use federated learning across entities working in these areas to better identify shipment fraud and facilitate expedited clearance while preserving the privacy of specific customer history and never pooling any customer data together.

The hub and spoke of generating and processing the network graph data structure 336 can be applied for multiple internal departments/agencies to collaborate within or between governments. For example, the hub-spoke architecture described herein can facilitate secure collaboration within and across government agencies and governments themselves. The data processing system 306 can generate private copies of the entire architecture, and thus a private network/“intranet” of value chain information and collaboration may be generated. This architecture can thus enable collaboration between different departments/ministries without different rights to access different data. Furthermore, they can enable shared intelligence across national boundaries for sensitive national security and economic security use cases that require multi-national collaboration between cooperating/allied nations. Combined with the role-based access controls and government-ready secure deployments described above, the data processing system 306 can enable secure collaboration.

In some cases, the data processing system 306 may not synchronize any information, including derived information such as network visibility, analytics, or AI models, back to the hub from national deployments. In other words, national security users benefit from the platform provided by the data processing system 306 in support of their missions, and are given new abilities to collaborate with the private sector in service of security, economic growth, and resiliency through a shared source of truth, but maintain the classification levels and security of their agencies and departments.

In some cases, to preserve privacy and security, the data processing system 306 can transmit copies (e.g., versions, dedicated copies, dedicated version, etc.) of the network graph data structure 336 to the different computing devices 304 of the hub-and-spoke system. The copies can be dedicated copies for the respective computing devices 304, such that the computing devices 304 only receive data that the computing devices 304 are authorized (e.g., via stored permission of profiles for the computing devices 304) to receives. For example, the data processing system 306 can generate a copy 375 of the network graph data structure 336. The data processing system 306 can generate the copy 375 by identifying the data of the network graph data structure, such as the types of data, edges connected with specific nodes, specific nodes, etc., that the computing device 304d is permissioned or authorized to receive, view, or access. The data processing system 306 can identify such data by applying a schema or a set of rules or permissions stored in a profile for the computing device 304d or the entity associated with the computing device 304d. The data processing system can use such permissions to retrieve that that the computing device 304d is authorized to access, and generate a copy 375 of the network graph data structure 336 only with the retrieved data. The data processing system can transmit the copy 375 of the network graph data structure 336 to the computing device 304d. In this way, the data processing system 306 can preserve the privacy of certain types of data for different nodes, while still providing different spokes of the federated system with access to the network graph data structure 336.

By implementing the systems and methods described herein, the data processing system 306 can generate a network graph data structure using a hub-spoke federated learning system with privacy preserving techniques to provide industry-wide insights while protecting confidential information.

FIG. 3F illustrates an example flowchart of a process 376 for network graph data structure-based networking, in accordance with an implementation. A data processing system (e.g., the data processing system 306, shown and described with reference to FIG. 3A) can perform the process 376 to generate and/or update a network graph data structure representing the network between facilities for networked item transformation and/or transportation. The process 376 can include any number of operations or additional operations and the operations may be performed in any order.

At operation 378, the data processing system can receive one or more electronic records. The data processing system may receive the electronic records from one or more computing devices of different facilities that are involved in a network of value chains representing the transport and/or transformation of networked items.

At operation 380, the data processing system can parse the one or more electronic records. The data processing system can parse the records using natural language processing techniques and/or language processing models to identify specific entities or data included in the electronic records. The data processing system can store the parsed data in a database, such as a system of record that maintains the data for the network of value chains.

At operation 382, the data processing system can generate nodes in a network graph data structure. The data processing system can generate the nodes based on the electronic records and/or the parsed data such that each of the facilities corresponds to a different node in the network graph data structure. Each of the nodes can include node field-value pairs for different characteristics or attributes of the facilities represented by the respective nodes.

At operation 384, the data processing system can connect nodes in the network graph data structure. The data processing system can connect the nodes in the network graph data structure with edges. Each edge can represent a different network operation or transaction. For example, an edge between two nodes can represent transport of a networked item or component from one facility to another facility. The data processing system can generate any number of edges between pairs of nodes.

Each edge can be or include a data structure. The data structure can include data about the relationship indicated by the edge between the nodes. For instance, the data structure can include an identification of the networked item transported between nodes, a time and/or date of the transportation, a quantity, etc.

At operation 386, the data processing system can generate one or more networked item digital records. The data processing system can generate the networked item digital records in response to one or more requests to generate the digital records, for example. The data processing system can generate a networked item digital record by identifying one or more nodes or sub-graph data structures of the network graph data structure to include in the networked item digital record. The data processing system can identify such nodes or sub-graph data structures based on identifications of the nodes or sub-graph data structures in a request. The data processing system can generate the networked item digital record to include identifications of each of the identified or nodes or sub-graph data structures and/or the data structures of the nodes or sub-graph data structures themselves. In some cases, the data processing system can include an identification of a networked item profile or the networked item profile itself in the networked item digital record. The data processing system can generate and store such networked item digital records in the network graph data structure or a separate database in a file. Subsequently, the data processing system can transmit the networked item digital record to another computing device to either provision the computing device with access to the data structures (e.g., the nodes, the networked item profiles, the sub-graph data structures, etc.) identified in the network graph data structure and/or provision a copy of the data structures included in the networked item digital record to provide a view of the data represented in the networked item digital records.

Implementations of the current solution provide systems and methods of addressing technical challenges in network systems, focusing on the real-time construction of node graphs, faster and more accurate data retrieval methods, federated system controls, and communication across network systems. First, the solution tackles the complexity involved in representing large-scale permutations of input-output relationships within node graphs. These graphs can be constructed in real-time and accommodate dynamic updates to maintain an accurate end-to-end matrix of relationships. Second, improvements to data retrieval processes are implemented by structuring node graphs into sub-graph data structures that represent specific value chains for specific networked items across networking systems. These improvements allow for targeted access to pertinent data and reduce computational overhead through intelligent navigation and traversal of the edges of the graph. Federated systems offer data privacy by implementing controls over node graph sharing. Data can be segmented within private enclaves, accessible only to authorized entities, while insights are shared without the transmission of raw or proprietary data. Furthermore, the architecture facilitates seamless communication and collaboration between systems and users across value chains over the complex network. This configuration enables efficient data updates and retrieval over the network, providing real-time synchronization, reduced latency, and improved coherence within interconnected systems.

The technological problem addressed by real-time construction of a node graph centers on the complexity and scalability of mapping intricate input-output relationships within large-scale systems. Conventional systems often encounter difficulties when attempting to represent the extensive permutations of transactional and procedural interactions across an entire network. As such, limitations in processing capabilities hinder the ability to produce comprehensive and dynamic models, resulting in fragmented or incomplete depictions of these relationships. This constrains computing device ability to analyze, plan, and improve processes across large scale networks and systems that are useful for more efficient operations.

The techniques described herein provide a technical solution through the development of a node graph architecture designed for real-time integration and analysis of large data sets. This architecture can dynamically construct node graphs that encapsulate different permutations of input-output connections within an end-to-end framework. Advanced algorithms can be deployed to continuously update and reconcile the graph structure as new data inputs become available. This includes identifying and relating comprehensive network nodes, allowing the system to seamlessly integrate diverse data points and maintain an up-to-date, accurate representation of the large scale network that continuously grows and changes.

The implementation of real-time node graph construction results in several technical enhancements. This construction provides continuous data integration into the node graph with continuous updates to the nodes and the edges between nodes within the node graph, ensuring that systems have up-to-date information streams. Accordingly, the construction can eliminate or reduce latency in data availability. The node graph structure facilitates efficient data indexing and retrieval, allowing for faster access to pertinent system relationships than conventional systems data storage and retrieval techniques or data storage and retrieval techniques that involve a node graph data structure. This capability can facilitate swift propagation of updates across the system, thus enhancing the system's responsiveness and scalability.

The technical problem addressed by improving data retrieval in node graphs entails the inefficiencies and inaccuracies associated with accessing relevant information from complex graph data structures. Conventional methods of data retrieval can struggle to efficiently navigate vast graph networks, especially when attempting to extract pertinent details related to sub-graph data structures that represent specific value chains. These challenges arise from redundant or unoptimized search processes, which often lead to increased retrieval times and higher computational costs, while failing to effectively pinpoint or prioritize the most relevant data subsets necessary for analysis.

The techniques described herein offer a technical solution by implementing advanced data retrieval through the structure of node graphs, particularly focusing on sub-graph data structures within these networks. This solution includes algorithms that can intelligently navigate the node graph, identifying sub-graph data structures that correspond to specified value chains or sub-graph data structures. Such algorithms can improve search paths and employ heuristic techniques that reduce retrieval time and computational overhead. By structuring data access around the segmentation of the graph into sub-graph data structures, the system can more efficiently target and extract relevant information.

The improved data retrieval techniques yield several technical enhancements in accessing and utilizing specific subsections of a broader node graph. These techniques increase the precision of data query results, ensuring high accuracy by effectively filtering out irrelevant data points. They also enhance retrieval efficiency and accuracy that reduce query response times, allowing fast access to relevant data subsets. This facilitates real-time data analytics capabilities, enabling systems to quickly process and analyze specific value chain segments. The improved retrieval mechanisms support enhanced data throughput and minimize bottlenecks in information processing, contributing to the system's overall responsiveness. Additionally, these techniques improve and/or optimize computational resource allocation by minimizing data redundancy and ensuring efficient utilization of processing power across networked system.

The technical problem associated with federated systems and the control over node graph sharing arises from the need to balance collaborative data integration against data privacy and sovereignty constraints. In traditional centralized data systems, sharing comprehensive data sets poses risks to confidential information and often violates regional data protection regulations. As organizations engage in shared networks, the challenge is to allow effective collaboration while ensuring that sensitive elements of the node graph remain protected and are only shared with authorized entities.

The techniques described herein introduce a federated system architecture designed to control specific node graph sharing, thus mitigating privacy concerns while still facilitating collaborative benefits. This system can segment the node graph into isolated private enclaves for each participant. Within these enclaves, data remains secure and local, accessible solely to the owner. Federated learning techniques are employed to derive shared insights without actual data transmission, enabling the selective sharing of insights rather than raw data. The system allows participants to define granular sharing controls, specifying which segments of the node graph are accessible and under what conditions, ensuring alignment with privacy and regulatory standards.

The implementation of federated systems with controlled node graph sharing results in several technical improvements. These systems uphold robust data privacy through decentralized data management, minimizing the risk of exposure by keeping data within local storage environments. By utilizing federated learning, the system aggregates insights without raw data transfer, maintaining data integrity and sovereignty across network nodes. This decentralized approach reduces the attack surface for potential breaches, significantly enhancing system security. Additionally, the architecture enables seamless integration of proprietary data into a collective analytical model, optimizing inter-organizational data processing without compromising the proprietary data. This configuration allows for efficient parallel processing and model refinement, facilitating advanced analytics and machine learning applications across distributed environment

The technical problem in networked systems, particularly within the context of systems operating across the value chain, is the challenge of seamless communication and data exchange with a central system. Traditional networked systems often experience latency, data inconsistency, and bottlenecks when numerous disparate systems attempt to update and retrieve information over a central network. These issues are exacerbated by the scale and complexity inherent in value chains, which traverse multiple entities and geographical locations, necessitating robust and efficient communication mechanisms to maintain coherence and synchronization of data across the network.

The techniques described herein propose a technical solution through the implementation of an advanced graph node architecture that facilitates efficient communication between systems across the value chain and a central system. This solution can involve configuring the central system as a nodal hub, where each node in the architecture represents specific entities or processes within the value chain. Alternatively, the solution can involve configuring decentralized nodes that communicate with no central hub, achieving decentralized communication and privacy. These nodes are interconnected in a manner that reflects the actual input-output relationships, allowing for streamlined data propagation and retrieval. The architecture can employ algorithms that dynamically adjust node connections based on network traffic, ensuring optimized data routing that minimizes latency and improves overall efficiency.

The implementation of a graph node architecture within networked systems enhances several technical aspects across the value chain. First, the architecture enables real-time data synchronization, reducing discrepancies and mitigating the risk of data inconsistency. This facilitates immediate data availability, enhancing the precision of analytics and decision-support systems. Second, the intelligent routing algorithms adjust node connections dynamically, which optimizes data flow and reduces latency throughout the network. This results in faster data processing times and improves system responsiveness under varying load conditions. Additionally, the architecture inherently supports fault tolerance by maintaining alternative pathways for data communication in the event of a node failure, thereby ensuring continuous operation and system reliability. Overall, the advanced graph node architecture strengthens the technical infrastructure needed for efficient data exchange, contributing to a more robust and agile value chain network.

The technical problem associated with tracking real-world events, processes, and occurrences, such as the production and transportation of goods within a graph node system, stems from the complexity of accurately representing and managing the dynamic and interconnected nature of these physical activities. Traditional systems often lack the capability to integrate multiple aspects of physical processes, such as changes in location, status, and characteristics, within a cohesive and responsive framework. This leads to inefficiencies in monitoring the transformation and movement of goods, making it challenging to manage logistics, ensure compliance with transportation restrictions, and capture the nuanced transformation characteristics of inputs into outputs.

The techniques described herein provide a technical solution through the implementation of an intelligent node graph system that can model and track the multifaceted nature of networking events in real time. The system can use advanced data analytics to map and update each node's attributes as networked items progress through various stages of their lifecycle, such as from creation, through transportation, to final transformation. Each node within this architecture can represent specific goods, transportation modes, or transformation processes, capturing relevant data points, such as location, condition, and transformation metrics. This setup allows the system to dynamically allow or restrict transportation based on predefined criteria and regulatory requirements, integrating these constraints into the decision-making functionality governing the network.

The implementation of this graph node system results in several technical effects useful to managing physical processes. The system enhances data acquisition and integration capabilities by providing precise real-time updates of physical attributes and changes within the network. This significantly improves monitoring accuracy by reducing dependency on manual tracking, thereby minimizing tracking errors. The architecture supports the orchestration of logistics operations by facilitating data-driven adjustments and enabling instantaneous data updates to relevant nodes. Automated enforcement of restrictions through system integration enhances compliance and regulatory adherence within the network. The standardized data framework within the system supports interoperability across different technological platforms, facilitating seamless data exchange and system integration. Overall, the system optimizes computational resources by structuring heterogenous data inputs into a cohesive, scalable architecture, improving the overall reliability and efficiency of monitoring events and processes.

The technical problem related to enabling collaborations between users on a graph network while tracking products lies in the challenge of facilitating seamless and secure data exchanges among diverse entities. Traditional systems struggle with synchronizing real-time updates and ensuring compatibility across different data formats. Moreover, protecting sensitive information while still allowing effective collaboration presents a significant technical hurdle. These issues can lead to inconsistencies and inefficiencies, impacting the effectiveness of the collaborative workflow.

The techniques described herein offer a technical solution through the development of an advanced graph network architecture. This architecture supports secure, real-time collaboration by employing cryptographic protocols and robust access controls, ensuring that data confidentiality is maintained. It provides mechanisms for integrating diverse data inputs into a cohesive structure, enabling consistent updates and data visibility across the network. By implementing dynamic access controls, the system can facilitate efficient information sharing that aligns with user roles and collaborative activities.

The implementation of this collaborative graph network results in several technical effects. The system ensures real-time data synchronization across users, minimizing discrepancies and enhancing the consistency of information. Secure data exchange can be facilitated through encryption and access control measures, restricting access to authorized users and preserving data confidentiality. The architecture integrates disparate data inputs into a unified format, enhancing data coherence across various systems. Additionally, adaptive management of user permissions through dynamic access controls enables efficient collaboration, ensuring data sharing aligns with security policies. These improvements contribute to a more resilient and efficient framework for tracking products and facilitating user collaboration within the graph network.

The implementations of embodiments of the present solution results in several technical advancements that significantly enhance system capabilities. Improved data retrieval algorithms ensure high accuracy and reduce query response times, facilitating real-time analytics. Intelligent node graph constructions can enable continuous data integration, precise monitoring, and efficient parallel processing, improving resource allocation and system responsiveness. Federated systems can uphold data privacy while allowing collaborative information sharing, enhancing system security and integrity. Advanced graph node architectures can provide real-time synchronization and fault tolerance, contributing to robust data exchange across the value chain. Systems for tracking physical events and facilitating user collaboration improve monitoring accuracy and regulatory compliance while supporting seamless data integration and communication. Overall, these solutions collectively optimize system reliability, efficiency, and the technical infrastructure needed for streamlined operations across complex network systems.

### D. Systems and Methods for Dynamically Updating and Synchronizing a Network Graph Data Structure

A computing system can maintain a network graph data structure that models relationships and interactions across a multi-tier value chain network. The network graph data structure can store nodes representing entities such as suppliers, manufacturers, distributors, logistics providers, facilities, or transportation services, and edges representing relationships between the entities, such as procurement relationships, shipment flows, ownership associations, or contractual dependencies. In some implementations, the network graph is used by a value chain management system to represent upstream supplier relationships, downstream customer relationships, and lateral connections between entities operating at the same tier. Such graph-based representations allow the computing system to model complex and evolving value chain topologies and to associate products, materials, or shipments with corresponding paths through the network.

When operating with conventional information processing systems, a computing system that maintains such a network graph data structure encounters several technical limitations. First, requests for additional information from entities represented in the network are often performed using disconnected communication mechanisms, such as email messages, spreadsheet-based questionnaires, or paper-based documentation requests, which are not linked to the underlying graph data structure. As a result, these approaches lack a shared visual or structural reference for identifying which specific entities, relationships, or network operations within the network require additional information. Furthermore, conventional systems may fail to identify the relevant computing systems to which an update should be propagated, or may redundantly request additional information and/or propagate updates due to disconnected communication mechanisms.

To address these technical challenges, a data processing system can perform a sequence of operations beginning with receipt of a request to complete a task associated with a networked item. In response to the request, the computing system can identify a profile associated with the networked item and query the network graph data structure to identify one or more sub-graph data structures linked to the profile. Each sub-graph can include nodes representing entities that have interacted with the networked item and edges representing relationships or transitions involving the networked item. The data processing system can dynamically generate a digital record that includes the identified sub-graph data structures and/or can generate a visual representation of the sub-graphs as a graphical depiction including node icons and edge lines. As a result, the system can provide visual context for requests. By maintaining a unified network graph data structure, the data processing system can allow for efficient retrieval of context associated with the request. Rather than searching through disjointed data records and/or databases to determine relationships associated with the request, the system can execute graph queries on the network graph data structure to efficiently identify relevant nodes, edges, and sub-graph data structures associated with the networked item. The data processing system can therefore reduce latency and network resources associated with completion of requests.

After assembling the digital record, the computing system can prepopulate the record with data extracted from the network graph data structure and, in some cases, from a system of record of the entity that sent the initial request. The computing system can transmit the digital record to a computing device associated with an entity represented by a node within the sub-graph, together with a request for additional information corresponding to one or more nodes or edges. The computing device can present the visual representation to a user and allow the user to associate documentation, attestations, or other data directly with specific nodes or edges within the graphical depiction. The computing device can then transmit an augmented digital record back to the computing system.

Upon receipt of the augmented digital record, the data processing system can then identify nodes to propagate the update to. For example, the data processing system can determine which nodes in the sequence of nodes satisfy a propagation condition based on the network graph data structure and then propagate the augmented digital record to systems associated with each of the identified nodes, such as by using an address (e.g., an IP address, an electronic message, etc.) identifying a computer or computing system of the nodes. By identifying nodes for propagation, the data processing system can allow for propagation to interested nodes. The data processing system may therefore reduce computing resources used to execute rollback procedures due to disjointed systems of record. For example, computing systems may execute operations (e.g., downstream workflows, validation routines, compliance checks, etc.) based on local systems of records. By ensuring that local systems of records stay up to date, the data processing system can reduce computing resources used to rollback operations executed based on outdated information. Furthermore, the data processing system may prevent redundant data transmissions. For example, disjointed data systems may lack coordination, causing requests and/or data updates to be redundantly transmitted, thereby using unnecessary computing resources. As an example, multiple nodes may independently submit the same request to an associated node and/or transmit separate notifications of updated information to associated nodes, thereby generating duplicative network traffic.

By dynamically generating digital records from sub-graph data structures and using visual graph representations as a shared reference framework, the described techniques enable requesting and responding parties to communicate based on network positions within the network graph data structure rather than disconnected identifiers or forms. The techniques establish unambiguous associations between submitted information and the corresponding entities or relationships within the network graph data structure and enable accepted updates to be propagated across multiple tiers of the sub-graph data structure. As a result, the computing system can reduce data fragmentation and synchronize and maintain consistency across distributed systems of record. The described techniques may therefore increase efficiency of requests for additional information by providing context retrieved from the unified network graph data structure and identifying computing systems for propagation via the network graph data structure in response to receiving additional information.

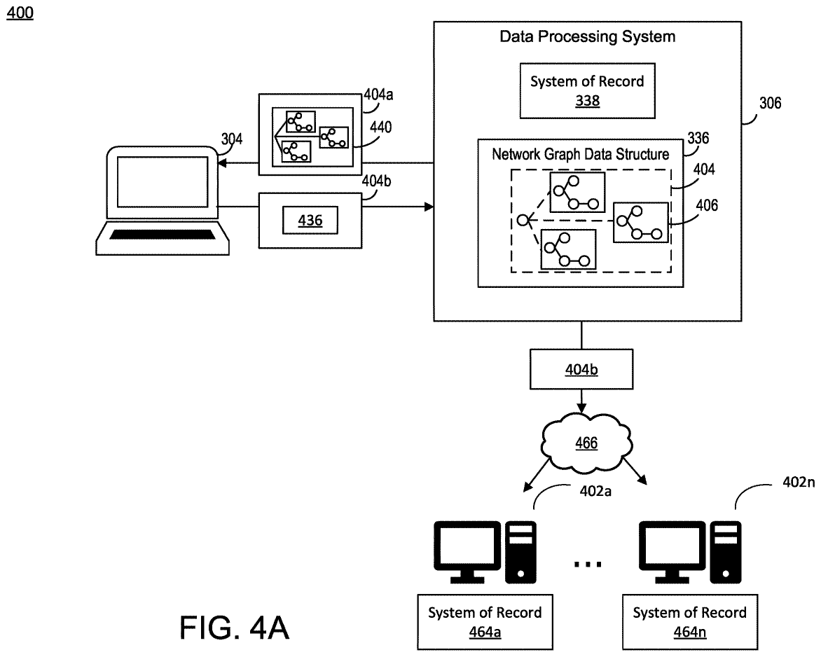

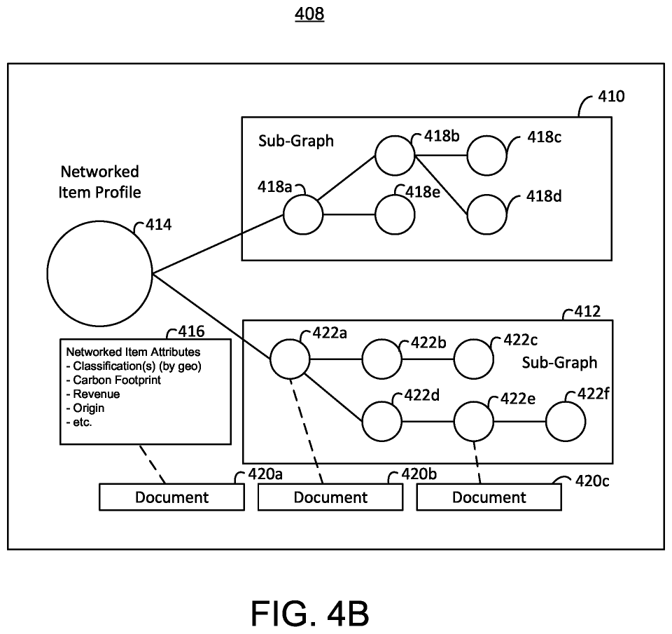

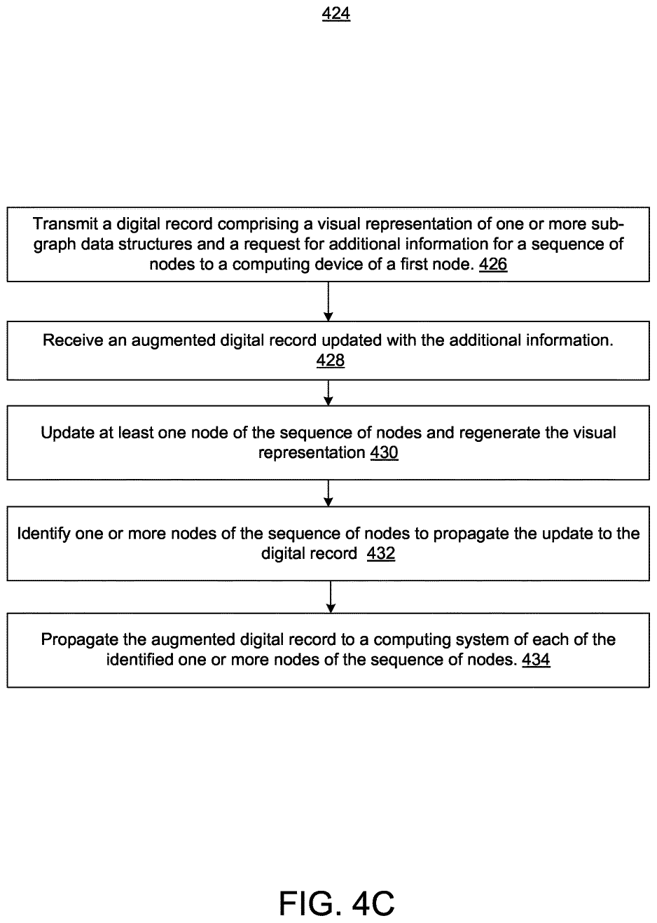

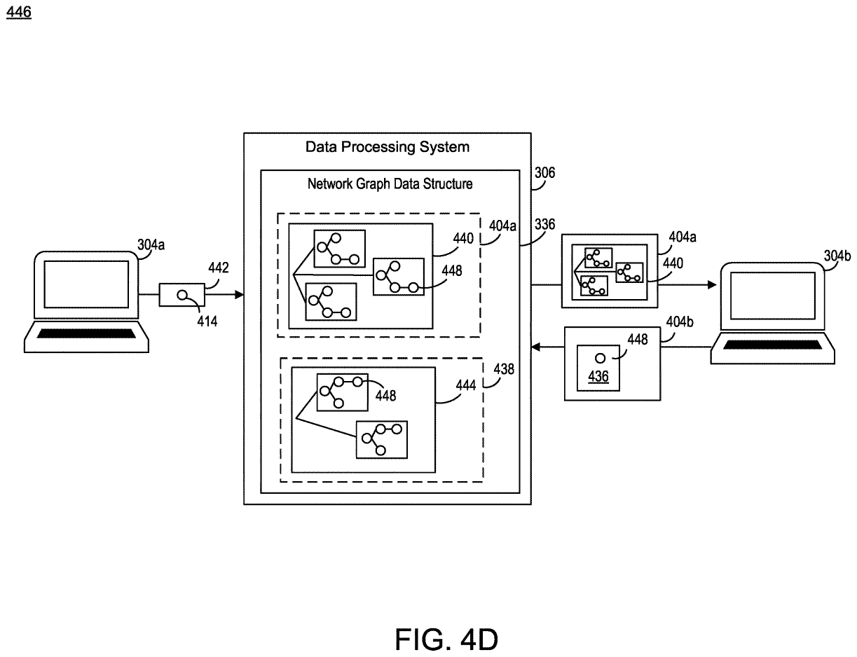

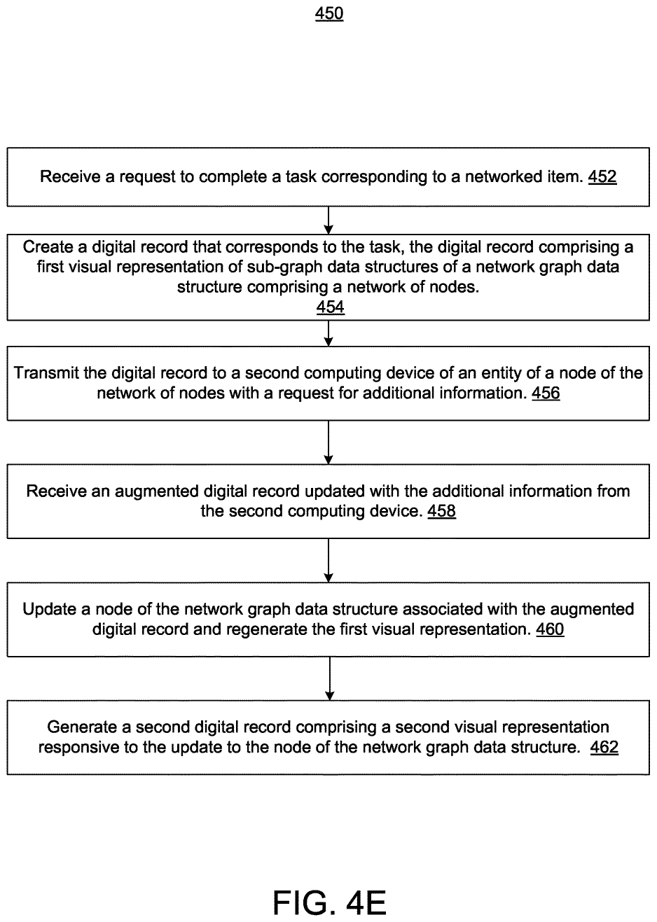

Referring now to FIG. 4A, illustrated is a schematic diagram of a system 400 for updating and propagating graph-based data across a computer network in a distributed computing environment. The system 400 can include the computing device 304, the data processing system 306, the network graph data structure 336, the system of record 338, computing systems 402a-402n (individually, computing system 402, collectively computing systems 402), system of records 464a-464n (individually, system of record 464, collectively systems of records 464), a digital record 404, a sub-graph data structure 406, additional information 436, and a communications network 466. The digital record 404 can include a first digital record 404a and an augmented digital record 404b.

The digital record 404 can be any data structure that includes data associated with at least part of a value chain of a networked item. The digital record 404 may include information associated with the networked item. As an example, the digital record 404 may include a summary of a classification of the networked item, carbon footprint, and associated sub-graphs. The digital record 404 can include a set of nodes (e.g., intermediate raw materials used to manufacture a finished garment) and/or edges (e.g., connections between the nodes) that represent the flow of components and assembly steps based on which the networked item is manufactured. In some examples, the digital record 404 can include attributes of the product (e.g., material composition, manufacturing location, production date, etc.). In some examples, the digital record 404 may be transmitted to the computing device 304 for presentation via a user interface. For example, the digital record 404 may be transmitted as a file, a data object, or a link that allows the computing device 304 to access a view of the relevant sub-graph data structures.

The digital record 404 can include the sub-graph data structure 406. For example, the digital record 404 can include a plurality of sub-graph data structures, including the sub-graph data structure 406. The sub-graph data structure 406 can be a subset of the overall network graph data structure 336 representing a specific set of relationships relevant to a networked item. A chain of nodes may form a path from a source node to a destination node representing a product or service provided by the entity. As an example, if the networked item is a chocolate bar, the sub-graph data structure 406 may include a chain of nodes associated with specific ingredients, such as sugar or cocoa beans, as they are converted into the chocolate bar at different nodes. The sub-graph data structure 406 can show the upstream suppliers (e.g., agricultural cooperatives that grow the cocoa beans) and transformation steps (e.g., post-harvesting processing, such as bean roasting) for a particular component of a product. These suppliers may be represented as nodes and their interconnected relationships may be represented as edges within the sub-graph data structure 406. In some cases, each sub-graph data structure in the digital record 404 can represent a different path to generating the networked item of the digital record 404.

In an example, the sub-graph data structure 406 may be generated by querying the network graph data structure 336 for nodes and edges linked to a given networked item profile. The sub-graph data structure 406 may be generated by filtering by relevant attributes or relationships. For example, the sub-graph data structure 406 may be constructed using a machine learning model to perform entity resolution and relationship extraction to build the relevant chain of nodes. The data processing system 306 may execute one or more machine learning models to identify latent relationships, infer missing links, and classify entities within the sub-graph data structure 406 based on contextual and semantic patterns derived from the underlying data. The machine learning model may be executed on various records available to the data processing system 306. These records can include public records (e.g., public import records retrieved from a government database), third-party commercial databases (e.g., supplier registries, trade compliance datasets, and industry certifications), and records provided by the computing device 304. As an example, the machine learning model can perform entity resolution by identifying that two terms refer to the same entity across different documents. As another example, the machine learning model may extract relationships by identifying patterns such as supplier-customer linkages, shared logistics providers, or co-occurrence of entities within procurement documents and shipment records.

In some implementations, the digital record 404 can be updated by the computing device 304. For example, the data processing system 306 may transmit the first digital record 404a to the computing device 304. The first digital record 404a may represent a first version of the digital record 404 that is generated based on current data in the network graph data structure 336. In some examples, the first digital record 404a may be associated with a deficiency. For example, the first digital record 404a may be missing country of origin certificates, supplier identification documents, compliance attestations, etc. In an example, the deficiency may be determined by the data processing system 306. For example, the data processing system 306 can transmit the first digital record 404a in response to determining that the digital record 404 fails to satisfy a completion condition. The completion condition can be a defined set of data fields, documentation, etc. In an example, the deficiency can be determined by another computing device associated with the data processing system 306. For example, the other computing device can transmit a request for additional data associated with the digital record 404.

The additional information 436 can be information transmitted by the computing device 304 in response to receiving the request for information from the data processing system 306. For example, the additional information 436 can include requested information associated with the first digital record 404a, such as information associated with a node of the sub-graph data structure 406. The additional information 436 can be data, documents, comments, attestations, certificates, etc. For example, the additional information 436 can include country of origin certificates, supplier identification documents, bills of material, purchase orders, invoices, certificates of compliance, environmental data, attestations about the use of specific materials or labor practices, etc. In some examples, the additional information 436 can correspond to specific nodes or edges within the sub-graph data structure 406. For example, the computing device 304 can indicate that the additional information 436 corresponds to a specific node or edge. In response to receiving the additional information 436, the data processing system 306 may update the network graph data structure 336. For example, the data processing system 306 can write the received additional information 436 into corresponding nodes or edges. The data processing system 306 may update the network graph data structure 336 by inserting values into field-value pairs, linking files or documents to nodes, adding new relationships or edges between nodes, regenerating the visual representations to reflect the updated graph data, etc.

In some implementations, the computing device 304 can receive a request to provide the additional information 436 associated with the network graph data structure 336. For example, the computing device 304 can receive the first digital record 404a including the sub-graph data structure 406 from the data processing system 306. The first digital record 404a may be received with a request to provide the additional information 436 associated with a node and/or edge of a sub-graph data structure included in the first digital record 404a. For example, the first digital record 404a may be received with a request to provide country of origin certificates, compliance documentation such as forced labor attestations, etc. of a node. In some examples, the computing device 304 may display at least part of the first digital record 404a in response to receiving the first digital record 404a. For example, the computing device 304 may render a sequence of nodes forming a path from a source node to a destination node to present the first visual representation 440 of the network graph data structure 336 at a graphical user interface on the computing device 304.

In some examples, the computing device 304 can transmit the augmented digital record 404b including additional information 436 in response to receiving the request for the additional information 436. For example, in response to receiving the request including the first digital record 404a, the computing device 304 can receive user input providing the additional information 436. The computing device 304 can then transmit the additional information 436 to the data processing system 306 for propagation to the system of record 338 of the network graph data structure 336 and/or the systems of records 464 of the computing systems 402. The computing device 304 may provide the additional information 436 by uploading documents, submitting a selection from a defined list of elements, transmitting a text string, etc.

The first digital record 404a may include the first visual representation 440. The first visual representation 440 may be a graphical depiction of one or more sub-graph data structures (e.g., including the sub-graph data structure 406) extracted from the network graph data structure 336. The first visual representation 440 may include node icons and edge lines representing entities and relationships within the supply chain. The data processing system 306 may cause presentation of the first visual representation 440 on a user interface of the computing device 304 based on transmitting instructions to render the first visual representation 440. In some examples, the first visual representation 440 can provide context for the requested information. For example, the first visual representation 440 can provide contextual information about the manufacture and/or distribution of the networked item associated with the request.

The computing systems 402 may be devices associated with nodes of the network graph data structure 336. For example, the computing systems 402 can include servers, workstations, or cloud-based computing platforms operated by suppliers, manufacturers, importers, exporters, logistics providers, or regulatory agencies. As an example, the computing system 402 may be a server system operated by a cocoa bean processing manufacturer responsible for roasting and packaging raw cocoa beans supplied by agricultural cooperatives. In some examples, the computing system 402 may trigger downstream workflows, generate review tasks, or initiate validation processes in response to receiving the propagated augmented digital record 404b. For example, the computing system 402 may notify regulatory bodies to begin verification procedures based on the updated information contained in the augmented digital record 404b.

Each of the computing systems 402 may maintain a respective system of record of the system of records 464. The systems of records 464 may include a set of nodes represented in the network graph data structure 336. The system of record 464 may be a repository or database that stores information about entities, transactions, attributes, and/or relationships relevant to the operations of the computing system 402. As an example, the system of record 464a for a computing system 402a representing a manufacturer may include detailed information about production batches, supplier certifications, and compliance documents. In some examples, the data processing system 306 may maintain the system of record 338. In these examples, the systems of record 464 of the computing systems 402 can be updated based on the system of record 338 of the data processing system 306 by synchronizing changes from the augmented digital record 404b that have been accepted into the system of record 338 of the data processing system 306 into the systems of records of the computing systems 402. In some examples, the computing system 402 may update data associated with products (e.g., internal product profiles, compliance documentation, supplier information, etc.) based on the augmented digital record 404b received across the communications network 466.

The communications network 466 can be any type of communications network that enables communication between the data processing system 306 and the computing systems 402. For example, the communications network 466 can include the Internet, one or more local area networks, wide area networks, wireless networks, cellular networks, satellite networks, or any combination thereof. In some examples, the data processing system 306 can transmit the augmented digital record 404b to the computing systems 402 via the communications network 466 based on addresses of the computing systems 402. For example, the data processing system 306 can transmit the augmented digital record 404b via the communications network 466 by identifying an address of a computing system 402a and including the address in a header of data packets containing the digital record 404. In some examples, the communications network 466 can propagate the augmented digital record 404b to multiple computing systems 402. For example, the data processing system 306 can propagate the augmented digital record 404b based on defined propagating policies. The propagation policies can define which of the computing systems 402 receive which modifications to the network graph data structure 336. For example, the propagation policies can indicate a subset of the computing systems 402 that are to receive updated digital records associated with a defined attribute.

Referring now to FIG. 4B, illustrated is a schematic diagram of a digital passport 408 for value chain management, in accordance with one or more implementations. The digital passport 408 may be generated for a networked item (e.g., a digital representation of a product) by a data processing system, such as the data processing system 306 of FIG. 3A. The digital passport 408 can include a sub-graph data structure 410, a sub-graph data structure 412, a networked item profile 414, networked item attributes 416, and one or more documents 420a-420c. The sub-graph data structure 410 can include one or more nodes 418a-418e. The sub-graph data structure 412 can include one or more nodes 422a-422f.

The digital passport 408 may be a digital representation of the networked item. For example, the digital passport 408 can be a structured data file, such as a JSON, XML, or other container format that supports extensible metadata and relationships. In response to receiving a request from a client device (e.g., the computing device 304 of FIG. 4A) to generate a passport for a networked item, the data processing system can generate the digital passport 408 based on data associated with that networked item. The digital passport 408 may consolidate relevant information associated with the networked item, such as documents associated with the networked item and/or sub-graphs showing relevant relationships to other networked items. In some examples, a user may transmit the digital passport 408 to another user. For example, the client device may transmit a link (e.g., HTTP link) to the digital passport 408. In this example, the data processing system may present the digital passport 408 based on the access permissions of the device opening the link to the digital passport 408. Specifically, the data processing system may compare access permissions (e.g., an access credential indicating access permissions) of a client device or account accessed by the client device opening the link to access restrictions associated with data within the digital passport 408. Based on this comparison, the data processing system may remove data (e.g., from the view presented in the digital passport 408). For example, the data processing system may remove data that the client device is not permitted to view based on their level of access. In some examples, the digital passport 408 may be included as part of a digital record (e.g., the digital record 404 of FIG. 4A). For example, the digital passport 408 may be included as part of a request for additional information associated with the network graph data structure (e.g., the network graph data structure 336 of FIG. 4A).

In some implementations, the digital passport 408 may be generated as part of or in response to receive of a request for additional information about the networked item corresponding to the networked item profile 414. For example, the data processing system can dynamically create the digital passport 408 in response to determining that additional information associated with the networked item is requested. As an example, in response to initiating a task, the data processing system can generate the digital passport 408 to be provided as part of a request to execute an operation associated with the task (e.g., upload documents, provide information, etc.). The task may be any operation involving user input from a client device associated with the network graph data structure (e.g., the client device 304 of FIG. 4A). For example, can include verifying information associated with the network graph data structure (e.g., based on an attestation submitted by the client device), updating information associated with the network graph data structure (e.g., based on user input including new files), etc. By leveraging the network graph's structured data, the data processing system can visually depict entities and relationships in a graphical format that accurately reflects the current state of the sub-graph data structure for that networked item. The digital passport 408 may be presented as a visual representation of the networked item. For example, the digital passport 408 may be rendered at a computing device along with a request for additional information about the networked item. The digital passport 408 may provide contextual information about the currently available information associated with the networked item.

The sub-graph data structure 410 may be a subset of the overall network graph data structure, representing a specific set of relationships relevant to the networked item profile 414. For example, the sub-graph data structure 410 may show the upstream suppliers and transformation steps for a particular product and/or component of a product represented by the networked item profile 414. The sub-graph data structure 410 can store and organize nodes and edges that correspond to entities and relationships involved in the production, transformation, and/or movement of a product associated with the networked item profile 414. For example, the sub-graph data structure 410 may represent a chain of nodes forming a path of one or more instances of the networked item from a source node (e.g., node 418c and/or node 418d) to a destination node (e.g., node 418a).

The sub-graph data structure 410 may be generated by querying a network graph data structure (e.g., network graph data structure 336 of FIG. 3A) for nodes and edges associated with the networked item. In an example, the data processing system can generate the sub-graph data structure 410 by filtering the network graph data structure based on relevant attributes or relationships. In this example, the data processing system may execute a machine learning model to identify and/or extract relationships within the network graph data structure. For example, the machine learning model can identify when two terms refer to the same entity or identify relationships between entities based on contextual clues. Based on the output of the machine learning model, the data processing system may generate nodes and/or relationships to be included as part of the sub-graph data structure 410.

The sub-graph data structure 412 may be another instance or type of sub-graph. For example, the sub-graph data structure 412 may represent a different set of relationships for the same or another networked item. This different set of relationships may be a downstream distribution or alternative supply routes for the networked item. As an example, if the networked item is an electronic device manufactured by a particular entity, the sub-graph data structure 410 may represent a value chain associated with sourcing battery cells from one country (e.g., a manufacturer in South Korea) while the sub-graph data structure 412 may represent a value chain associated with sourcing battery cells from another country (e.g., a manufacturer in Canada). In an example, the sub-graph data structure 410 may represent a value chain associated with manufacturing the electronic device while the sub-graph data structure 412 may represent a value chain associated distributing the electronic device to retail stores. The sub-graph data structure 412 may therefore provide additional or alternative views into the networked item's value chain, supporting analysis, decision support, or compliance checks. The sub-graph data structure 412 may be constructed using similar methods as sub-graph data structure 410. However, the sub-graph data structure 412 can be constructed using different filters, criteria, and/or user-driven customization.

The networked item profile 414 can be a data structure (e.g., a table, spreadsheet, or other type of structured data) that represents a networked item. The networked item profile 414 may be a node representing a specific product, material, or item within the sub-graph data structure, serving as a central reference point for associated data and relationships. For example, the networked item profile 414 may be a profile for a particular product, such as an electronic device, and the various components that the product is made out of. The networked item profile 414 can aggregate and present key attributes, relationships, and supporting documentation for the networked item. For example, the networked item profile 414 may store references to sub-graph data structures, documents, and attribute sets for the product. The networked item profile 414 may be instantiated by the system upon receipt of a user request or as part of automated data ingestion, linking to sub-graphs, attributes, and documents as appropriate. For example, the networked item profile 414 may be created or updated dynamically as new data is ingested or user input is received. In some examples, the networked item profile 414 can represent a plurality of instances of the networked item. For example, the networked item profile 414 can represent the networked item at various points within the value chain. As an example, the networked item profile 414 can represent a product throughout multiple stages of its manufacturing lifecycle within a value chain.

The networked item attributes 416 can be a collection of data fields describing properties of the networked item (e.g., carbon footprint, revenue, origin, etc.). As an example, the networked item attributes 416 may include tariff classification codes, carbon footprint metrics, or certification data such as fair trade or organic status for the networked item. The networked item attributes 416 can provide relevant information for compliance, reporting, analytics, and decision support related to the networked item. For example, the networked item attributes 416 may be used to generate digital records (e.g., passports), such as for regulatory or documentation purposes. The networked item attributes 416 may be populated from internal or external data sources, user input, or automated extraction from documents (e.g., documents 420a-420c), and may be updated as new information becomes available. For example, the networked item attributes 416 may be extracted using AI and natural language processing (NLP) from supporting documents or system-of-record data (e.g., the system of record 338 of FIG. 3A).

The documents 420a-420c can be electronic files or records that provide supporting evidence, provenance, or attestation for the data and relationships represented in the digital passport 408 and associated sub-graphs. For example, the documents 420a-420c may include certificates of origin, bills of materials, audit reports, or compliance documents. The documents 420a-420c may be retrieved from internal and/or external sources. For example, the documents 420a-420c may be retrieved from a network graph data structure (e.g., the network graph data structure 336 of FIG. 3A). In some examples, the documents 420a-420c can be linked to specific nodes or attributes to substantiate claims, provide audit trails, or support regulatory compliance. As an example, a document 420a may be linked to a node representing a manufacturing facility, while a document 420b may be linked to a shipment event. The documents 420a-420c may be associated with nodes or attributes via metadata, hyperlinks, or embedded references, and may be managed within the a hub of a federated system for secure storage and retrieval.

The sub-graph data structure 410 can include the nodes 418a-418e. The nodes 418a-418e can be data structures representing entities such as facilities, companies, or locations within a sub-graph data structure 410. For example, each node of the nodes 418a-418e may correspond to a supplier, transformation step, or logistics provider in the value chain. The nodes 418a-418e can serve as connection points for edges representing relationships, enabling the modeling of value chain networks. For example, the nodes 418a-418e may be connected by edges to form a chain representing the flow of goods or information. The nodes 418a-418e can be instantiated based on entity resolution and canonicalization processes, linked by edges according to detected or inferred relationships. For example, the data processing system may generate the nodes 418a-418e by executing a machine learning model to resolve duplicate or ambiguous entities and construct the sub-graph.

The sub-graph data structure 412 can include the nodes 422a-422f. The nodes 422a-422f may correspond to another segment or aspect of the value chain. For example, nodes 422a-422f may represent downstream distributors, alternate suppliers, or related facilities. The nodes 422a-422f can enable the modeling of alternative or extended value chain scenarios, supporting analysis and decision-making. For example, the nodes 422a-422f may be connected by edges to illustrate alternative supply routes or distribution paths. The nodes 422a-422f may be generated, resolved, and linked using the same or similar processes as nodes 418a-418e. This process can include user-driven or automated selection of which sub-graphs to display or analyze. For example, a client device (e.g., the computing device 304 of FIG. 4A) may transmit input that indicates which sub-graph data structures to display.

Referring now to FIG. 4C, illustrated is a flow chart depicting a method 424 for updating and propagating graph-based data across a distributed computing environment. The method 424 can be executed, performed, or otherwise carried out by any of the computing systems or devices described herein, such as the data processing system 306 shown and described with reference to FIG. 3. The method 424 can include any number of operations, and the operations can be performed in any order. Each of the operations can be performed by the same computing device, or different computing devices can perform different operations of the method 424. Conventional methods for managing data of a network graph data structure may involve inefficient and fragmented multi-party information exchange within distributed network graph data structures disconnected processes can involve high latency data updates. By implementing the method 424, the data processing system can improve the efficiency of propagating updates within a unified network graph by enabling dynamic, targeted update dissemination.

At operation 426, the method 424 can include transmitting a digital record (e.g., the first digital record 404a of FIG. 4A) comprising a visual representation (e.g., the first visual representation 440 of FIG. 4A) of one or more sub-graph data structures and a request for additional information for a sequence of nodes to a computing device of a first node. For example, the data processing system can request additional information such as country of origin certificates, compliance attestations, etc. The request may be associated with a particular node and/or edge in the one or more sub-graph data structures. The data processing system can transmit the digital record to a computing device (e.g., the computing device 304 of FIG. 1) of a first node of a network of nodes represented in a network of nodes of the network graph data structure included in the digital record. Each node in the network graph data structure may be associated with a computing device. For example, each node may represent an entity involved in the value chain, such as a supplier, manufacturer, distributor, or logistics provider. The entities may correspond to computing devices via which the entities can interact with the network graph data structure. For example, each entity can interact (e.g., view, submit requests for additional data, add additional data, etc.) with at least part of the network graph data structure via a computing device. As an example, the computing device may correspond to an entity responsible for roasting cocoa beans within a value chain for producing chocolate bars. The digital record can include a visual representation of one or more sub-graph data structures (e.g., the sub-graph data structure 406 of FIG. 4A) of the network graph data structure.

For example, the digital record can include sub-graph data structure associated with the requested additional information. As an example, if the request is a request for carbon footprint data, the sub-graph data structures may represent the upstream raw material suppliers and their processing facilities within the value chain. A visual representation may refer to a graphical rendering of the sub-graph data structures. In some examples, the data processing system can cause presentation of the visual representation at the computing device by transmitting the digital record.

In some implementations, the digital record may include a sequence of nodes that form a path of a networked item (e.g., a networked item corresponding to the networked item profile 414 if FIG. 4B). For example, the nodes may form a path from a source node to a destination node. A networked item may be an item represented within the network graph data structure. For example, the networked item can represent raw materials, an intermediate product, or a final product. The first node corresponding to the computing device that the digital record is transmitted may be the source node, the destination node, or any node in between within the sequence of nodes of the path. In some examples, the path may represent network operations of the networked item through the sequence of nodes. For example, the path may depict the movement of a networked item from raw material suppliers, through manufacturing and assembly facilities, to distributors and finally to retailers or customers, with each node representing a specific entity performing an operation or handling the networked item at different stages of the sequence of nodes. Network operations may refer to any operation (e.g., production, processing, transportation, storage, etc.) associated with the path of the networked item. In some examples, each node of the sequence of nodes may represent an entity performing a network operation on one or more instances of the networked item. As an example, if the networked item is an electronic device, the nodes in the sequence of nodes can represent suppliers of electronic components, assembly manufacturers, testing facilities, distributors, etc. In this example, a supplier may perform a network operation of manufacturing electronic components, the assembly manufacturers may perform a network operation of assembling the electronic components into the electronic device, the testing facilities may perform a network operation of testing the electronic device, and the distributors may perform a network operation of transporting the electronic device. In some examples, each edge between pairs of nodes in the sequence of nodes may represent movement of the networked item from a first node in the pair to a second node in the pair. As an example, an edge may represent shipment of electronic components from a supplier to an assembler or transportation of finished goods from a manufacturer to a distributor.

In some implementations, the digital record and/or the request for additional data may be generated based on a request from a second computing device. For example, the data processing system can receive a request from the second computing device to complete a task corresponding to the networked item. Tasks may include any update to the network graph data structure involving user input of at least one client device. For example, tasks can include verification of existing data in the network graph data structure, upload of data associated with at least part of the network graph data structure, etc. In some examples, the network graph data structure may be modified based on user input submitted as part of a task. For example, edges may be reconfigured to reflect new relationships between nodes indicated by the user input. In some examples, a client device can initiate a task. For example, the second computing device may transmit a request based on determining a deficiency or a lack of a value associated with the first node. The second computing device may transmit the request based on determining that current information associated with the first node does not satisfy a completion threshold. The completion threshold can be inclusion of a defined set of fields, defined documents, etc. As an example, the second computing device may be associated with an importer. In this example, the second computing device may identify that the first node lacks a country of origin designation, rendering the information insufficient to assess whether the networked item complies with applicable sanctions. The data processing system can create the digital record in response to the request. As part of generating the digital record, the data processing system can identify the one or more sub-graph data structures of the network graph data structure based on a link between the one or more sub-graph data structures and a node of a profile for the networked item within the network of nodes. For example, the data processing system may query the network graph data structure to retrieve nodes and edges associated with the profile of the networked item, filter relevant relationships based on task parameters, and assemble a sub-graph data structure representing the specific portion of the network graph data structure pertinent to the requested information. Task parameters may indicate a type of information being requested (e.g., verification with a certain standard). The data processing system may determine nodes associated with the networked item based on determining which nodes are connected (e.g., via edges) to the networked item. The data processing system may then filter out at least some of the nodes and/or edges that are determined to be connected to the networked item.

As an example, the networked item may be an electronic device, and the nodes may represent entities involved in manufacturing and distributing the electronic device (e.g., suppliers of electronic components, assembly manufacturers, etc.). In response to a task associated with verification of compliance of forced labor standards associated with a particular mineral (e.g., cobalt) used in a particular component (e.g., a lithium-ion battery) of the electronic device, the data processing system may filter out edges and/or nodes not associated with the component. In an example, the data processing system may filter out nodes and/or edges that are not relevant to a type of the task. For example, nodes associated with testing the component may not be relevant to verification of compliance with forced labor standards due to such testing being performed after manufacture of the component and therefore not providing information relevant to labor practices involved in extraction or refinement of the mineral. The data processing system can extract the remaining nodes and edges to construct a sub-graph that provides relevant context to the request to verify compliance of the cobalt with the force labor standards.

In some implementations, the digital record may be rendered at the computing device as part of the request for the additional information. For example, the data processing system can create a visual representation of the sub-graph data structure that corresponds to completing the task identified in the request. The data processing system can transmit the digital record by rendering the visual representation on a user interface for presentation on the computing device. The visual representation can be displayed to the responding party to provide network context showing entities (e.g., nodes) and relationships (e.g., edges) associated with the request. The rendered visual representation can allow the responding party to identify specific nodes or edges within the sub-graph data structure to which the requested information is to be attached or appended. For example, the user interface can present the visual representation as an interactive graphical depiction with selectable node icons and edge lines representing entities and relationships within the network graph data structure. The computing device may transmit pointer input that selects a node and/or edge associated with the additional information to indicate which node and/or edge the additional information corresponds to. Pointer input may be any user input generated via a pointing device (e.g., mouse input, touchscreen input, etc.). The computing device can generate the augmented digital record based on user input selecting nodes and/or edges within the rendered visual representation and the additional data (e.g., files, documents, attestations, etc.).

At operation 428, the method 424 can include receiving an augmented digital record (e.g., the augmented digital record 404b of FIG. 4A) updated with the additional information (e.g., the additional information 436 of FIG. 4A). For example, the data processing system can receive the additional information in response to the request. The additional information can be any data (e.g., documents, text strings, etc.) associated with the sequence of nodes. For example, the additional information may be associated with a particular node associated with the request. As an example, the request can indicate a request for a defined type of documentation associated with a particular node within the sequence of nodes. In some examples, the computing device may attach the additional information to specific nodes or edges within the sub-graph data structure. For example, the computing device may transmit an indication that the additional information corresponds to a particular node based on interactions (e.g., pointer input) within the graphical user interface displaying the visual representation included in the digital record. In an example where the computing device is associated with the first node within the sequence of nodes, the computing device may indicate that the additional information corresponds to the first node. As an example, if the computing device corresponds to a first node representing distribution of an electronic device, the computing device can upload additional information associated with the distribution (e.g., shipment tracking details, delivery confirmation documents, etc.).

At operation 430, the method 424 can include updating at least one node of the sequence of nodes. The data processing system can regenerate the visual representation (e.g., based on the update to the at least one node). For example, the data processing system can update a node based on the additional information received from the computing device. In some examples, the additional information may be associated with an update to the first node. In some cases, the additional information may result in updates to nodes associated with the first node within the sequence of nodes. As an example, the data processing system may update upstream supplier nodes with newly provided compliance certifications or modify linked edges to reflect revised shipment schedules based on the received information. The data processing system may update the node by executing one or more data modification operations to the network graph data structure (e.g., associating new documents, adding metadata tags, establishing new edges connecting the node to related entities, etc.). For example, the data processing system can update a node representing an upstream supplier by inserting a value into a field-value pair of the node or linking a file containing a certificate of origin to the node. In some examples, the data processing system can regenerate the visual representation based on the updated node. For example, if the update to the node results in new edges, the data processing system can regenerate the visual representation to reflect the new edges (e.g., new connections between nodes).

In some implementations, receipt of the augmented digital record may cause the addition of an edge. For example, the data processing system can transmit the augmented digital record to a computing system of a downstream node. The computing system can receive the augmented digital record and process the additional information contained within it. The processing can trigger the computing system to locally add an edge between a pair of nodes of the set of nodes within the digital record. The edge can represent a newly identified relationship between the pair of nodes based on the additional information. As an example, if the additional information indicates a newly discovered supplier relationship for a specific electronic component, the data processing system may add an edge that links the component supplier node to the assembly manufacturer node, reflecting the updated network graph data structure connection. The computing system can add the edge to its local system of record by creating a new relationship entry linking the pair of nodes. The addition of the edge can occur automatically in response to receipt of the augmented digital record without manual intervention by a user at the computing system.

At operation 432, the method 424 can include identifying one or more nodes of the sequence of nodes to propagate the update to the digital record. For example, the data processing system can identify nodes in the sequence of nodes that satisfy a propagation condition based on update generated based on the additional information provided by the computing device. The propagation condition may be defined by a type of task, the additional information, and/or node affected by the update. As an example, propagation conditions for additional information associated with raw materials (e.g., cobalt), may be different than propagation conditions for additional information associated with quality testing (e.g., electrical component testing). The propagation condition can be a defined relationship between a node associated with the update and other nodes in the sequence of nodes. For example, the propagation condition can be a defined distance within the sequence of nodes (e.g., within three nodes of an updated node), in a particular direction (e.g., towards a source node or a destination node), an attribute of a node (e.g., an attribute indicating a node represents a regulatory organization), an indication of a subscription to a type of update (e.g., subscription of a node to new country of origin files within an associated sequence of nodes), etc. As an example, if an update adds a file to a node, the data processing system can propagate the update to all nodes that are downstream of the updated node in the sequence of nodes based on determining that downstream nodes satisfy the propagation condition, etc. As another example, the data processing system can identify downstream nodes associated with attributes indicating the nodes represent regulatory bodies satisfy the propagation condition.

As an example, the data processing system can identify downstream nodes corresponding to manufacturing facilities that assemble the electronic device satisfy the propagation condition. In this example, transmitting the updated digital record may cause the manufacturing facilities systems to evaluate the update. For example, the manufacturing facilities may evaluate an updated node for compliance with a standard (e.g., an International Electrotechnical Commission (IEC) standard). By identifying nodes to propagate the update to based on configured propagation conditions, the data processing system can selectively disseminate updated digital records to relevant computing systems while reducing unnecessary transmissions across the distributed computing environment. For example, while conventional computing infrastructure exchange processes rely on disjointed data transmission (e.g., emails, spreadsheets, and siloed system updates) that may not reliably reach all affected parties, the network graph data structure can identify connected nodes and relationships that satisfy propagation condition for targeted update delivery. As a result, the data processing system can improve synchronization of distributed systems of record and/or reduce redundant data transmissions.

In some implementations, the data processing system can propagate the augmented digital record (e.g., including an update to at least one node and/or edge in the sequence of nodes) based on identifying nodes connected (e.g., via edges) to the first node. For example, the data processing system can identify one or more other nodes of the sequence of nodes to propagate the update to the digital record by identifying each node of the sub-graph data structure containing the sequence of nodes through edges connecting the respective nodes. The data processing system can traverse the edges of the sub-graph data structure starting from the first node to discover connected nodes within the sequence. Each traversed edge can link a pair of nodes that represent entities participating in the path within the network graph data structure. The data processing system can compile a list of identified nodes by following the edges from the first node through intermediate nodes to the destination node. The data processing system can then propagate the augmented digital record to computing systems associated with at least some of the identified nodes to communicate the update across the sequence of nodes.

At operation 434, the method 424 can include propagating the augmented digital record to a computing system of each of the identified one or more nodes of the sequence of nodes. For example, the data processing system can propagate the augmented digital record across a communications network (e.g., the communications network 466 of FIG. 4A) to a computing system (e.g., the computing system 402 of FIG. 4A) of each of the identified one or more other nodes of the sequence of nodes. The augmented digital record may be transmitted to trigger an action regarding a system of record maintained by the computing system (e.g., the systems of record 464 of FIG. 4A). The action can be any operation associated with management of the system of record (e.g., data synchronization tasks, review operations, generation of audit logs, etc.). For example, the data processing system can propagate the augmented digital record to a computing system operated by a regulatory agency. In this example, the receipt of the augmented digital record may trigger a review queue notification. Based on the review queue notification, a regulator associated with the computing system can evaluate the updated information. In an example, the regulator may validate imports (e.g., verify that the networked item complies with one or more regulatory standards) based on the information in the augmented digital record. In some examples, propagating the updates to the identified nodes may reduce redundant requests for the additional information (e.g., and therefore may increase efficiency of maintaining data records within the sequence of nodes). For example, once a country of origin certificate is received from one node and written into the network graph data structure, the data processing system can propagate the updated digital record to other nodes identified at operation 432 so those nodes can rely on the propagated information rather than separately issuing duplicative requests for the same documentation.

In some implementations, the augmented digital record may be propagated through the communications network based on addresses of the identified computing systems. For example, the data processing system can identify an address of a second computing device of a computing system from a node of the identified one or more other nodes of the sequence of nodes. The address can be any network-based address (e.g., an internet protocol (IP) address, media access control (MAC) address, etc.). In some examples, the data processing may transmit the augmented digital record as a set of data packets. The data processing system can include the address in a header of each of the set of data packets that include the augmented digital record. The data processing system can then transmit the set of data packets to the second computing device across the communications network. The data packets can be routed through the communications network to the second computing device based on the address in the packet headers. The second computing device can receive the data packets. The second computing device may reassemble the augmented digital record for presentation or processing at the computing system. For example, the second computing device can render the regenerated visual representation based on the reassembled packets.

In some implementations, the edge may be added based on interactions with the computing system. For example, receipt of the augmented data digital record may trigger transmission of the set of nodes to the computing system. The data processing system can transmit the set of nodes to the computing system. The set of nodes may include attributes corresponding to entities represented by the set of nodes. For example, the set of nodes may include attributes such as company identifiers, location details, compliance certifications, shipment schedules, or product specifications corresponding to the entities represented by the set of nodes. The attributes may be generated by the data processing system and/or provided by computing devices. The computing system can modify one or more edges based on the additional information included in the augmented data. For example, the computing system can add an edge representing a connection between a pair of nodes in the set of nodes. The data processing system may receive the edge in response to transmitting the set of nodes to the computing system. As an example, if the augmented digital record includes new compliance information revealing a supplier relationship between a semiconductor foundry and a circuit board assembler, the data processing system may transmit nodes representing the semiconductor foundry and the circuit board assembler, and the computing system may add an edge linking these nodes to reflect this updated connection.

In some implementations, the data processing system may verify security or access control permissions of nodes before propagating the augmented digital record. For example, the data processing system can determine whether security permissions of each node satisfies a threshold. The data processing system can identify security permissions of each node of the sequence of nodes by querying permission metadata stored in the network graph data structure and/or in a separate access control database. Security permissions can define which entities (e.g., which computing systems and/or nodes corresponding to the entities) are authorized to receive updates to specific nodes or edges based on role-based access rules, data classification levels, etc. The data processing system can determine to propagate the augmented digital record to a computing system of an identified node based on determining the security permissions of the node satisfy a threshold. The threshold can be any attribute permission attributes (e.g., a minimum permission level, a set of required authorization attributes, etc.) that confirm the recipient node (e.g., the computing system) has appropriate rights to access the updated information. As an example, if an augmented digital record proprietary includes bill-of-material details, the data processing system can restrict propagation only to nodes with elevated permission levels that authorize access to the proprietary bill-of-material data. The data processing system can filter the list of identified nodes generated in operation by comparing the security permissions of each node against the threshold before transmitting data packets across the communications network. The selective propagation based on verified permissions can prevent unauthorized disclosure of sensitive information while still enabling broad distribution of generalized network connectivity updates to nodes that satisfy the access criteria.

In some implementations, selectively propagating the augmented digital record may maintain confidentiality of the additional information included in the augmented digital record. For example, propagating the augmented digital record only to computing systems of nodes with security permissions satisfying the threshold can improve data integrity of the network graph data structure by preventing unauthorized updates to nodes outside the updated sequence of nodes. The data processing system can restrict propagation to authorized nodes, thereby preventing unauthorized parties from introducing erroneous and/or malicious modifications to the network graph data structure. By filtering recipient nodes based on verified permissions, the data processing system can ensure that only entities with appropriate authorization credentials can receive sensitive updates (e.g., augmented digital records associated with security permissions) and/or write corresponding changes to their local systems of record.

In some cases, propagating the augmented digital record to a computing system can involve cascading requests for updates to the network graph data structure. For example, the data processing system can transmit a request for additional data to complete task to a first computing device of a sub-graph data structure (e.g., a computing device of a node represented in the sub-graph data structure). The data processing system can receive the additional data in an augmented digital record. The data processing system can apply a set of rules of a model (e.g., a machine learning model) to the data of the digital record (e.g., the data represented in the digital record) and determine that additional data is needed from another node of the sub-graph data structure, which may be triggered by the additional data in the augmented digital record. The data processing system can identify another node in the sub-graph data structure (e.g., a new node that is missing the data) and transmit the augmented digital record to the newly identified node (e.g., a computing device of the newly identified node) with a request for the new data. The newly identified node can provide the data in a now twice-augmented digital record and transmit the twice-augmented digital record back to the data processing system. The data processing system can repeat this process any number of times (e.g., for nodes within the same sub-graph data structure) until determining no new updates are needed or the data of the network graph data structure is synchronized or complete. In this way, the data processing system can use the digital record to synchronize data across computing devices for the same sub-graph data structure without recursively processing all of the data of the network graph data structure to detect missing data.

In an example, a digital record may be associated with an electronic device networked item. The data processing system can transmit the digital record to a computing device operated by a circuit board manufacturer requesting country of origin certificates and compliance documentation for semiconductor components sourced from upstream suppliers. The circuit board manufacturer can receive the digital record, review a visual representation or nodes representing semiconductor foundries and component distributors, and attach additional information such as material declarations, conflict mineral certifications, or shipment tracking documents to specific nodes within the sub-graph data structure. The data processing system can receive the augmented digital record, update the node representing the circuit board manufacturer by linking the attached certificates to the node, and regenerate the visual representation to reflect the newly documented compliance information. The data processing system can identify downstream nodes representing final assembly facilities and regulatory agencies as recipients for propagation of the update. The data processing system can then transmit the augmented digital record across the communications network to computing systems operated by the final assembly facilities and regulatory agencies, triggering review workflows that allow the receiving parties to verify the semiconductor sourcing information and update their local systems of record accordingly.

In computing systems that generate visual representations of network graph data structures, additional technical challenges arise when information associated with one networked item is updated while other visual representations derived from related portions of the network remain unchanged. In particular, conventional systems often generate static or semi-static visualizations that represent a snapshot of a sub-graph at a point in time. When attributes of a node or edge are subsequently modified based on newly received information, other digital records or visual representations that depend on the same node or edge are not automatically refreshed. As a result, different users or systems may continue to interact with stale visual representations that no longer reflect the current state of the underlying network graph data structure.

These stale visual representations give rise to multiple technical deficiencies. Users may interact with outdated network paths, entity attributes, or relationship data, causing tasks and decisions to be executed against an inaccurate representation of network state and leading to inconsistent downstream processing. In addition, when overlapping sub-graphs are visualized across multiple digital records, conventional systems rely on manual synchronization or periodic refresh mechanisms to update each representation, introducing additional latency and computational overhead. Further, existing approaches do not provide automated techniques for determining which other networked items, profiles, or sub-graphs are impacted by an update to a given node or edge, resulting in fragmented updates and divergence of network state across distributed computing devices.

To address these deficiencies, the computing system can implement a regeneration workflow that dynamically updates visual representations responsive to modifications of the underlying network graph data structure. After receiving an augmented digital record that includes additional information for a node or edge, the computing system can update the corresponding node of the network graph data structure and regenerate a first visual representation included in the digital record based on the updated graph state. The regenerated visual representation can replace or supersede the prior representation such that the digital record reflects the current topology, attributes, and paths represented in the network graph.

In addition to regenerating the first visual representation, the computing system can identify other networked items or digital records that are related to the updated node. For example, the computing system can query the network graph data structure to identify additional profile nodes, sub-graph data structures, or paths that reference the updated node or include the updated edge as part of a chain of connected nodes. Based on this identification, the computing system can generate one or more second digital records, each comprising a second visual representation that is generated responsive to the update of the node in the network graph data structure.

Each second visual representation can reflect the updated node within the context of a different sub-graph, networked item instance, or operational path through the network. In some implementations, the computing system regenerates the second visual representation by re-evaluating path membership, recalculating derived attributes, or re-rendering visual elements such as node icons, edge connections, or annotations that depend on the updated information. The regenerated visual representations can then be transmitted to corresponding computing devices or written to associated systems of record, ensuring that all related digital records present a consistent and current view of the network.

By identifying related networked items and regenerating multiple visual representations in response to a single update, the described techniques maintain synchronization between the network graph data structure and distributed digital records that rely on visual sub-graphs. This regeneration mechanism prevents the persistence of stale visual representations, reduces redundant refresh operations, and ensures that users interact with accurate representations of network state. As a result, the computing system improves the reliability of task execution, coordination, and decision-making workflows that depend on graph-based visualizations across complex, multi-entity networks.

Referring now to FIG. 4D, illustrated is a block diagram depicting a system 446 for updating the network graph data structure 336 in a computer-networked environment using a visual representation of the network graph data structure 336. The system 446 can include a first computing device 304a, the data processing system 306, a second computing device 304b, a first digital record 404a, an augmented digital record 404b, a second digital record 438, additional information 436, and a request 442. The request 442 may be associated with the networked item profile 414. The first digital record 404a and the second digital record 438 may be associated with a node 448. The first digital record 404a may include the first visual representation 440. The second digital record 438 may include a second visual representation 444.

The system 446 can include the first computing device 304a that transmits the request 442 to complete a task and the second computing device 304b that uploads the additional information 436 associated with the request to complete the task. The first computing device 304a and the second computing device 304b may be the same or similar to the computing device 304 of FIG. 4A. For example, the first computing device 304a and the second computing device 304b may each be any client-side device. The first computing device 304a and the second computing device 304b may correspond to an entity (e.g., a node) within the network graph data structure 336. As an example, the first computing device 304a may correspond to a first node and the second computing device 304b may correspond to a second node of the network graph data structure 336. In this example, the first and second nodes may be connected. For example, the second node may be upstream (e.g., a supplier) of the first node, downstream (e.g., a distributor) of the first node, etc. The first computing device 304a and the second computing device 304b can be any type of device (e.g., tablet, laptop, etc.) that can transmit and receive data associated with the network graph data structure 336. In an example, the first computing device 304a may be a device associated with a first computing system (e.g., one of the computing systems 402 of FIG. 4A) corresponding to the first node. Similarly, the second computing device 304b may be a device associated with a second computing system corresponding to the second node. The computing systems serve as broader server infrastructures or cloud-based platforms that provide the technical environment and resources that can be used to process, store, and manage the data associated with respective nodes within the network graph data structure 336. In some examples, the first computing device 304a and the second computing device 304b can provide a graphical user interface that allows a user to interact with the network graph data structure 336. For example, the graphical user interface can allow a user of the second computing device 304b to select nodes or edges within the first visual representation 440 and attach data (e.g., files, documents, comments, attestations, etc.) as the additional information 436. As another example, the graphical user interface can allow a user of the first computing device 304a to transmit input indicating the request 442 to complete the task. In some examples, the first computing device 304a and the second computing device 304b can execute a web browser or dedicated application interface that communicates with the data processing system 306 to receive digital records, present visual representations, and transmit augmented records with attached information.

The request 442 can be a message transmitted from the computing device 304a to the data processing system 306 to create a task for gathering information associated with at least part of the network graph data structure 336. For example, the request 442 can be a request for more information associated with the networked item profile 414. The first computing device 304a can transmit the request 442 based on determining that the network graph data structure 336 does not satisfy a completion condition. The completion condition can include a defined set of fields, proof of compliance with one or more standards, etc. For example, based on determining that a node is associated with insufficient information to determine compliance with a regulatory standard, the first computing device 304a can transmit the request 442 for information that can be used to determine whether the node complies with the regulatory standard. The request 442 can be transmitted based on user input and/or as part of an automated workflow. The workflow may be triggered by detection of missing or outdated data in the network graph data structure 336. For example, the system may automatically generate and send a request for updated certification documents based on identifying a lapse in mandatory supplier compliance records. In some examples, the request 442 can include parameters. For example, the request 442 can include parameters identifying the networked item profile 414 and/or type of task associated with the networked item.

In an example, the request 442 may be associated with the node 448. For example, the request 442 may identify the networked item profile 414 corresponding to the node 448. As an example, if the networked item of the networked item profile 414 is an electronic device, the request 442 may be a request for more information about a component assembler corresponding to the node 448 that assembles components as part of manufacturing the electronic device. The data processing system 306 can parse the request 442 to extract task parameters, including identifiers of requested information, target nodes or edges, and recipient computing devices (e.g., the second computing device 304b). In some examples, the data processing system 306 may generate the first digital record 404a in response to receiving the request 442. For example, the request 442 can trigger the data processing system 306 to create the first digital record 404a by identifying the sub-graph data structure (e.g., the sub-graph data structure 406 of FIG. 4A) linked to the networked item and prepopulating fields with data extracted from the network graph data structure 336. In some examples, the first computing device 304a may transmit the request 442 via a network (e.g., the communications network 466 of FIG. 4A). For example, the request 442 can be transmitted across the network from the computing device 304a to the data processing system 306 in data packets including encoded instructions and parameters for dynamic creation of the first digital record 404a.

The request 442 can include a task corresponding to a networked item (e.g., of the networked item profile 414). A task may refer to a requested action associated with modifying the network graph data structure 336. For example, tasks can include gathering data, verifying compliance (e.g., via an attestation), or resolve an issue (e.g., conflicting data) related to the networked item within the network graph data structure. For example, a task may involve requesting documentation or attestations to confirm ethical sourcing or regulatory compliance. The networked item may be a product, shipment, component, or material moving through a multi-tier network represented by the network graph data structure. In some examples, the networked item may be represented by a node corresponding to the networked item and an entity associated with the networked item (e.g., a manufacturer of the networked item, etc.). As an example, a task corresponding to a networked item including an electronic device may be requesting a child labor-free compliance certification for semiconductor components used in assembly of the electronic device.

The first digital record 404a can be a data structure or file created by the data processing system 306. For example, digital records can represent digital passports that can be viewed by entities as an overview of relevant information within the network graph data structure. The first digital record 404a can be an initial set of graph-based data elements generated based on the request 442 received from the first computing device 304a. The data processing system 306 can generate the first digital record 404a by querying the network graph data structure 336 to identify one or more sub-graph data structures linked to a profile node for the networked item profile 414 specified in the request 442. The data processing system 306 can extract nodes and edges from the network graph data structure 336 that correspond to entities and relationships relevant to the task in the request 442. As an example, the data processing system 306 can prepopulate fields within the first digital record 404a using data extracted from the network graph data structure 336 and/or from a requester system of record maintained by the computing device 304a. The data processing system 306 can transmit the first digital record 404a to the computing device 304b via a network. The first digital record 404a may be transmitted with a request for the additional information 436 associated with specific nodes and/or edges within the sub-graph data structure 406.

The first digital record 404a may include the node 448. For example, the node 448 can be one of the nodes extracted from the network graph data structure 336 that correspond to the networked item profile 414. The node 448 may correspond to an entity that is the same or different from an entity corresponding to the second computing device 304b. In some examples, the node 448 may be associated with a plurality of digital records. As an example, the node 448 representing a semiconductor supplier may be linked to multiple digital records corresponding to various electronic devices in which its components are used. Based on updates to the first digital record 404a including the additional information 436, the system may generate updates to the other digital records that associated with the information included in the additional information 436. For example, the data processing system 306 can generate updates to the second digital record 438 that also includes the node 448 based on receiving the additional information 436 that includes an update to the node 448.

In some implementations, the data processing system 306 may generate the first visual representation 440 as part of the first digital record 404a. For example, the data processing system 306 can create the first visual representation 440 by extracting nodes and edges from the sub-graph data structure and rendering them as a graphical depiction. The first visual representation 440 can include node icons representing entities involved in manufacturing and distribution of the networked item and edge lines representing relationships or movements of items between the entities. As an example, the first visual representation 440 may depict at least one sub-graph data structure for an electronic device including node icons representing semiconductor foundries, component assemblers, testing facilities, and distributors, with edge lines illustrating the flow of components and products between these entities. In this example, a first node associated with a component assembler may be represented by a first node icon connected by an edge (e.g., line) to a second node icon associated with a testing facility. The data processing system 306 can configure the first visual representation 440 for display within a graphical user interface presented on the second computing device 304b. For example, the data processing system 306 can transmit instructions to the second computing device 304b that cause the first visual representation 440 to be rendered within the graphical user interface of the second computing device 304b. The first visual representation 440 can provide the responding party with a visual reference of the network context relevant to the request 442.

The second computing device 304b may generate the augmented digital record 404b based on appending the additional information 436 to the first digital record 404a. For example, the augmented digital record 404b may represent a modified version of the first digital record 404a that includes the additional information 436. The second computing device 304b may receive the first digital record 404a with an indication to complete the task associated with the request 442. In response, the second computing device 304b can complete the task by appending the additional information 436 to the first digital record 404a to generate the augmented digital record 404b. The second computing device 304b can display the first visual representation 440 included in the first digital record 404a through a graphical user interface. The user interface can present node icons and edge lines representing entities and relationships between the entities within the network graph data structure. A user at the second computing device 304b can interact with the displayed first visual representation 440 to attach the additional information 436 (e.g., documents, data, attestations, etc.) to specific nodes or edges. For example, the additional information 436 may correspond to the node 448. As an example, the additional information 436 can include an uploaded file corresponding to the node 448 (e.g., a child labor-free compliance certification for components supplied by the entity represented by node 448). The second computing device 304b can receive user input selecting a node icon corresponding to the node 448 within the first visual representation 440 and associating the additional information 436 with the selected node. The second computing device 304b can package the additional information 436 with the first digital record 404a to generate the augmented digital record 404b. The second computing device 304b can then transmit the augmented digital record 404b to the data processing system 306.

The data processing system 306 may generate the second digital record 438 based on the additional information 436. For example, the data processing system can query a database including a set of digital records (e.g., the memory 312 of FIG. 3A). The database may store a plurality of digital records to represent different portions of the network graph data structure 336. The digital records may correspond to various products, entities, or supply chain segments, enabling efficient access and updating of the specific records linked to the received information. The data processing system 306 can identify the second digital record 438 based on querying the database. The second digital record 438 may be a different digital record than the first digital record 404a. For example, the second digital record 438 and the first digital record 404a may be associated with different networked items. The first digital record 404a may be associated with the networked item profile 414 and the second digital record 438 may be associated with a networked item profile other than the networked item profile 414. As an example, if the networked item profile 414 represents a laptop computer, and the node 448 represents a manufacture of a solid state drive (e.g., an electrical component that uses integrated circuits to store data persistently), the first digital record 404a may represent a subset of the network graph data structure representing manufacturing of the laptop computer. The additional information 436 can include a file associated with manufacturing the solid state drive (e.g., a country of origin certificate, etc.). Based on updating the node 448 to include the file from the additional information 436, the data processing system 306 can query the database to determine that the second digital record 438 also includes the solid state drive. The second digital record 438 may represent a desktop computer in this example. The data processing system 306 can then update the second digital record 438 based on the update to the node 448 within the network graph data structure 336.

In some implementations, the data processing system 306 may generate updated visual representations based on updating the network graph data structure 336 based on the additional information 436. For example, the data processing system 306 may generate the second visual representation 444 based on the additional information 436 and identifying that the second digital record 438 corresponds to the node 448 (e.g., the updated node). As a result, a visual representation of both the first digital record 404a and the 438 may be updated based on the additional information 436. In an example where the additional information 436 includes an update to the node 448, such as the addition of a file corresponding to the node 448, the second visual representation 444 may be updated with an icon indicating the new file. In an example where the additional information 436 results in a new edge connection associated with the node 448, the second visual representation 444 may be updated to reflect the new edge connection. In some examples, the second visual representation 444 may be presented to one or more subscribed entities. For example, the second visual representation 444 may be transmitted to one or more computing systems (e.g., or devices of the computing systems) of entities associated with nodes of the first digital record 404a and/or the second digital record 438.

Conventional approaches to information collection and updating in networked environments often rely on static records or disconnected communication channels, resulting in delayed, inconsistent, or incomplete data synchronization across entities. A computing system implementing the systems and methods described herein can overcome the aforementioned technical deficiencies. For example, the computing system enhances collaborative data management by dynamically generating digital records with visual sub-graph representations corresponding to requested tasks, facilitating precise information requests tied to network positions, and enabling real-time updates and regeneration of visualizations. This approach improves the accuracy of data updates within the network graph data structure, supporting coordinated verification and decision-making across distributed parties. Furthermore, this approach can reduce computing resources associated with managing fragmented and disjointed states of the network graph, thereby improving the efficiency of data synchronization and update propagation across interconnected computing systems.

For instance, referring now to FIG. 4E, illustrated is a flow chart depicting a method 450 for updating a network graph data structure in a computer-networked environment using a visual representation of the network graph data structure. The method 450 can be executed, performed, or otherwise carried out by any of the computing systems or devices described herein, such as the data processing system 306 shown and described with reference to FIG. 3. The method 450 can include any number of operations, and the operations can be performed in any order. Each of the operations can be performed by the same computing device, or different computing devices can perform different operations of the method 450.

At operation 452, the method 450 can include receiving a request (e.g., the request 442 of FIG. 4D) to complete a task corresponding to a networked item (e.g., indicating the networked item profile 414 of FIG. 4B). For example, the data processing system can receive a request to complete the task from a first computing device (e.g., the computing device 304a of FIG. 4D). A networked item may be a component (e.g., product, material, shipment, etc.) moving through a multi-tier value chain network represented within a network graph data structure (e.g., the network graph data structure 336 of FIG. 4D). The task can be any data update activity associated with the networked item. For example, the task can include requests for additional data, data verification, compliance assessment, etc. In some examples, the data processing system may receive the request in response to user interaction with a graphical interface. For example, the graphical interface can display a set of possible issues within the network graph data structure (e.g., lack of country of origin, unusual edge connections, possible non-compliance, etc.). The first computing device may transmit the request in response to receiving user input via the graphical user interface. The data processing system can parse the request to extract parameters of the request. The parameters can include an identifier of the networked item, a type of task, an identification of requested information, one or more target nodes or entities to which the request is to be transmitted, etc. As an example of the request, the first computing device may request a child labor-free compliance certification for semiconductor components used in the assembly of an electronic device. In this example, the first computing device may transmit the request based on identifying missing or outdated compliance documentation during an assessment of a portion of the network graph data structure corresponding to the value chain for manufacturing the electronic device. By maintaining a network graph data structure and receiving requests associated with the network graph data structure, the data processing system can increase efficiency of updates to data associated with networked items. For example, the data processing system can link responses received to the request to a networked item indicated by the request. As a result, the data processing system can more efficiently manage data associated with the networked item across the network graph data structure. For example, the data processing system can reduce redundant data requests the networked item and rollback operations associated with out-of-date information.

In some implementations, the request may be a request to provide node attributes. For example, the data processing system can receive the request to complete the task from the first computing device as a request to provide additional node attributes corresponding to the networked item. The additional node attributes can include data fields associated with the networked item that are incomplete or require verification within the network graph data structure. For example, the additional node attributes can include country of origin designations, supplier certifications, manufacturing dates, material composition details, compliance status indicators, shipment tracking information, quality inspection results, etc. The first computing device can transmit the request based on identifying that one or more node attributes are missing from the networked item profile or that existing attribute values are outdated or insufficient for compliance verification. The data processing system can then transmit the digital record to the second computing device to request that the responding party provide values for the specified node attributes.

At operation 454, the method 450 can include creating a digital record (e.g., the first digital record 404a of FIG. 4D) that corresponds to the task. For example, the data processing system can generate a digital record including a first visual representation (e.g., the first visual representation 440 of FIG. 4D) of one or more sub-graph data structures (e.g., the sub-graph data structure 406 of FIG. 4D) of a network graph data structure (e.g., the network graph data structure 336 of FIG. 4D). The digital record may be generated in response to receiving the request from the first computing device. Each sub-graph data structure may be linked to a node of a profile (e.g., the networked item profile 414 of FIG. 4B) of the networked item. Each sub-graph data structure may include a chain of nodes (e.g., the nodes 418 of FIG. 4B) comprising a sequence of connected nodes forming a path of one or more instances of the networked item from a source node to a destination node. A source node may refer to an origin entity (e.g., supplier) from which components of the networked item initially enter the value chain within a sub-graph data structure. A destination node may refer to the final entity (e.g., consumer) in the chain that ultimately receives or utilizes the networked item within the sub-graph data structure. The sequence of connected nodes can form a path of one or more instances of the networked item from the source node to the destination node.

In some examples, the path may represent network operations of the instances of the networked item through the sequence of connected nodes. Network operations may refer to activities involved in manufacturing and distribution of the networked item. As an example, the path may depict the processing steps for an electronic device as a chain of nodes associated with manufacturing and distributing the device moves from component manufacturing, through assembly and testing, to final distribution. In some examples, each node of the sequence of nodes may represent an entity performing a network operation on the one or more instances of the networked item. For example, each node may represent an entity (e.g., manufacturer, assembler, distributor, etc.) that executes an operation within a portion of the network graph data structure corresponding to the networked item. Instances of the networked item may refer to nodes associated with a path of the networked item. For example, an instance of the networked item may represent the networked item at any point within the path. As an example, if the networked item is an electronic device, a first instance may be initial components, a second instance may be assembled circuit boards, etc. In some examples, an edge between a pair of nodes in the sequence of nodes may represent movement of the networked item from one node of the pair of nodes to the other node of the pair of nodes. For example, edges may represent progression within the sequence of nodes representing entities. As an example, an edge may represent movement of the components at an entity corresponding to a component manufacturing facility represented by a first node to an entity corresponding to a component assembly facility represented by a second node. The edge may therefore represent movement of the instances of the networked item within the path from the source node to the destination node.

In some implementations, the digital record may be created based on a set of sub-graph data structures associated with the networked item. For example, the data processing system can create the digital record responsive to receiving the request by querying the sub-graph data structure for any nodes that correspond to profiles and contain a matching identifier to the networked item. The data processing system can identify the node of the profile for the networked item based on the query results. The data processing system can then identify the one or more sub-graph data structures based on the links of each sub-graph data structure with the node of the profile for the networked item. The data processing system can dynamically create the digital record based on the identified one or more sub-graph data structures by extracting the relevant nodes and edges from the network graph data structure. As an example, the data processing system can query the network graph to identify nodes representing semiconductor component manufacturers, assembly plants, and testing facilities linked to a profile for a specific electronic device. The data processing system can then extract these nodes and the edges representing supply and manufacturing relationships to dynamically create a digital record that reflects the relevant sub-graph associated with the electronic device.

At operation 456, the method 450 can include transmitting the digital record (e.g., the first digital record 404a of FIG. 4D) with a request for additional information. For example, the data processing system can transmit the digital record (e.g., the first digital record 404a of FIG. 4D) with the request to a second computing device (e.g., the second computing device 304b of FIG. 4D). The second computing device may correspond to at least one entity of a node of the network of nodes. For example, the second device may correspond to an entity involved in the path of the instances of the networked item. As an example, if the request is a request to provide updated compliance documentation, the data processing system may identify that the second computing device corresponds to the task of supplying such documentation associated with the request. The request for additional information may be any request for data associated with the sequence of nodes associated with the networked item. For example, the request for additional information can be a request for country of origin certificates, supplier attestations, manufacturing process details, environmental compliance reports, etc.

In some implementations, the data processing system may transmit the digital record via a communication network to the second computing device based on an address of the second computing device. For example, the data processing system can identify an address of the second computing device from the node included in the sequence of nodes. The address can be a network address such as an internet protocol address, a media access control address, or another network identifier associated with the second computing device. The data processing system can retrieve the address from metadata or attributes stored in association with the node within the network graph data structure. In some examples. the data processing system can generate a set of data packets that include the digital record. In these examples, the data processing system can include the address in a header of each data packet of the set of data packets. The data processing system can then transmit the set of data packets to the second computing device across the communications network. The communications network can route the data packets to the second computing device based on the address included in the packet headers. The second computing device can receive the data packets and reassemble the digital record for presentation or further processing by the responding party.

At operation 458, the method 450 can include receiving an augmented digital record (e.g., the augmented digital record 404b) updated with the additional information (e.g., the additional information 436 of FIG. 4D). For example, the data processing system can receive the augmented digital record as a response to the request for additional information. The second computing device can package the additional information 436 with the first digital record by appending metadata, file attachments, and/or node or edge association identifiers to generate the augmented digital record. The additional information can include any data associated with the requested task. For example, the additional information can include documents such as country of origin certificates, bills of material, purchase orders, commercial invoices, compliance attestations, environmental data, labor certifications, quality inspection reports, and/or supplier identification records associated with specific nodes or edges within the sub-graph data structure. As an example, if the requested task is requesting a country of origin certification to verify compliance with international sanctions, the additional information may include official documents confirming the geographic origin of semiconductor components used in electronic devices.

In some implementations, the digital record may include a graphical depiction including icons representing nodes and the augmented digital record may include a selection of one of the nodes along with input of a file corresponding to the selected node. For example, the data processing system can generate the digital record to include the first visual representation of the one or more sub-graph data structures as a graphical depiction including icons representing one or more nodes of each of the one or more sub-graph data structures. The graphical depiction can present the nodes as selectable visual elements that allow users to interact with specific entities within the network graph data structure. For example, a user of the second computing device can select one of the nodes based on transmitting pointer input associated with an icon representing the node. The data processing system can receive the augmented digital record responsive to a selection of an icon corresponding to the node of the network graph data structure and an input of a file identifying an entity represented by the node. In some examples, the second computing device can display the graphical depiction through a user interface that allows a user to select a node icon and associate a file with the selected node to complete the information request. As an example, a user at the computing device can select an icon representing a semiconductor supplier node and attach a country of origin certificate file to that node, thereby creating the augmented digital record that links the uploaded documentation directly to the node within the network graph data structure corresponding to the relevant entity.

At operation 460, the method 450 can include updating a node of the network graph data structure and regenerating the first visual representation. For example, the data processing system can modify the network graph data structure based on the additional information provided by the second computing device and then regenerate the first visual representation to create an updated version of the first visual representation that reflects the update to the network graph data structure. In some examples, the data processing system can update the node based on acceptance of the additional information. For example, the data processing system may present the additional information to an associated computing device for verification. In response to receiving the verification from the associated computing device, the data processing system can modify the network graph data structure based on the additional information. As an example, the data processing system can update the node after the requesting party (e.g., the first computing device selects an accept option from a user interface displaying the additional information and/or the second visual representation. Receiving the acceptance from the first computing device may trigger the write operation to the system of record (e.g., the system of record 338 of FIG. 3A) of the data processing system and the network graph data structure. In some examples, the data processing system can write the received information into a local system of record (e.g., the system of record 464 of FIG. 4A) of the first computing device, the second computing device, and/or any computing device associated with the network graph data structure in response to updating the node, thereby updating both the local system and the shared network graph data structure.

In some implementations, the data processing system can update the network graph data structure by linking a file transmitted by the second computing device as part of the additional information to the node of the network graph data structure. The data processing system can receive the file as an attachment within the augmented digital record. The file can include any document associated with the node. For example, the file can include certificates, attestations, compliance reports, etc. In some examples, the data processing system can store the file in a storage repository (e.g., the memory 312 of FIG. 3A) associated with the network graph data structure. The data processing system can then create a reference (e.g., unique file identifier, pointer, storage location, etc.) linking the stored file to the node by inserting a file identifier into a field-value pair of the node. The file identifier can include a storage location path, a unique file identifier, and/or a pointer to the file in the storage repository. The file identifier can allow subsequent retrieval of the file when the node is accessed or displayed. The data processing system can update metadata of the node to reflect the presence of the linked file. The metadata can include file type, upload timestamp, source identifier, and/or file description. In some examples, the linked file can be displayed as an attachment indicator when the node is rendered in a visual representation. The attachment indicator can include an icon representing the file type and/or a selectable element that opens the file for viewing.

In some implementations, the data processing system may update the network graph data structure by inserting a value into a field-value pair of the node. For example, the data processing system can identify a field associated with the node that corresponds to the additional information received in the augmented digital record. The field can be a metadata attribute (e.g., country of origin, compliance status, certification date, supplier identifier, etc.) that describes characteristics of the entity represented by the node. The data processing system can extract a value from the additional information and insert the extracted value into the field-value pair by writing the value to the corresponding field. For example, if the additional information includes a country of origin certificate indicating that semiconductor components originate from a specific country, the data processing system can extract the country name from the certificate and insert the country name as a value into a country of origin field associated with the semiconductor supplier node. The insertion of the value into the field-value pair can update the node attributes within the network graph data structure to reflect the newly provided information. In some examples, the updated field-value pair can be stored in a database that maintains the network graph data structure (e.g., the memory 312 of FIG. 3A).

At operation 462, the method 450 can include generating a second digital record (e.g., the second digital record 438 of FIG. 4D) including a second visual representation. For example, the data processing system can identify a second networked item (e.g., a networked item that is different from the networked item corresponding to the digital record included in the request for the additional information) that is associated with the additional information. The networked item can be associated with a shared node with the first digital record, a shared edge with the first digital record, etc. The data processing system can then generate the second digital record in response to updating the node of the network graph data structure (e.g., the node 448 of FIG. 4D). The second digital record may be a revised digital passport that reflects the accepted changes to nodes or edges (e.g., generated based on the additional information). In some examples, the data processing system can generate the second digital record in response to a requesting party (e.g., an entity associated with the first computing device) accepting the update to the node of the network graph data structure. For example, the data processing system can transmit the second visual representation and/or the additional information to the requesting party (e.g., to the first computing device and/or another device of an entity associated with the first computing device). The data processing system can then receive an indication of acceptance or non-acceptance of the update to the node of the network graph generated at operation 460. In some examples, the data processing system can generate the second digital record in response to the requesting party transmitting an indication to publish the update to the node of the network graph data structure. For example, the first computing device may transmit an instruction for publication of the update to the node. The data processing system can then generate the second digital record. In some examples, the data processing system may propagate the second digital record based on generating the second digital record. For example, the data processing system can propagate the second digital record to computing systems associated with the sequence of connected nodes of the digital record. The computing systems may update local systems of record based on the second digital record. Systems of records may refer to repositories or databases that store authoritative and current information associated with the network graph data structure. The data processing system may include a system of record (e.g., the system of record 338). Each of the computing systems may include a local system of record that is a local repository or database maintained by the computing system for storing authoritative information associated with the network graph data structure. In some examples, the data processing system may update the system of record based on the second digital record and then propagate the update to the local systems of records of the computing systems in response to the update to the system of record.

By implementing the systems and methods described herein, the data processing system can increase the efficiency of maintaining and synchronizing data records associated with networked items by generating the second digital record based on receiving the additional information. For example, by determining other digital records that should be updated based on information added to a first digital record, the system can automatically propagate corresponding updates across related digital records without separate reentry of the same information in the related digital records. The network graph data structure may allow the data processing system to efficiently identify related nodes, sub-graph data structures, and corresponding digital records affected by the received additional information. The data processing system can therefore reduce processing overhead associated with redundant data entry and/or record reconciliation by generating the second digital record based on updating the first digital record.

In some implementations, the second digital record may be a revised version of an existing digital record (e.g., other than the digital record included in the request for the additional information) that is associated with the additional information. For example, the data processing system can query a database comprising identifications of a plurality of digital records. In this example, each digital record may correspond to a portion of the network graph data structure. The data processing system can execute the query to search for digital records associated with nodes or edges associated with the update to the node of the network graph data structure. For example, the data processing system can execute the query to search for digital records associate with nodes that are connected to the updated node (e.g., via an edge). The data processing system can determine that a third digital record corresponds to the updated node based on the query results. The third digital record can be an existing digital record that includes the node or is linked to entities, products, or shipments associated with the updated node. The data processing system can revise the third digital record into the second digital record based on the update to the node of the network graph data structure. The revision can include inserting new field values, linking additional documents, modifying node attributes, adding new edges, or regenerating the visual representation to reflect the accepted information from the augmented digital record. In some examples, the data processing system can identify multiple existing digital records through the database query and revise each identified digital record to propagate the update across related portions of the network graph data structure. As an example, if the digital record is associated with an electronic device assembly process, the data processing system may identify an associated digital record linked to a semiconductor component supplier (e.g., the third digital record) to modify (e.g., into the second digital record) based on additional information that includes newly established connections or updated compliance certifications affecting the relationships between components and assembly stages.

In some implementations, the data processing system may revise digital records by appending files. For example, the data processing system can identify an instance of an entity associated with the node corresponding to the additional information. The additional information can include a file identifying the entity represented by the node. The data processing system can append the file to a third digital record to generate the second digital record. The third digital record can be an existing digital record that includes the node or is linked to the node within the network graph data structure. The data processing system can modify the third digital record by attaching the file as supplemental documentation associated with the node. The appended file can include certificates, attestations, compliance documents, or other evidentiary materials that provide context or verification for the entity represented by the node. The data processing system can generate the second digital record by incorporating the appended file into the structure of the third digital record. The second digital record can then be propagated to downstream computing systems to communicate the updated information across the network.

In some implementations, the first and/or second visual representations may be generated as two-dimensional renderings of sub-graph data structures. For example, the data processing system can create the first visual representation and generate the second visual representation as dynamic, computer-generated two-dimensional renderings of at least one of the one or more sub-graph data structures. A two-dimensional rendering of sub-graph data structures may refer to a graphical depiction displayed on a planar surface (e.g., a user interface of a computing device). The two-dimensional renderings can include node icons and edge lines representing entities and relationships within the network graph data structure. The data processing system can configure the two-dimensional renderings for display within a viewport of a graphical user interface. The viewport can be a bounded display area within a web browser window, desktop application interface, and/or mobile application screen of a computing device. In some examples, users may view and/or interact with the visual representations via the viewport. In an example, the data processing system can scale the node icons and edge lines to fit within the viewport dimensions while maintaining readability and interactive functionality. In some examples, the graphical user interface can allow users to pan, zoom, or otherwise navigate the two-dimensional rendering to explore different portions of the sub-graph data structure. As an example, the first visual representation can display a sub-graph data structure for an electronic device as a two-dimensional network diagram with circular node icons representing semiconductor foundries, assembly plants, and distribution centers, connected by directional edge lines indicating the flow of components through the manufacturing process, rendered within a scrollable viewport that allows users to examine upstream supplier relationships and downstream distribution pathways interactively.

As a nonlimiting example, the digital record may be associated with an electronic device. The data processing system can receive a request from a first computing device operated by a smartphone manufacturer to complete a task requesting verification of ethical sourcing for lithium-ion battery cells used in the manufacturer's devices. The data processing system can create a digital record corresponding to the task by querying the network graph data structure to identify sub-graph data structures linked to a profile node for the smartphone product. The data processing system can extract nodes representing upstream battery cell suppliers, lithium mining operations, cobalt refineries, and cathode material producers, along with edges representing procurement relationships and material flows between these entities. The data processing system can generate a first visual representation of the sub-graph data structures as a graphical depiction showing node icons for each entity connected by edge lines illustrating the path of nodes from raw material extraction through battery cell assembly. The data processing system can prepopulate the digital record with existing data from the network graph data structure, including supplier identifications, facility locations, and previously documented shipment records. The data processing system can transmit the digital record to a second computing device operated by a battery cell manufacturer with a request for additional information (e.g., conflict mineral certifications, child labor compliance attestations, mine-site audit reports, etc.) for upstream cobalt suppliers.

The battery cell manufacturer can receive the digital record and display the first visual representation through a graphical user interface. A user at the second computing device can interact with the displayed visual representation by selecting a node icon representing a cobalt refinery and attaching additional information such as a responsible sourcing certificate and third-party audit documentation to the selected node. The second computing device can transmit an augmented digital record updated with the attached certificates back to the data processing system. The data processing system can receive the augmented digital record and update the node representing the cobalt refinery within the network graph data structure by linking the received certificates to the node and inserting verification status values into field-value pairs of the node. The data processing system can regenerate the first visual representation to reflect the updated node with visual indicators showing that compliance documentation has been attached and verified.

In some examples, the data processing system can generate a second digital record comprising the second visual representation and the newly documented compliance information based on the update to the node. As an example, the data processing system can determine that a second networked item, a laptop, is also manufactured using the cobalt from the cobalt refinery associated with the additional information. The data processing system can then generate a second digital record based on the additional information and/or retrieve an existing third digital record and modify the third digital record based on the additional information to generate the second digital record. The data processing system can generate a second visual representation of the second digital record that indicates the additional information (e.g., includes an icon indicating the uploaded files).

In some implementations, the data processing system can identify downstream nodes representing final assembly facilities operated by the smartphone manufacturer, the laptop manufacturer, and/or regulatory agencies responsible for conflict mineral oversight as recipients for propagation of the update. The data processing system can transmit the first and/or second digital records across the communications network to computing systems of entities corresponding to nodes of the respective digital records. The first and second digital records can trigger review workflows that allow these receiving parties to verify the ethical sourcing information for the lithium-ion battery cells and update their local systems of record to reflect the confirmed compliance status of the upstream cobalt.

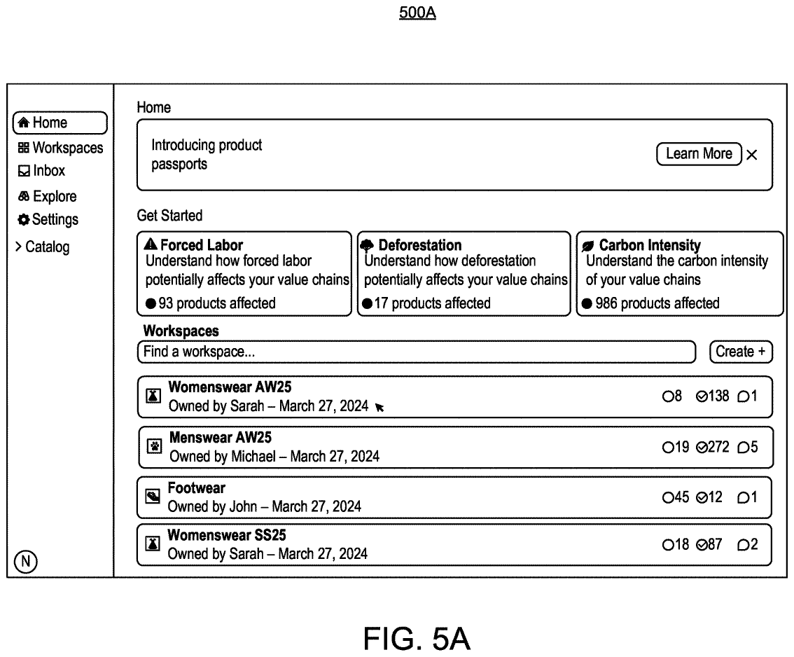

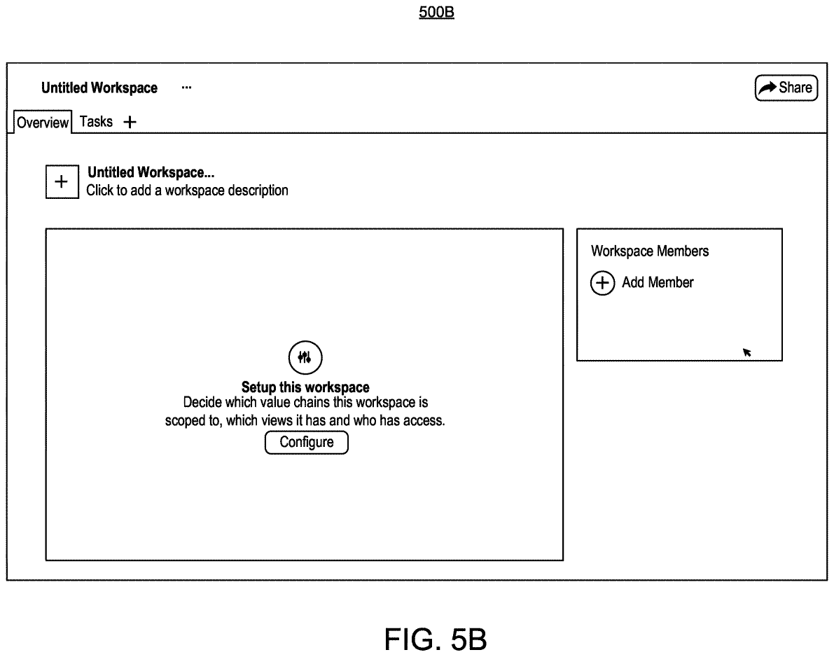

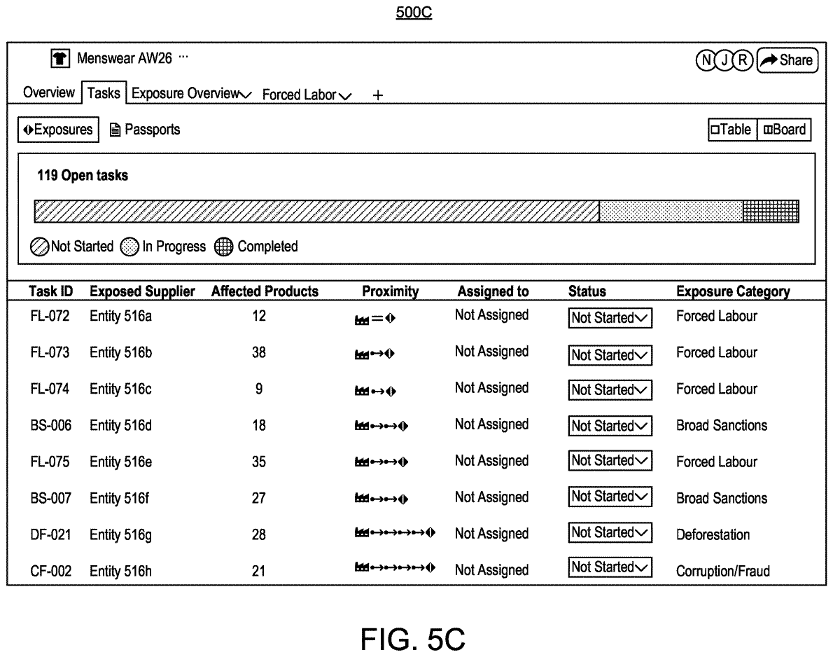

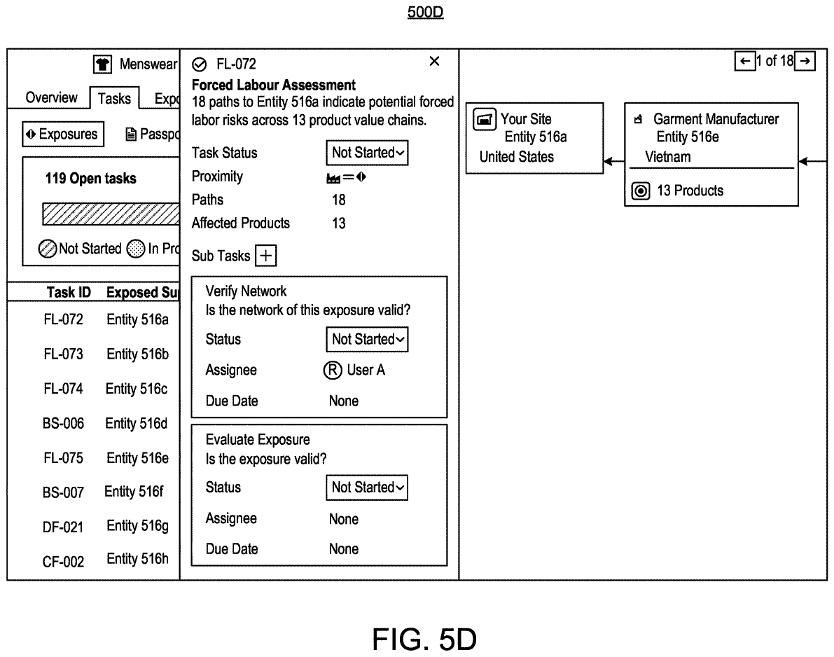

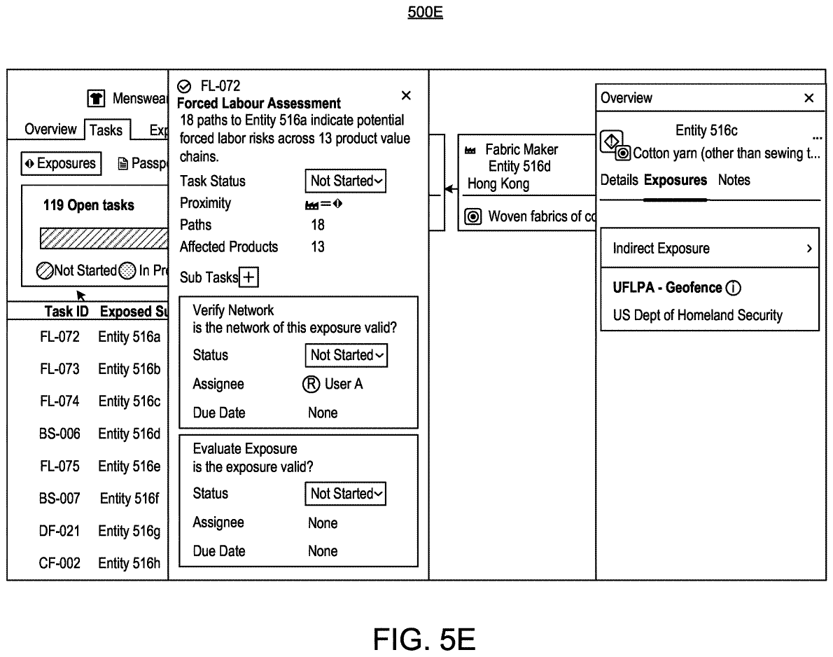

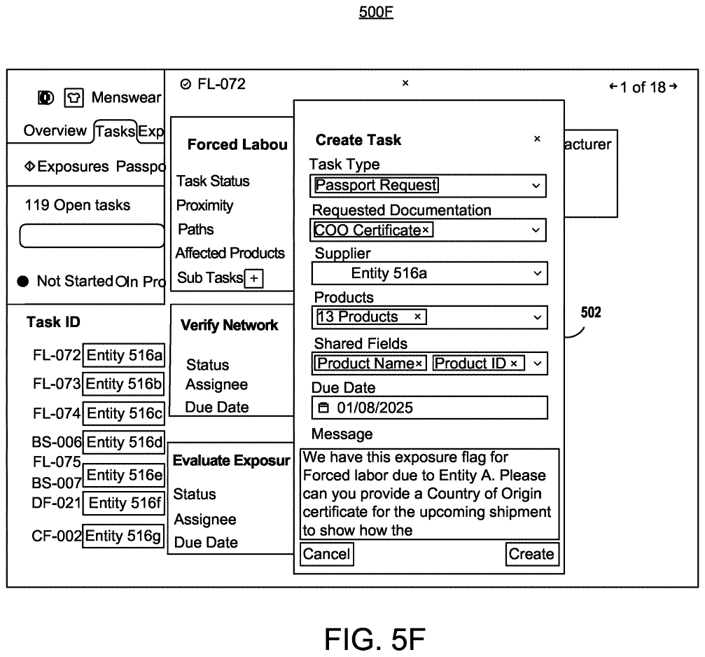

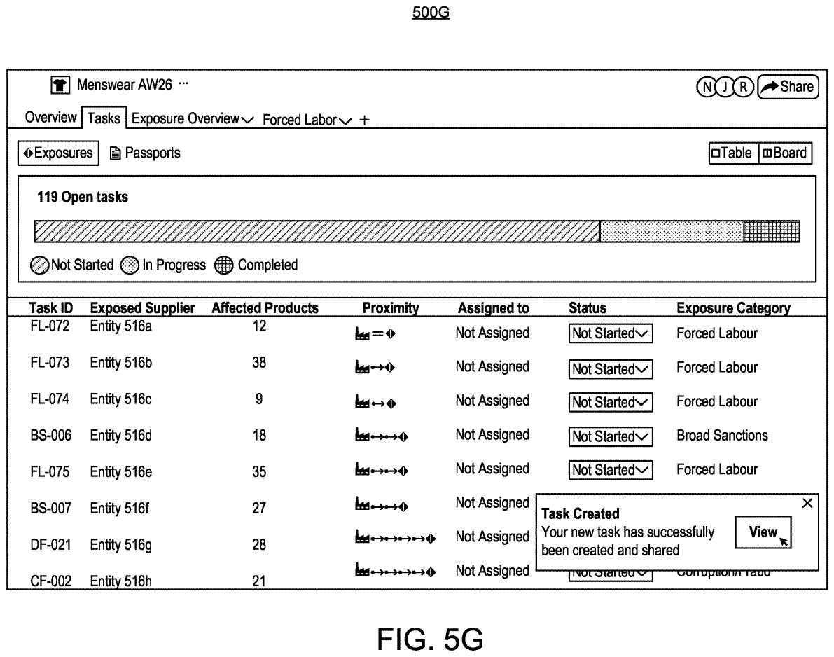

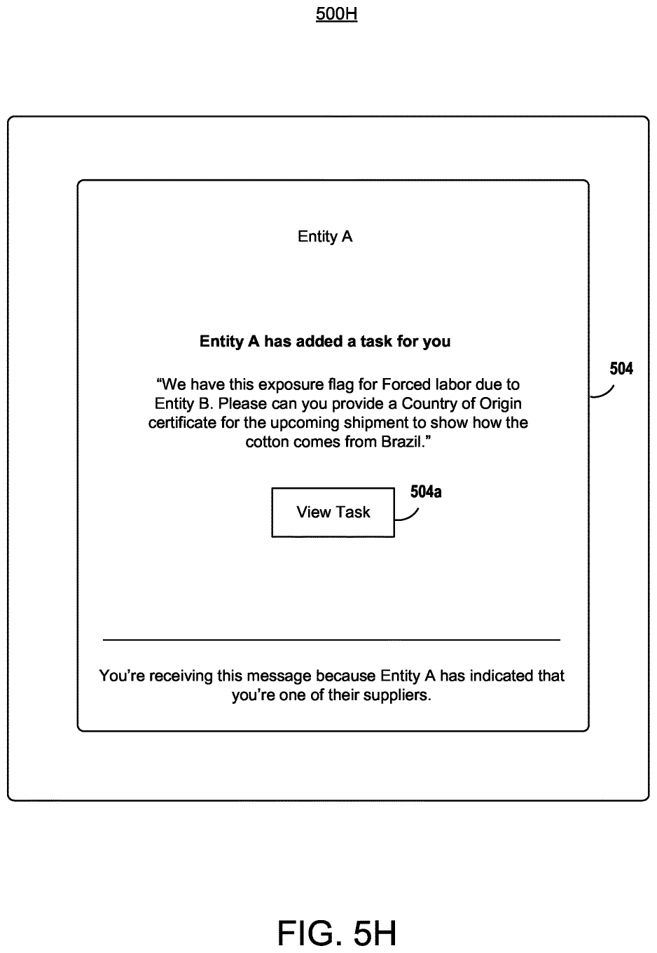

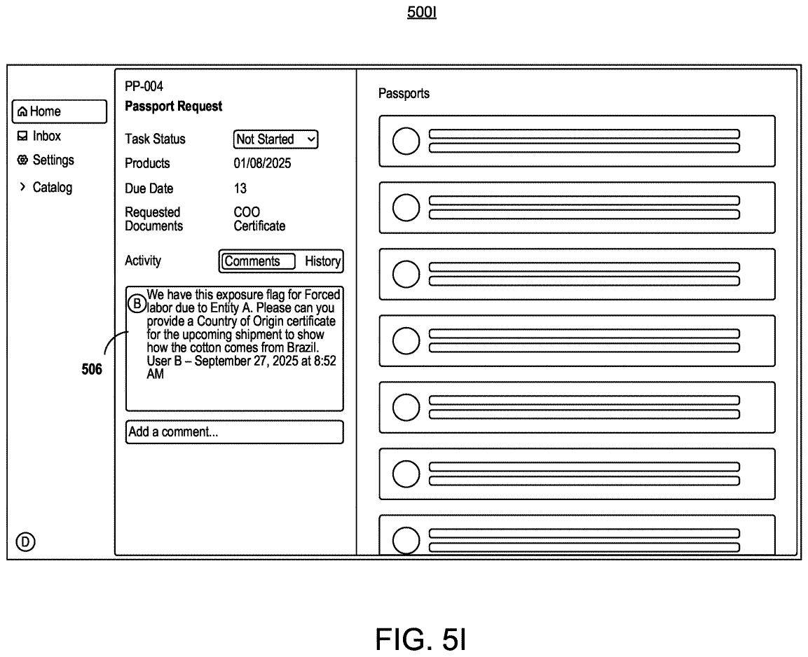

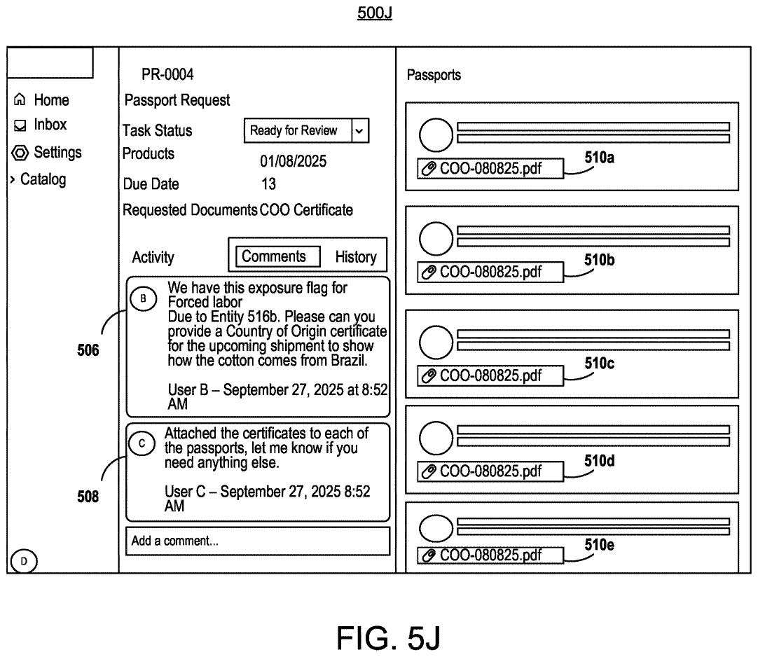

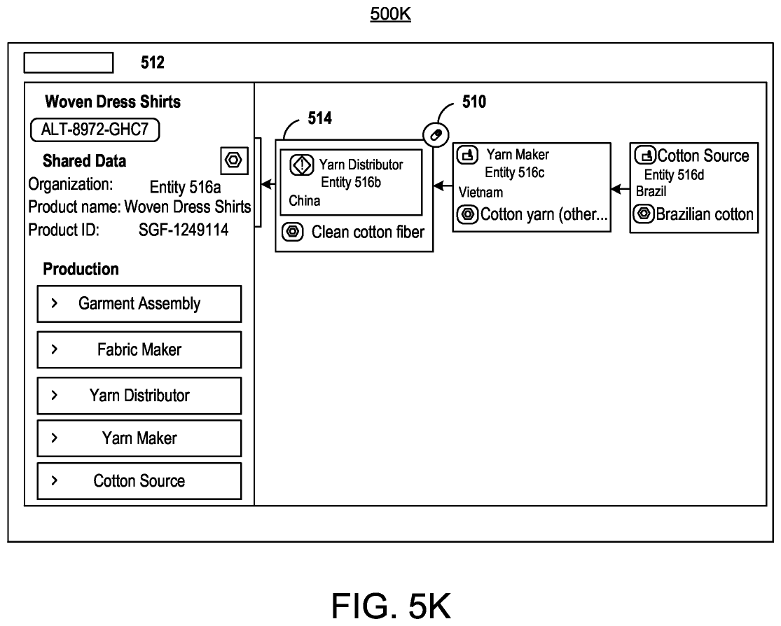

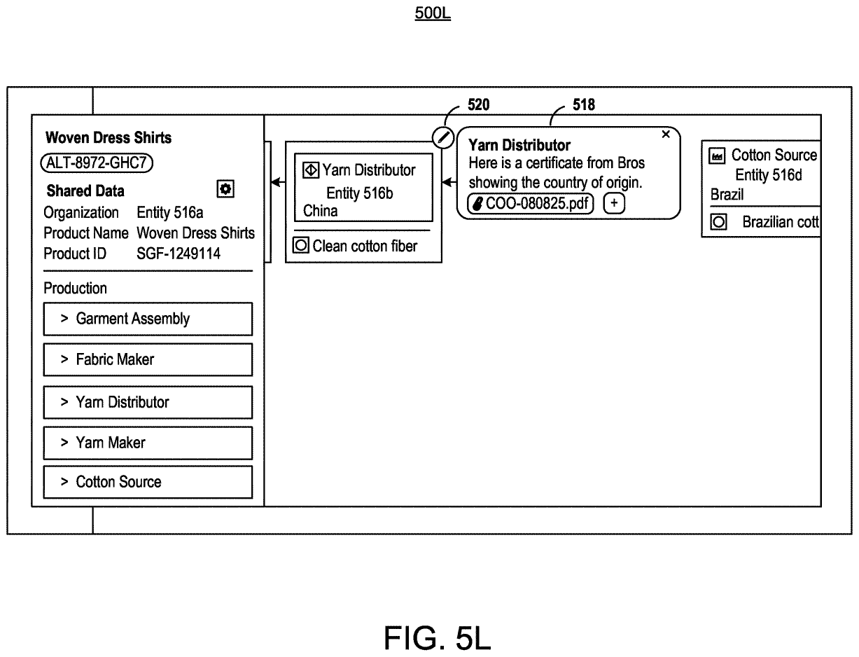

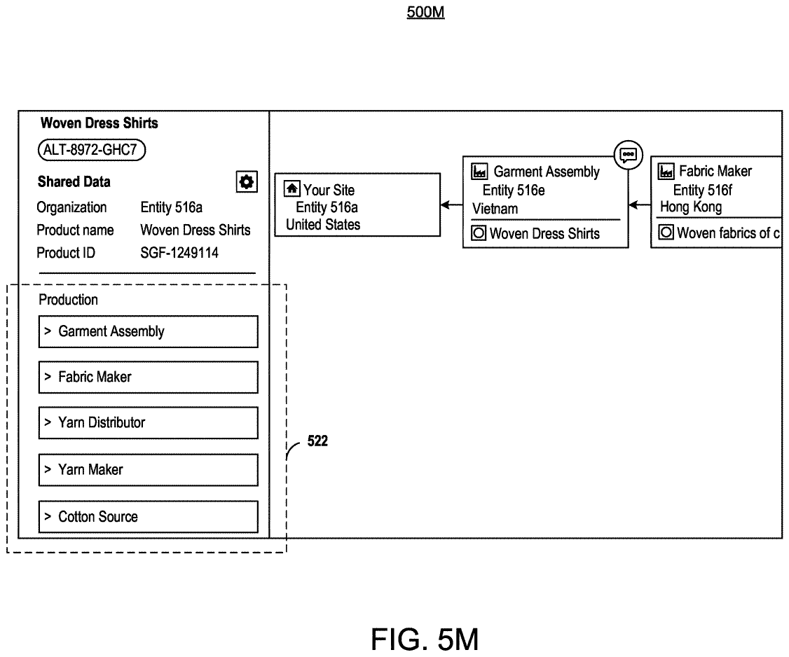

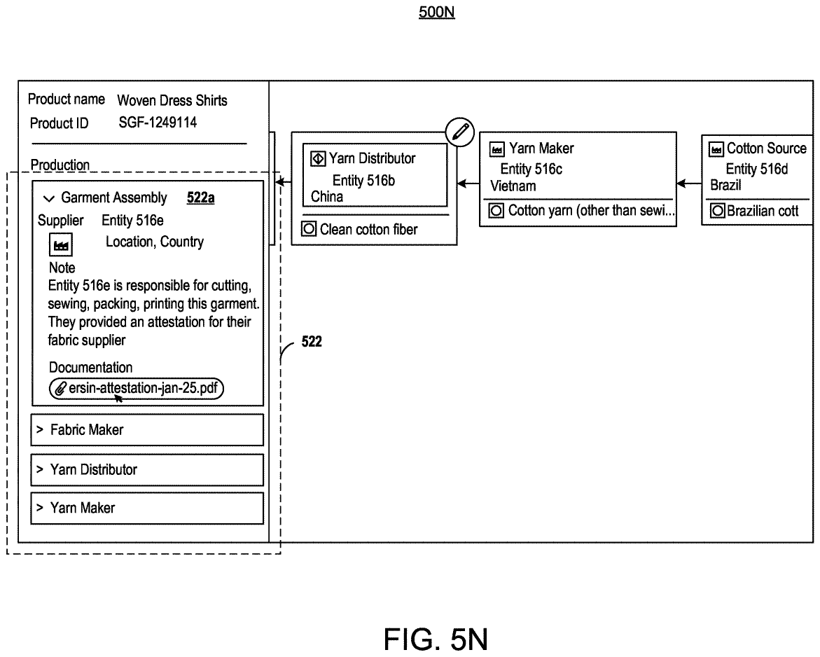

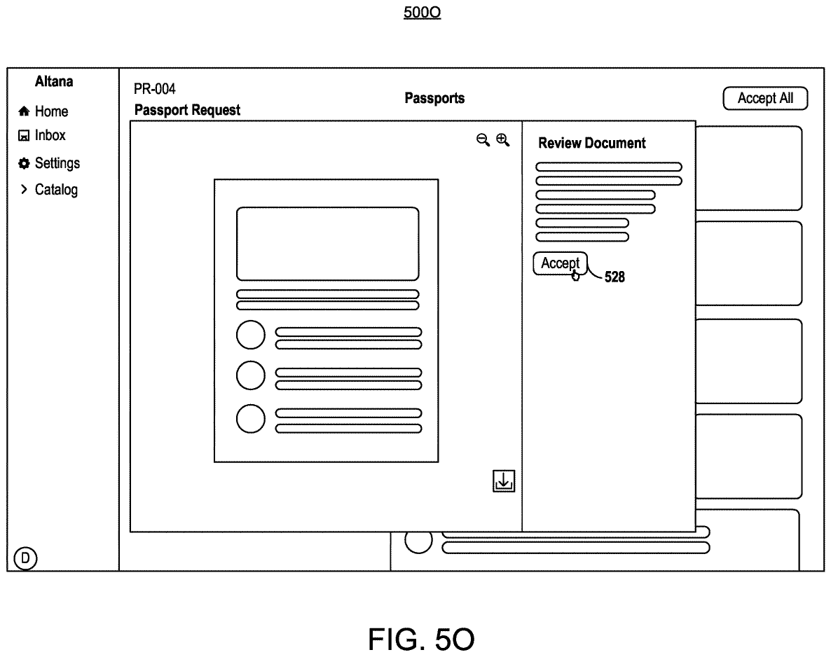

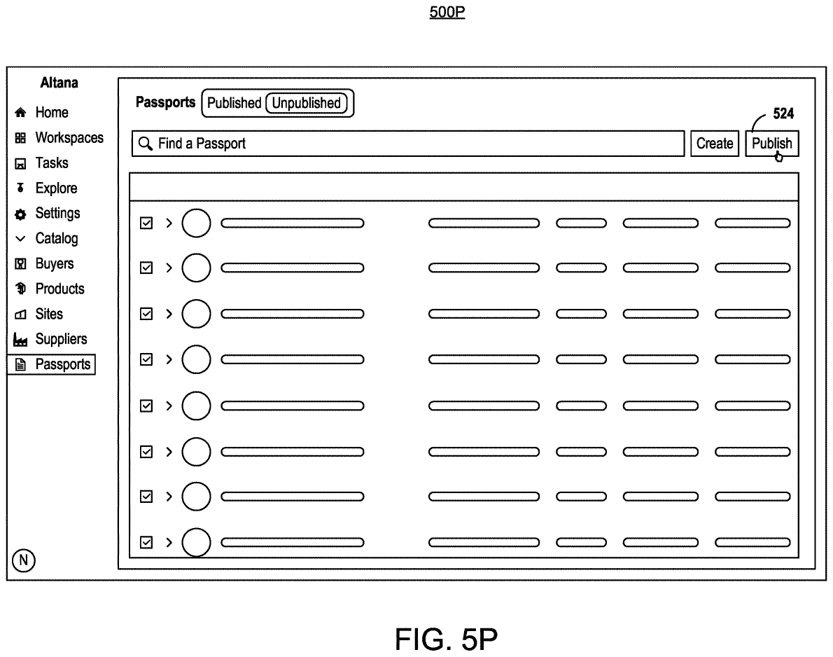

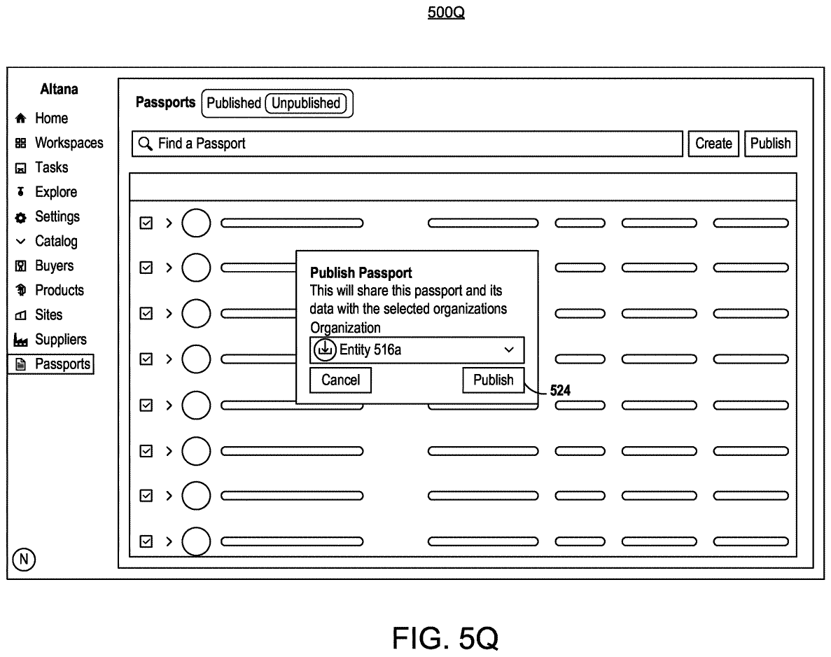

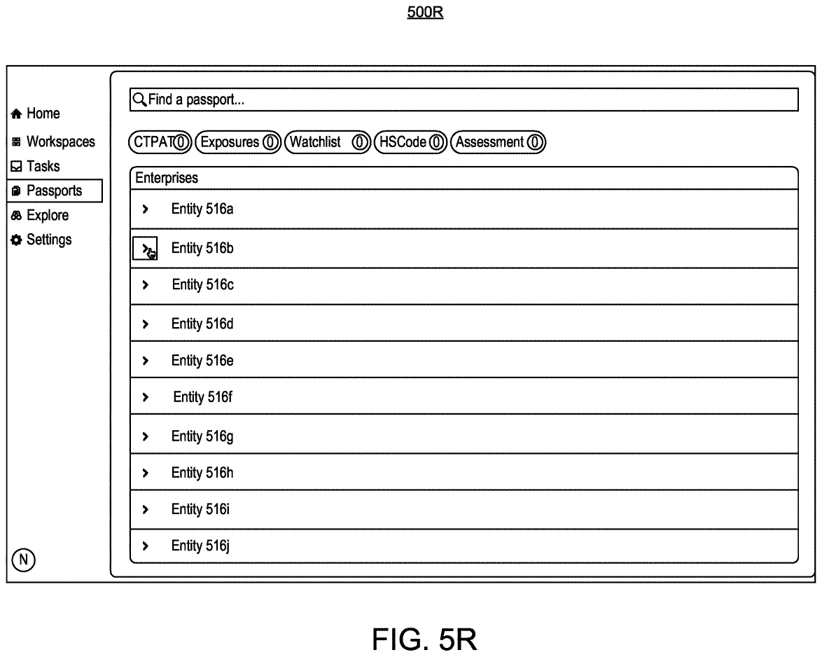

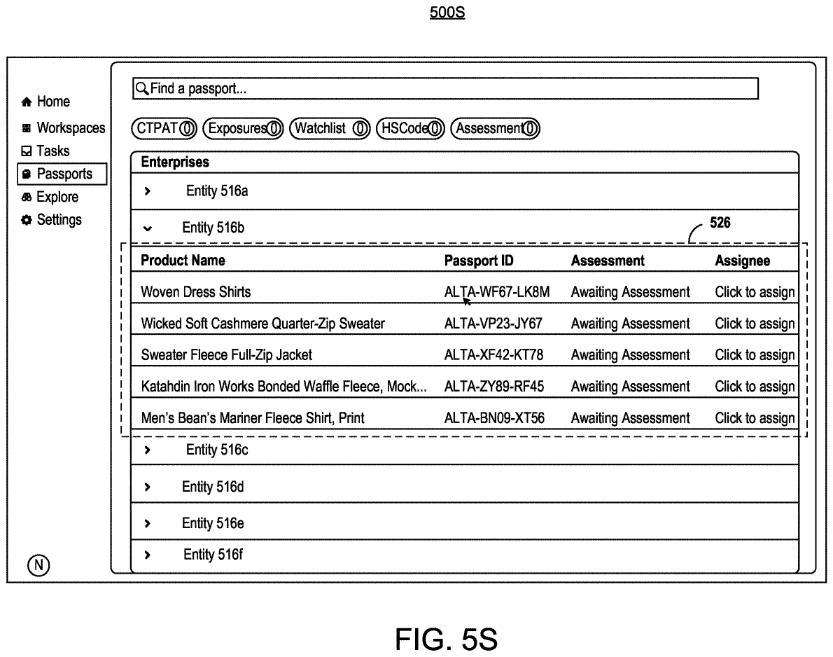

Referring now to FIGS. 5A-5S, illustrated is a set of user interfaces for task management and digital record creation associated with a network graph data structure. A data processing system (e.g., the data processing system 306 of FIG. 3A) can cause presentation of user interface 500A-500S (collectively user interfaces 500) on at least one computing device (e.g., the computing device 304 of FIG. 3A). Based on interactions with the user interfaces 500, a user can transmit requests to complete tasks, receive digital records comprising requests to complete tasks, view visual representations of sub-graph data structures of a network graph data structure (e.g., the network graph data structure 336 of FIG. 3A), etc.

As illustrated in FIG. 5A, the user interface 500A associated with networked items and tasks corresponding to the networked items may be displayed at a computing device (e.g., the first computing device 304a of FIG. 4D). For example, the computing device may display data generated based on the networked graph data structure. As an example, by navigating to the “Forced Labor” section, the computing device may view data corresponding to possible forced labor associated various networked items. The system may determine, based on the network graph data structure, that a node in the sequence of nodes corresponding to a networked item may be associated with forced labor. As an example, if the networked item is an electronic device, the system may identify that a node corresponding to a mineral used to manufacture the electronic device may be associated with forced labor based on data uploaded (e.g., by other computing devices associated with other nodes) to the network graph data structure.

As illustrated in FIG. 5B, the user interface 500B may display a workspace. The workspace may correspond to one or more networked items. For example, the computing device may be associated with an entity. The entity may correspond (e.g., may manufacturer, distribute, and/or the like) a plurality of networked items. The workspace can correspond to a subset of networked items. In some examples, the computing device may execute operations (e.g., upload data, request tasks, and/or the like) associated with networked items via the workspace.

As illustrated in FIG. 5C, the user interface 500C may display entities that are affected by tasks submitted by the computing device. For example, the graphical user interface may include tasks associated with entities 516a-516h. The computing device can submit tasks (e.g., requests for data, compliance verification, and/or the like). The tasks may affect one or more nodes in the network graph data structure. The user interface 500C can indicate which entities (e.g., corresponding to nodes of the network graph data structure) are affected and how close the affected entities are to a primary node associated with the task. Proximity to the node may be measured by how nodes a given node is separated from the primary node by.

As illustrated in FIG. 5D, the user interface 500D may display a task. In an example, the task (e.g., task “FL-072”) may be submitted by the computing device that the user interface 500D is displayed at. The computing device may be associated with the entity 516a. In an example, the task may be submitted by another computing device corresponding to another entity. In response to the system receiving a request for a task that is within a threshold distance (e.g., is within a threshold proximity of nodes) the entity 516a, the system may generate a notification and/or render an interface element depicting data associated with the task. As an example, based on determining that the task is associated with the entity 516a, and the entity 516a is within a threshold proximity of the entity 516a (e.g., is within ten nodes in a sequence of nodes included in the network graph data structure), the system may cause the user interface 500D to be displayed at the computing device of the entity 516a.

As illustrated in FIG. 5E, the user interface 500E may display further information about entities associated with the task. For example, the entity 516c may represent a node in a sequence of nodes corresponding to the networked item that is affected by the task. In this example, the entity 516c may be indirectly affected by the task (e.g., may receive notification of updated information, but may not be associated with a request for information). In some examples, the computing device can select to view how each node within the sequence of nodes is affected by the task. For example, in response to receiving a selection of the entity 516b associated with the task “FL-072,” the system can display associated data (e.g., proximity to a primary node of the task, exposure, notes uploaded by a computing device associated with the entity 516b, and/or the like).

As illustrated in FIG. 5F, the computing device may transmit a request via the user interface 500F. For example, based on transmitting input associated with a task request element 502 of the user interface 500F, a first computing device (e.g., the first computing device 304a of FIG. 4D) can transmit a request to complete a task corresponding to a networked item to a data processing system. As illustrated in FIG. 5F, the task may be a request for a file (e.g., a country of origin certificate). The request can include a set of parameters (e.g., requested documentation, due date, etc.). In some examples, the request may indicate an entity associated with the request (e.g., the entity 516a). Based on identifying the entity indicated in the request, the data processing system can transmit the request to the indicated entity. For example, the data processing system can transmit the request to a second computing device (e.g., the second computing device 304b of FIG. 4D) of a computing system associated with the Entity A. In some examples, the data processing system may generate a digital record in response to receiving the request. For example, if the request is associated with a product (e.g., indicated by the “Product ID”), the data processing system can identify the product as the networked item. The data processing system can then identify a set of sub-graph data structures linked to a node of a profile for the networked item and then generate the digital record based on a sequence of connected nodes included in the set of sub-graph data structures. As an example, if the product is a shirt, the data processing system can identify sub-graph data structures representing entities within a path of nodes associated with manufacturing of the shirt, such as cotton suppliers, textile manufacturers, and garment assembly facilities, and generate the digital record to include a visual representation of the sequence of nodes reflecting these connected entities involved in the production of the shirt.

As illustrated in FIG. 5G, the user interface 500G may display a total number of tasks open at the computing device. For example, the user interface 500G can indicate a number of tasks that have not been started, are in progress, and/or are complete. Tasks that have not been started may refer to possible tasks that have been identified by the computing system based on the network graph data structure. As an example, based on determining that a node fails to satisfy a completion condition, the computing system can identify a possible task. The possible task may be associated with missing data corresponding to the failure to satisfy the completion condition. A user can select an option on the user interface 500G to initiate a task or initiate generation and transmission of a message corresponding to a selected task.

As illustrated in FIG. 5H, the user interface 500H may display a task notification 504 at the second computing device. In some examples, the data processing system can display the task notification 504 of FIG. 5H on the user interface 500H at the second computing device in response to receiving the request from the first computing device. For example, the data processing system can transmit instructions to render the task notification as an indication of the request for additional information. In some examples, the user interface 500H may display at least part of a digital record associated with the request in response to selection of the view task icon 504a. For example, the interface may display a visual representation of the set of sub-graph data structures included in the digital record generated based on the request.

As illustrated in FIGS. 51-5J, the user interface 500I and the user interface 500J may present information associated with the request. The user interface 500I and the user interface 500J can be presented at the second computing device. The user interface 500J can display a first comment 506 indicating the request. The second computing device can upload a set of files 510a-510d (collectively referred to as the files 510) based on the request. The user interface 500J can display a second comment 508 indicating completion of the task based on uploading the additional information comprising the set of files 510a-510d.

In some implementations, the data processing system can update a network graph data structure based on the set of files 510 uploaded by the second computing device. For example, the data processing system may propagate an augmented digital record including the files along identified paths within the network data graph. The data processing system can query the network data graph to determine computing systems associated with the update. As an example, if the files 510 are associated with an entity (e.g., Entity B) that produces cotton fiber, the data processing system can query the network data graph to identify downstream entities that use the cotton fiber to perform an operation on instances of various networked items (e.g., other items of clothing, etc.). The data processing system can then propagate the updates to local systems of records (e.g., the systems of record 464 of FIG. 4A) associated with computing systems (e.g., the computing systems 402) of the downstream entities. Propagating the augmented digital record including the files 510 may prompt the local systems of record to take an action. For example, propagating the augmented digital record may trigger one or more operations (e.g., compliance review workflows, initiate automated data validation processes, generate notifications to relevant personnel for further inspection or approval, etc.). By propagating the augmented digital record including the files 510, the data processing system can synchronize local systems of records to prevent inconsistent updates across the network graph data structure.

In some implementations, the data processing system can regenerate related visual representations in response to receiving the files 510. For example, the data processing system can regenerate a visual representation of a path of nodes associated with networked item corresponding to the task (e.g., the dress shirt). In an example, the data processing system can generate (e.g., generate or regenerate) visual representations of paths of nodes of networked items associated with the files 510. For example, if the cotton fiber associated with the files is also used in a second networked item representing a dress, the data processing system can generate a second visual representation of the portion of the network graph data structure corresponding to the dress responsive to receiving the files 510. The data processing system can then transmit the generated visual representations to one or more entities corresponding to nodes associated with the files 510 and/or the portion of the network graph data structure corresponding to the dress. By regenerating visual representations, the system can maintain accurate and current user interfaces and thereby resolving the technical problem of stale visual depictions in distributed environments. Furthermore, by regenerating visual representations of associated networked items (e.g., generating a visual representation of the dress based on receiving the files 510 in response to a task request associated with the dress shirt), the data processing system can ensure consistency and coherence across related supply chain records, enabling timely dissemination of updated information to relevant entities.

As illustrated in FIG. 5K, the user interface 500K may display an updated visual representation 512 of a digital record associated with the networked item (e.g., the dress shirt) may be presented responsive to the data processing system receiving the files 510. For example, the data processing system may link the files 510 (e.g., at least one of the files 510a-510e to a node 514 of the network graph data structure corresponding to the entity 516b. The data processing system can then update the digital record. Based on updating the digital record, the data processing system can generate the updated visual representation incorporating the additional information (e.g., the files 510). The data processing system can then present the updated visual representation at the first computing device, the second computing device, and/or any computing device associated with the portion of the network graph data structure associated with the dress shirt. As an example, the data processing system can cause presentation of the updated visual representation at a computing device that transmitted the task request (e.g., a computing device associated with entity 516a).

As illustrated in FIG. 5L, the user interface 500L may present a graphical element 518 indicating the upload of the files 510. For example, the user interface 500L may present the graphical element 518 as a pop-up notification and/or based on a user selection of a file element 520 presented in association with the entity 516b within the user interface 500L.

As illustrated in FIGS. 5M-5N, the computing device may access documentation associated with other nodes based on selecting one of a set of sequence elements 522 presented within the user interface 500M and the user interface 500N. The sequence elements 522 may correspond to a sequence of nodes associated with a networked item (e.g., woven dress shirts). Based on selecting one of the sequence elements 522, the computing device may view documents uploaded by an entity of the corresponding node. As an example, based on selecting a garment assembly element 522a, the computing device can view documents uploaded by the entity 516e that corresponds to garment assembly. The entity 516e may be an entity that can assemble garments based on materials supplied by upstream entities (e.g., yarn manufactured by the entity 516c). As illustrated in FIGS. 5M-5N, the computing device may view an attestation uploaded by the entity 516e based on selecting the garment assembly element 522a.

As illustrated in FIG. 50, the computing device may review documents before upload. For example, the user interface 500O may be presented before the files 510 are uploaded at FIG. 5J. In some examples, the files 510 may be published to the network graph data structure in response to selection of the accept element 528. Publishing documents can trigger one or more network operations. For example, selection of the accept element 528 can trigger notification of new files to associated entities, authorization workflows, revision of one or more elements (e.g., nodes or edges) of the network graph data structure, and/or the like.

As illustrated in FIG. 5P-5Q, the user interface 500P may display unpublished passports. For example, the computing device may create passports representing networked items. The user interface 500Q may indicate which entities a passport will be shared with upon publication. In response to selection of the publish element 524, the passports may be published. In an example, publishing the passports can add nodes and/or edges to the network graph data structure. In an example, publishing the passports can trigger notifications to associated nodes. For example, a supplier may be notified of inclusion in the passport corresponding to a networked item manufactured using a material manufactured by the supplier. As an example, the entity 516a may be notified upon the publication of the passport associated with the user interface 500Q.

As illustrated in FIGS. 5R-5S, the user interface 500R and the user interface 500S may display passports corresponding to entities. For example, in response to selection of the entity 516b, the user interface 500S can display passports 526 corresponding to the entity 516b. The passports 526 which a node corresponding to the entity 516b is associated with. For example, if the entity 516b is a yarn distributor, the passports 526 can include passports associated with networked items (e.g., clothing items) manufactured using yarn distributed by the entity 516b.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing device that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the networked items listed thereafter, equivalents thereof, and additional networked items, as well as alternate implementations consisting of the networked items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional networked items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A method for updating and synchronizing graph-based data across a computer network in a distributed computing environment, comprising:
transmitting, by one or more processors, a digital record comprising a visual representation of one or more sub-graph data structures of a network graph data structure comprising a network of nodes to a computing device of a first node of the network of nodes of the network graph data structure, the digital record comprising a request for additional information for a sequence of nodes of a sub-graph data structure of the one or more sub-graph data structures, sequence of nodes forming a path of one or more instances of a networked item from a source node to a destination node,
wherein the path represents network operations of the one or more instances of the networked item through the sequence of nodes,
wherein each node of the sequence of nodes represents an entity performing a network operation on the one or more instances of the networked item, and
wherein each edge between one or more pairs of the sequence of nodes represents a network operation involving the one or more instances of the networked item from one node of the pair of nodes to the other node of the pair of nodes;
receiving, by the one or more processors, an augmented digital record updated with the additional information from the computing device of the first node of the network of nodes of the network graph data structure;
updating, by the one or more processors based at least on the additional information, at least one node of the sequence of nodes of the sub-graph data structure and regenerating the visual representation based at least on the updated at least one node of the network graph data structure;
identifying, by the one or more processors, one or more other nodes of the sequence of nodes to propagate the update to the digital record; and
propagating, by the one or more processors across a communications network, the augmented digital record to a computing system of each of the identified one or more other nodes of the sequence of nodes for taking an action regarding a system of record maintained by the computing system and comprising a set of nodes of the computing system represented in the network graph data structure.

2. The method of claim 1, wherein propagating the augmented digital record to the computing system of each of the identified one or more other nodes of the sequence of nodes comprises, for each computing system:
identifying, by the one or more processors, an address of a second computing device of the computing system from the first node of the one or more other nodes of the sequence of nodes; and
including, by the one or more processors, the address in a header of each of a set of data packets including the augmented digital record transmitted to the second computing device across the communications network.

3. The method of claim 1, further comprising:
receiving, by the one or more processors from a second computing device, a request to complete a task corresponding to the networked item; and
creating, by the one or more processors, the digital record in response to the request and based on the task by identifying the one or more sub-graph data structures of the network graph data structure based on a link between the one or more sub-graph data structures linked and a node of a profile for the networked item within the network of nodes.

4. The method of claim 3, wherein creating the digital record comprises:
creating, by the one or more processors, a visual representation of the sub-graph data structure that corresponds to completing the task identified in the request; and
wherein transmitting the digital record comprising the first visual representation of the one or more sub-graph data structures comprises:
rendering, by the one or more processors, the visual representation on a user interface for presentation on the computing device.

5. The method of claim 1, wherein receipt of the augmented digital record triggers at least one computing system of the one or more other nodes to locally add an edge between a pair of nodes of the set of nodes within the digital record.

6. The method of claim 5, further comprising:
transmitting, by the one or more processors, the set of nodes to the computing system including attributes corresponding to entities represented by the set of nodes; and
receiving, by the one or more processors from the computing system, the set of nodes updated with added edge between the pair of nodes of the set of nodes.

7. The method of claim 5, further comprising:
receiving, by the one or more processors, a message from the at least one computing system identifying the added edge between the pair of nodes;
identifying, by the one or more processors, the pair of nodes within the network graph data structure stored by the one or more processors; and
adding, by the one or more processors, the edge between the pair of nodes within the network graph data structure stored by the one or more processors.

8. The method of claim 1, wherein identifying the one or more other nodes of the sequence of nodes to propagate the update to the digital record comprises identifying each node of the sub-graph data structure containing the sequence of nodes through edges connecting the respective nodes.

9. The method of claim 1, further comprising:
identifying, by the one or more processors, security permissions of each node of the sequence of nodes; and
determining, by the one or more processors, to propagate the augmented digital record to the computing system of each of the identified one or more other nodes of the sequence of nodes responsive to determining security permissions of the one or more nodes satisfy a threshold.

10. The method of claim 9, wherein selectively propagating the augmented digital record only to computing systems of nodes with security permissions satisfying the threshold improves data integrity of the network graph data structure by preventing unauthorized updates to nodes outside the updated sequence of nodes.

11. A system for updating and synchronizing graph-based data across a computer network in a distributed computing environment, comprising:
one or more processors; and
one or more non-transitory computer-readable media storing instructions that, when executed by the one or more processors, cause the system to:
transmit a digital record comprising a visual representation of one or more sub-graph data structures of a network graph data structure comprising a network of nodes to a computing device of a first node of the network of nodes of the network graph data structure, the digital record comprising a request for additional information for a sequence of nodes of a sub-graph data structure of the one or more sub-graph data structures, sequence of nodes forming a path of one or more instances of a networked item from a source node to a destination node,
wherein the path represents network operations of the one or more instances of the networked item through the sequence of nodes,
wherein each node of the sequence of nodes represents an entity performing a network operation on the one or more instances of the networked item, and
wherein each edge between one or more pairs of the sequence of nodes represents a network operation involving one or more instances of the networked item from one node of the pair of nodes to the other node of the pair of nodes;
receive an augmented digital record updated with the additional information from the computing device of the first node of the network of nodes of the network graph data structure;
update, based at least on the additional information, at least one node of the sequence of nodes of the sub-graph data structure and regenerate the visual representation based at least on the updated at least one node of the network graph data structure;
identify one or more other nodes of the sequence of nodes to propagate the update to the digital record; and
propagate across a communications network, the augmented digital record to a computing system of each of the identified one or more other nodes of the sequence of nodes for taking an action regarding a system of record maintained by the computing system and comprising a set of nodes of the computing system represented in the network graph data structure.

12. The system of claim 11, wherein the instructions for propagating the augmented digital record to the computing system of each of the identified one or more other nodes of the sequence of nodes causes the system to, for each computing system:
identify an address of a second computing device of the computing system from the first node of the one or more other nodes of the sequence of nodes; and
include the address in a header of each of a set of data packets including the augmented digital record transmitted to the second computing device across the communications network.

13. The system of claim 11, wherein the instructions further cause the system to:
receive, from a second computing device, a request to complete a task corresponding to the networked item; and
create, the digital record in response to the request and based on the task by identifying the one or more sub-graph data structures of the network graph data structure based on a link between the one or more sub-graph data structures linked and a node of a profile for the networked item within the network of nodes.

14. The system of claim 13, wherein the instructions for creating the digital record cause the system to:
create a visual representation of the sub-graph data structure that corresponds to completing the task identified in the request; and
wherein the instructions for transmitting the digital record comprising the first visual representation of the one or more sub-graph data structures cause the system to:
render the visual representation on a user interface for presentation on the computing device.

15. The system of claim 11, wherein receipt of the augmented digital record triggers at least one computing system of the one or more other nodes to locally add an edge between a pair of nodes of the set of nodes within the digital record.

16. The system of claim 15, wherein the instructions further cause the system to:
transmit the set of nodes to the computing system including attributes corresponding to entities represented by the set of nodes; and
receive, from the computing system, the set of nodes updated with added edge between the pair of nodes of the set of nodes.

17. The system of claim 15, wherein the instructions further cause the system to:
receive a message from the at least one computing system identifying the added edge between the pair of nodes;
identify the pair of nodes within the network graph data structure stored by the one or more processors; and
add the edge between the pair of nodes within the network graph data structure stored by the one or more processors.

18. The system of claim 11, wherein identifying the one or more other nodes of the sequence of nodes to propagate the update to the digital record comprises identifying each node of the sub-graph data structure containing the sequence of nodes through edges connecting the respective nodes.

19. A non-transitory computer-readable storage medium storing instructions that, when executed by one or more processors, cause the one or more processors to perform operations comprising:
transmitting a digital record comprising a visual representation of one or more sub-graph data structures of a network graph data structure comprising a network of nodes to a computing device of a first node of the network of nodes of the network graph data structure, the digital record comprising a request for additional information for a sequence of nodes of a sub-graph data structure of the one or more sub-graph data structures, sequence of nodes forming a path of one or more instances of a networked item from a source node to a destination node,
wherein the path represents network operations of the one or more instances of the networked item through the sequence of nodes,
wherein each node of the sequence of nodes represents an entity performing a network operation on the one or more instances of the networked item, and
wherein each edge between one or more pairs of the sequence of nodes represents a network operation involving the one or more instances of the networked item from one node of the pair of nodes to the other node of the pair of nodes;
receiving an augmented digital record updated with the additional information from the computing device of the first node of the network of nodes of the network graph data structure;
updating, based at least on the additional information, at least one node of the sequence of nodes of the sub-graph data structure and regenerating the visual representation based at least on the updated at least one node of the network graph data structure;
identifying one or more other nodes of the sequence of nodes to propagate the update to the digital record; and
propagating, across a communications network, the augmented digital record to a computing system of each of the identified one or more other nodes of the sequence of nodes for taking an action regarding a system of record maintained by the computing system and comprising a set of nodes of the computing system represented in the network graph data structure.

20. The non-transitory computer-readable storage medium of claim 19, wherein the operations further comprise:
identifying security permissions of each node of the sequence of nodes; and
determining to propagate the augmented digital record to the computing system of each of the identified one or more other nodes of the sequence of nodes responsive to determining security permissions of the one or more nodes satisfy a threshold.
